(19) United States
(12) Patent Application Publication
(10) Pub. No.: US 2025/0315142 A1
(43) Pub. Date: Oct. 9, 2025

(54) INTELLIGENT DIGITAL ASSISTANT

(71) Applicant: Apple Inc., Cupertino, CA (US)

(72) Inventors: Ramon GILABERT LLOP, Barcelona (ES); Karan M. DARYANANI, San Francisco, CA (US); Miquel ESTANY RODRIGUEZ, San Francisco, CA (US); Lane FUJITA, Oakland, CA (US); Pierre GREBORIO, Sunnyvale, CA (US); Eli A. GUERRON, Cupertino, CA (US); James N. JONES, San Francisco, CA (US); Cas G. LEMMENS, San Francisco, CA (US); Pedro MARI, Santa Cruz, CA (US); James J. OWEN, San Francisco, CA (US); AlI T. OZER, Redwood City, CA (US); Raymond PAI, San Jose, CA (US); Jerry WONG, Princeton, NJ (US); Giancarlo YERKES, San Francisco, CA (US)

(21) Appl. No.: 19/170,928

(22) Filed: Apr. 4, 2025

Related U.S. Application Data
(60) Provisional application No. 63/631,414, filed on Apr. 8, 2024.
(60) Provisional application No. 63/646,887, filed on May 13, 2024.
(60) Provisional application No. 63/657,760, filed on Jun. 7, 2024.
(60) Provisional application No. 63/755,131, filed on Feb. 6, 2025.

(51) Int. Cl. G06F 3/0481; G06F 3/04845; G06F 3/04886; G06F 9/451

(52) U.S. Cl. CPC G06F 3/0481; G06F 3/04845; G06F 3/04886; G06F 9/453

(57) ABSTRACT

Techniques for managing an intelligent automated assistant are provided. An example method includes receiving an input including a request to activate a digital assistant; in response, initiating a process to activate the digital assistant, wherein the process to activate the digital assistant includes: in accordance with a determination that a location of the input relative to the computer system corresponds to a first location, displaying an input indicator with a first directionality; in accordance with a determination that the location of the input relative to the computer system does not correspond to the first location, displaying the input indicator with a second directionality different than the first directionality; and after displaying the input indicator, displaying an activation indicator indicating that the digital assistant is active, wherein the activation indicator is displayed adjacent to at least a portion of an edge of a user interface.

### CROSS-REFERENCE TO RELATED APPLICATIONS

This application claims priority to (1) U.S. Provisional Application 63/755,131, filed Feb. 6, 2025, entitled “INTELLIGENT DIGITAL ASSISTANT,” to (2) U.S. Provisional Application 63/657,760, filed Jun. 7, 2025, entitled “INTELLIGENT DIGITAL ASSISTANT,” to (3) U.S. Provisional Application 63/646,887, filed May 13, 2024, entitled “INTELLIGENT DIGITAL ASSISTANT,” and to (4) U.S. Provisional Application 63/631,414, filed Apr. 8, 2024, entitled “INTELLIGENT DIGITAL ASSISTANT.” The entire contents of each of these applications are hereby incorporated by reference.

### FIELD

This relates generally to intelligent automated assistants and, more specifically, to managing intelligent automated assistants on electronic devices.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user.

### SUMMARY

Example methods are disclosed herein. An example method includes, at a computer system that is in communication with a display generation component and one or more input devices: receiving, via the one or more input devices, an input including a request to activate a digital assistant of the computer system; in response to the request to activate the digital assistant, initiating a process to activate the digital assistant, wherein the process to activate the digital assistant includes: in accordance with a determination that a location of the input relative to the computer system corresponds to a first location, displaying, via the display generation component, an input indicator with a first directionality; in accordance with a determination that the location of the input relative to the computer system does not correspond to the first location, displaying, via the display generation component, the input indicator with a second directionality different than the first directionality; and after displaying the input indicator, displaying, via the display generation component, an activation indicator indicating that the digital assistant is active, wherein the activation indicator is displayed adjacent to at least a portion of an edge of a user interface.

An example method includes, at a computer system that is in communication with a display generation component and one or more input devices: while displaying a user interface, via the display generation component, receiving, via the set of one or more input devices, a set of inputs including a request to activate a digital assistant of the computer system; in response to the set of inputs: activating the digital assistant; modifying, based on a type of an input of the set of inputs, a visual characteristic of a perimeter of at least a portion of the user interface indicating that the digital assistant is activated.

An example method includes, at a computer system that is in communication with one or more input devices: receiving, via the one or more input devices, a first input including a request to activate a digital assistant; in response to the request to activate the digital assistant, activating the digital assistant; and while the digital assistant is activated: providing a first set of candidate tasks based on a context of the computer system; receiving, via the one or more input devices, a natural-language input; and providing a second set of candidate tasks based on the natural-language input and the context of the computer system.

An example method includes, at a computer system that is in communication with a display generation component and one or more input devices: while a digital assistant of the computer system is active: receiving, via the one or more input devices, a request to perform a first task; in response to the request to perform the first task, performing the first task; after performing the first task, displaying, via the display generation component, a user interface object including a first result corresponding to the first task; and while the user interface object is displayed: receiving, via the one or more input devices, a request to perform a second task different than the first task; in response to the request to perform the second task, performing the second task; and modifying display of the user interface object to include a second result corresponding to the second task.

An example method includes, at a computer system that is in communication with a display generation component and one or more input devices: receiving, via the one or more input devices, an input including a request to perform a task; in response to the request, initiating performance of the task; in accordance with a determination that the task satisfies a set of latency criteria: displaying, via the display generation component, a performance indicator corresponding to the task; and after the task has been performed, displaying a result corresponding to the request; and in accordance with a determination that the task does not satisfy the set of latency criteria: forgoing display of the performance indicator; and after the task has been performed, displaying the result corresponding to the request.

An example method includes, at a computer system that is in communication with a display generation component and one or more input devices: receiving, via the one or more input devices, a speech input from a user, wherein the speech input includes a request to activate a digital assistant of the computing system; and in response to the request to activate the digital assistant, initiating a process to activate the digital assistant, wherein the process to activate the digital assistant includes: in accordance with a determination that a location of the user corresponds to a first location, displaying, via the display generation component, an activation indicator based on the first location; and in accordance with a determination that a location of the user corresponds to a second location different than the first, displaying, via the display generation component, the activation indicator based on the second location.

An example method includes at a computer system that is in communication with a display generation component and one or more input devices: initiating, via the display generation component, display of an activation indicator; and while displaying the activation indicator: receiving, via the one or more input devices, a first speech input from a first user; determining, based on the first speech input, a location of the first user relative to the computing system; adjusting, via the display generation component, display of the activation indicator based on the location of the first user; receiving, via the one or more input devices, a second speech input from a second user different than the first user; determining, based on the second speech input, a location of the second user relative to the computing system; and adjusting, via the display generation component, display of the activation indicator based on the location of the second user.

Example non-transitory computer-readable media are disclosed herein. An example non-transitory computer-readable storage medium stores one or more programs configured to be executed by one or more processors of a computer system that is in communication with a display generation component and one or more input devices. The one or more programs include instructions for: receiving, via the one or more input devices, an input including a request to activate a digital assistant of the computer system; in response to the request to activate the digital assistant, initiating a process to activate the digital assistant, wherein the process to activate the digital assistant includes: in accordance with a determination that a location of the input relative to the computer system corresponds to a first location, displaying, via the display generation component, an input indicator with a first directionality; in accordance with a determination that the location of the input relative to the computer system does not correspond to the first location, displaying, via the display generation component, the input indicator with a second directionality different than the first directionality; and after displaying the input indicator, displaying, via the display generation component, an activation indicator indicating that the digital assistant is active, wherein the activation indicator is displayed adjacent to at least a portion of an edge of a user interface.

An example non-transitory computer-readable storage medium stores one or more programs configured to be executed by one or more processors of a computer system that is in communication with a display generation component and one or more input devices. The one or more programs include instructions for: while displaying a user interface, via the display generation component, receiving, via the set of one or more input devices, a set of inputs including a request to activate a digital assistant of the computer system; in response to the set of inputs: activating the digital assistant; modifying, based on a type of an input of the set of inputs, a visual characteristic of a perimeter of at least a portion of the user interface indicating that the digital assistant is activated.

An example non-transitory computer-readable storage medium stores one or more programs configured to be executed by one or more processors of a computer system that is in communication with one or more input devices. The one or more programs include instructions for: receiving, via the one or more input devices, a first input including a request to activate a digital assistant; in response to the request to activate the digital assistant, activating the digital assistant; and while the digital assistant is activated: providing a first set of candidate tasks based on a context of the computer system; receiving, via the one or more input devices, a natural-language input; and providing a second set of candidate tasks based on the natural-language input and the context of the computer system.

An example non-transitory computer-readable storage medium stores one or more programs configured to be executed by one or more processors of a computer system that is in communication with a display generation component and one or more input devices. The one or more programs include instructions for: while a digital assistant of the computer system is active: receiving, via the one or more input devices, a request to perform a first task; in response to the request to perform the first task, performing the first task; after performing the first task, displaying, via the display generation component, a user interface object including a first result corresponding to the first task; and while the user interface object is displayed: receiving, via the one or more input devices, a request to perform a second task different than the first task; in response to the request to perform the second task, performing the second task; and modifying display of the user interface object to include a second result corresponding to the second task.

An example non-transitory computer-readable storage medium stores one or more programs configured to be executed by one or more processors of a computer system that is in communication with a display generation component and one or more input devices. The one or more programs include instructions for: receiving, via the one or more input devices, an input including a request to perform a task; in response to the request, initiating performance of the task; in accordance with a determination that the task satisfies a set of latency criteria: displaying, via the display generation component, a performance indicator corresponding to the task; and after the task has been performed, displaying a result corresponding to the request; and in accordance with a determination that the task does not satisfy the set of latency criteria: forgoing display of the performance indicator; and after the task has been performed, displaying the result corresponding to the request.

An example non-transitory computer-readable storage medium stores one or more programs configured to be executed by one or more processors of a computer system that is in communication with a display generation component and one or more input devices. The one or more programs include instructions for: receiving, via the one or more input devices, a speech input from a user, wherein the speech input includes a request to activate a digital assistant of the computing system; and in response to the request to activate the digital assistant, initiating a process to activate the digital assistant, wherein the process to activate the digital assistant includes: in accordance with a determination that a location of the user corresponds to a first location, displaying, via the display generation component, an activation indicator based on the first location; and in accordance with a determination that a location of the user corresponds to a second location different than the first, displaying, via the display generation component, the activation indicator based on the second location.

An example non-transitory computer-readable storage medium stores one or more programs configured to be executed by one or more processors of a computer system that is in communication with a display generation component and one or more input devices. The one or more programs include instructions for: initiating, via the display generation component, display of an activation indicator; and while displaying the activation indicator: receiving, via the one or more input devices, a first speech input from a first user; determining, based on the first speech input, a location of the first user relative to the computing system; adjusting, via the display generation component, display of the activation indicator based on the location of the first user; receiving, via the one or more input devices, a second speech input from a second user different than the first user; determining, based on the second speech input, a location of the second user relative to the computing system; and adjusting, via the display generation component, display of the activation indicator based on the location of the second user.

Example transitory computer-readable media are disclosed herein. An example transitory computer-readable storage medium stores one or more programs configured to be executed by one or more processors of a computer system that is in communication with a display generation component and one or more input devices. The one or more programs include instructions for: receiving, via the one or more input devices, an input including a request to activate a digital assistant of the computer system; in response to the request to activate the digital assistant, initiating a process to activate the digital assistant, wherein the process to activate the digital assistant includes: in accordance with a determination that a location of the input relative to the computer system corresponds to a first location, displaying, via the display generation component, an input indicator with a first directionality; in accordance with a determination that the location of the input relative to the computer system does not correspond to the first location, displaying, via the display generation component, the input indicator with a second directionality different than the first directionality; and after displaying the input indicator, displaying, via the display generation component, an activation indicator indicating that the digital assistant is active, wherein the activation indicator is displayed adjacent to at least a portion of an edge of a user interface.

An example transitory computer-readable storage medium stores one or more programs configured to be executed by one or more processors of a computer system that is in communication with a display generation component and one or more input devices. The one or more programs include instructions for: while displaying a user interface, via the display generation component, receiving, via the set of one or more input devices, a set of inputs including a request to activate a digital assistant of the computer system; in response to the set of inputs: activating the digital assistant; modifying, based on a type of an input of the set of inputs, a visual characteristic of a perimeter of at least a portion of the user interface indicating that the digital assistant is activated.

An example transitory computer-readable storage medium stores one or more programs configured to be executed by one or more processors of a computer system that is in communication with one or more input devices. The one or more programs include instructions for: receiving, via the one or more input devices, a first input including a request to activate a digital assistant; in response to the request to activate the digital assistant, activating the digital assistant; and while the digital assistant is activated: providing a first set of candidate tasks based on a context of the computer system; receiving, via the one or more input devices, a natural-language input; and providing a second set of candidate tasks based on the natural-language input and the context of the computer system.

An example transitory computer-readable storage medium stores one or more programs configured to be executed by one or more processors of a computer system that is in communication with a display generation component and one or more input devices. The one or more programs include instructions for: while a digital assistant of the computer system is active: receiving, via the one or more input devices, a request to perform a first task; in response to the request to perform the first task, performing the first task; after performing the first task, displaying, via the display generation component, a user interface object including a first result corresponding to the first task; and while the user interface object is displayed: receiving, via the one or more input devices, a request to perform a second task different than the first task; in response to the request to perform the second task, performing the second task; and modifying display of the user interface object to include a second result corresponding to the second task.

An example transitory computer-readable storage medium stores one or more programs configured to be executed by one or more processors of a computer system that is in communication with a display generation component and one or more input devices. The one or more programs include instructions for: receiving, via the one or more input devices, an input including a request to perform a task; in response to the request, initiating performance of the task; in accordance with a determination that the task satisfies a set of latency criteria: displaying, via the display generation component, a performance indicator corresponding to the task; and after the task has been performed, displaying a result corresponding to the request; and in accordance with a determination that the task does not satisfy the set of latency criteria: forgoing display of the performance indicator; and after the task has been performed, displaying the result corresponding to the request.

An example transitory computer-readable storage medium stores one or more programs configured to be executed by one or more processors of a computer system that is in communication with a display generation component and one or more input devices. The one or more programs include instructions for: receiving, via the one or more input devices, a speech input from a user, wherein the speech input includes a request to activate a digital assistant of the computing system; and in response to the request to activate the digital assistant, initiating a process to activate the digital assistant, wherein the process to activate the digital assistant includes: in accordance with a determination that a location of the user corresponds to a first location, displaying, via the display generation component, an activation indicator based on the first location; and in accordance with a determination that a location of the user corresponds to a second location different than the first, displaying, via the display generation component, the activation indicator based on the second location.

An example transitory computer-readable storage medium stores one or more programs configured to be executed by one or more processors of a computer system that is in communication with a display generation component and one or more input devices. The one or more programs include instructions for: initiating, via the display generation component, display of an activation indicator; and while displaying the activation indicator: receiving, via the one or more input devices, a first speech input from a first user; determining, based on the first speech input, a location of the first user relative to the computing system; adjusting, via the display generation component, display of the activation indicator based on the location of the first user; receiving, via the one or more input devices, a second speech input from a second user different than the first user; determining, based on the second speech input, a location of the second user relative to the computing system; and adjusting, via the display generation component, display of the activation indicator based on the location of the second user.

Example computer systems (e.g., devices) are disclosed herein. An example computer system configured to communicate with a display generation component and one or more input devices, comprises one or more processors; a memory storing one or more programs configured to be executed by the one or more processors, the one or more programs including instructions for: receiving, via the one or more input devices, an input including a request to activate a digital assistant of the computer system; in response to the request to activate the digital assistant, initiating a process to activate the digital assistant, wherein the process to activate the digital assistant includes: in accordance with a determination that a location of the input relative to the computer system corresponds to a first location, displaying, via the display generation component, an input indicator with a first directionality; in accordance with a determination that the location of the input relative to the computer system does not correspond to the first location, displaying, via the display generation component, the input indicator with a second directionality different than the first directionality; and after displaying the input indicator, displaying, via the display generation component, an activation indicator indicating that the digital assistant is active, wherein the activation indicator is displayed adjacent to at least a portion of an edge of a user interface.

An example computer system configured to communicate with a display generation component and one or more input devices, comprises one or more processors; a memory storing one or more programs configured to be executed by the one or more processors, the one or more programs including instructions for: while displaying a user interface, via the display generation component, receiving, via the set of one or more input devices, a set of inputs including a request to activate a digital assistant of the computer system; in response to the set of inputs: activating the digital assistant; modifying, based on a type of an input of the set of inputs, a visual characteristic of a perimeter of at least a portion of the user interface indicating that the digital assistant is activated.

An example computer system configured to communicate with one or more input devices, comprises one or more processors; a memory storing one or more programs configured to be executed by the one or more processors, the one or more programs including instructions for: receiving, via the one or more input devices, a first input including a request to activate a digital assistant; in response to the request to activate the digital assistant, activating the digital assistant; and while the digital assistant is activated: providing a first set of candidate tasks based on a context of the computer system; receiving, via the one or more input devices, a natural-language input; and providing a second set of candidate tasks based on the natural-language input and the context of the computer system.

An example computer system configured to communicate with a display generation component and one or more input devices, comprises one or more processors; a memory storing one or more programs configured to be executed by the one or more processors, the one or more programs including instructions for: while a digital assistant of the computer system is active: receiving, via the one or more input devices, a request to perform a first task; in response to the request to perform the first task, performing the first task; after performing the first task, displaying, via the display generation component, a user interface object including a first result corresponding to the first task; and while the user interface object is displayed: receiving, via the one or more input devices, a request to perform a second task different than the first task; in response to the request to perform the second task, performing the second task; and modifying display of the user interface object to include a second result corresponding to the second task.

An example computer system configured to communicate with a display generation component and one or more input devices, comprises one or more processors; a memory storing one or more programs configured to be executed by the one or more processors, the one or more programs including instructions for: receiving, via the one or more input devices, an input including a request to perform a task; in response to the request, initiating performance of the task; in accordance with a determination that the task satisfies a set of latency criteria: displaying, via the display generation component, a performance indicator corresponding to the task; and after the task has been performed, displaying a result corresponding to the request; and in accordance with a determination that the task does not satisfy the set of latency criteria: forgoing display of the performance indicator; and after the task has been performed, displaying the result corresponding to the request.

An example computer system configured to communicate with a display generation component and one or more input devices, comprises one or more processors; a memory storing one or more programs configured to be executed by the one or more processors, the one or more programs including instructions for: receiving, via the one or more input devices, a speech input from a user, wherein the speech input includes a request to activate a digital assistant of the computing system; and in response to the request to activate the digital assistant, initiating a process to activate the digital assistant, wherein the process to activate the digital assistant includes: in accordance with a determination that a location of the user corresponds to a first location, displaying, via the display generation component, an activation indicator based on the first location; and in accordance with a determination that a location of the user corresponds to a second location different than the first, displaying, via the display generation component, the activation indicator based on the second location.

An example computer system configured to communicate with a display generation component and one or more input devices, comprises one or more processors; a memory storing one or more programs configured to be executed by the one or more processors, the one or more programs including instructions for: initiating, via the display generation component, display of an activation indicator; and while displaying the activation indicator: receiving, via the one or more input devices, a first speech input from a first user; determining, based on the first speech input, a location of the first user relative to the computing system; adjusting, via the display generation component, display of the activation indicator based on the location of the first user; receiving, via the one or more input devices, a second speech input from a second user different than the first user; determining, based on the second speech input, a location of the second user relative to the computing system; and adjusting, via the display generation component, display of the activation indicator based on the location of the second user.

An example computer system configured to communicate with a display generation component and one or more input devices comprises means for receiving, via the one or more input devices, an input including a request to activate a digital assistant of the computer system; means for, in response to the request to activate the digital assistant, initiating a process to activate the digital assistant, wherein the process to activate the digital assistant includes: in accordance with a determination that a location of the input relative to the computer system corresponds to a first location, displaying, via the display generation component, an input indicator with a first directionality; in accordance with a determination that the location of the input relative to the computer system does not correspond to the first location, displaying, via the display generation component, the input indicator with a second directionality different than the first directionality; and after displaying the input indicator, displaying, via the display generation component, an activation indicator indicating that the digital assistant is active, wherein the activation indicator is displayed adjacent to at least a portion of an edge of a user interface.

An example computer system configured to communicate with a display generation component and one or more input devices comprises means for, while displaying a user interface, via the display generation component, receiving, via the set of one or more input devices, a set of inputs including a request to activate a digital assistant of the computer system; means for, in response to the set of inputs: activating the digital assistant; modifying, based on a type of an input of the set of inputs, a visual characteristic of a perimeter of at least a portion of the user interface indicating that the digital assistant is activated.

An example computer system configured to communicate with one or more input devices comprises means for receiving, via the one or more input devices, a first input including a request to activate a digital assistant; means for, in response to the request to activate the digital assistant, activating the digital assistant; and means for, while the digital assistant is activated: providing a first set of candidate tasks based on a context of the computer system; receiving, via the one or more input devices, a natural-language input; and providing a second set of candidate tasks based on the natural-language input and the context of the computer system.

An example computer system configured to communicate with a display generation component and one or more input devices comprises means for while a digital assistant of the computer system is active: receiving, via the one or more input devices, a request to perform a first task; in response to the request to perform the first task, performing the first task; after performing the first task, displaying, via the display generation component, a user interface object including a first result corresponding to the first task; and while the user interface object is displayed: receiving, via the one or more input devices, a request to perform a second task different than the first task; in response to the request to perform the second task, performing the second task; and modifying display of the user interface object to include a second result corresponding to the second task.

An example computer system configured to communicate with a display generation component and one or more input devices comprises means for receiving, via the one or more input devices, an input including a request to perform a task; means for, in response to the request, initiating performance of the task; in accordance with a determination that the task satisfies a set of latency criteria: displaying, via the display generation component, a performance indicator corresponding to the task; and after the task has been performed, displaying a result corresponding to the request; and means for, in accordance with a determination that the task does not satisfy the set of latency criteria: forgoing display of the performance indicator; and after the task has been performed, displaying the result corresponding to the request.

An example computer system configured to communicate with a display generation component and one or more input devices comprises means for receiving, via the one or more input devices, a speech input from a user, wherein the speech input includes a request to activate a digital assistant of the computing system; and means for, in response to the request to activate the digital assistant, initiating a process to activate the digital assistant, wherein the process to activate the digital assistant includes: in accordance with a determination that a location of the user corresponds to a first location, displaying, via the display generation component, an activation indicator based on the first location; and in accordance with a determination that a location of the user corresponds to a second location different than the first, displaying, via the display generation component, the activation indicator based on the second location.

An example computer system configured to communicate with a display generation component and one or more input devices comprises means for initiating, via the display generation component, display of an activation indicator; and means for, while displaying the activation indicator: receiving, via the one or more input devices, a first speech input from a first user; determining, based on the first speech input, a location of the first user relative to the computing system; adjusting, via the display generation component, display of the activation indicator based on the location of the first user; receiving, via the one or more input devices, a second speech input from a second user different than the first user; determining, based on the second speech input, a location of the second user relative to the computing system; and adjusting, via the display generation component, display of the activation indicator based on the location of the second user.

Example computer program products are described herein. An example computer program product comprises one or more programs configured to be executed by one or more processors of a computer system that is in communication with a display generation component and one or more input devices. The one or more programs include instructions for: receiving, via the one or more input devices, an input including a request to activate a digital assistant of the computer system; in response to the request to activate the digital assistant, initiating a process to activate the digital assistant, wherein the process to activate the digital assistant includes: in accordance with a determination that a location of the input relative to the computer system corresponds to a first location, displaying, via the display generation component, an input indicator with a first directionality; in accordance with a determination that the location of the input relative to the computer system does not correspond to the first location, displaying, via the display generation component, the input indicator with a second directionality different than the first directionality; and after displaying the input indicator, displaying, via the display generation component, an activation indicator indicating that the digital assistant is active, wherein the activation indicator is displayed adjacent to at least a portion of an edge of a user interface.

An example computer program product comprises one or more programs configured to be executed by one or more processors of a computer system that is in communication with a display generation component and one or more input devices. The one or more programs include instructions for: while displaying a user interface, via the display generation component, receiving, via the set of one or more input devices, a set of inputs including a request to activate a digital assistant of the computer system; in response to the set of inputs: activating the digital assistant; modifying, based on a type of an input of the set of inputs, a visual characteristic of a perimeter of at least a portion of the user interface indicating that the digital assistant is activated.

An example computer program product comprises one or more programs configured to be executed by one or more processors of a computer system that is in communication with one or more input devices. The one or more programs include instructions for: receiving, via the one or more input devices, a first input including a request to activate a digital assistant; in response to the request to activate the digital assistant, activating the digital assistant; and while the digital assistant is activated: providing a first set of candidate tasks based on a context of the computer system; receiving, via the one or more input devices, a natural-language input; and providing a second set of candidate tasks based on the natural-language input and the context of the computer system.

An example computer program product comprises one or more programs configured to be executed by one or more processors of a computer system that is in communication with a display generation component and one or more input devices. The one or more programs include instructions for: while a digital assistant of the computer system is active: receiving, via the one or more input devices, a request to perform a first task; in response to the request to perform the first task, performing the first task; after performing the first task, displaying, via the display generation component, a user interface object including a first result corresponding to the first task; and while the user interface object is displayed: receiving, via the one or more input devices, a request to perform a second task different than the first task; in response to the request to perform the second task, performing the second task; and modifying display of the user interface object to include a second result corresponding to the second task.

An example computer program product comprises one or more programs configured to be executed by one or more processors of a computer system that is in communication with a display generation component and one or more input devices. The one or more programs include instructions for: receiving, via the one or more input devices, an input including a request to perform a task; in response to the request, initiating performance of the task; in accordance with a determination that the task satisfies a set of latency criteria: displaying, via the display generation component, a performance indicator corresponding to the task; and after the task has been performed, displaying a result corresponding to the request; and in accordance with a determination that the task does not satisfy the set of latency criteria: forgoing display of the performance indicator; and after the task has been performed, displaying the result corresponding to the request.

An example computer program product comprises one or more programs configured to be executed by one or more processors of a computer system that is in communication with a display generation component and one or more input devices. The one or more programs include instructions for: receiving, via the one or more input devices, a speech input from a user, wherein the speech input includes a request to activate a digital assistant of the computing system; and in response to the request to activate the digital assistant, initiating a process to activate the digital assistant, wherein the process to activate the digital assistant includes: in accordance with a determination that a location of the user corresponds to a first location, displaying, via the display generation component, an activation indicator based on the first location; and in accordance with a determination that a location of the user corresponds to a second location different than the first, displaying, via the display generation component, the activation indicator based on the second location.

An example computer program product comprises one or more programs configured to be executed by one or more processors of a computer system that is in communication with a display generation component and one or more input devices. The one or more programs include instructions for: initiating, via the display generation component, display of an activation indicator; and while displaying the activation indicator: receiving, via the one or more input devices, a first speech input from a first user; determining, based on the first speech input, a location of the first user relative to the computing system; adjusting, via the display generation component, display of the activation indicator based on the location of the first user; receiving, via the one or more input devices, a second speech input from a second user different than the first user; determining, based on the second speech input, a location of the second user relative to the computing system; and adjusting, via the display generation component, display of the activation indicator based on the location of the second user.

Providing respective activation indicators when activating a digital assistant in a voice mode or a text input mode allows a user to readily identify a current mode of a digital assistant and communicate with the digital assistant using the appropriate modality, thereby providing suitable operation of the computer system across various usage scenarios. In this manner, operation of the computer system is made more convenient and intuitive, which additionally reduces power usage and improved battery life of the device by enabling the user to use the device more quickly and efficiently.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4A is a block diagram of an exemplary multifunction device with a display and a touch-sensitive surface, according to various examples.

FIGS. 4B-4G illustrate the use of Application Programming Interfaces (APIs) to perform operations.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 8 illustrates exemplary foundation system 800 including foundation model 810, according to some embodiments.

FIGS. 9A-90 illustrate exemplary interfaces for managing a digital assistant, according to some embodiments.

FIG. 10 is an exemplary flowchart for managing a digital assistant, according to some embodiments.

FIG. 11 is an exemplary flowchart for managing a digital assistant, according to some embodiments.

FIG. 12 is an exemplary flowchart for managing a digital assistant, according to some embodiments.

FIGS. 13A-13AF illustrate exemplary interfaces for managing a digital assistant, according to some embodiments.

FIG. 14 is an exemplary flowchart for managing a digital assistant, according to some embodiments.

FIG. 15 is an exemplary flowchart for managing a digital assistant, according to some embodiments.

FIGS. 16A-16J illustrate exemplary interfaces for managing a digital assistant, according to some embodiments.

FIG. 17 is an exemplary flowchart for managing a digital assistant, according to some embodiments.

FIGS. 18A-18G illustrate exemplary interfaces for managing a digital assistant, according to some embodiments.

FIG. 19 is an exemplary flowchart for managing a digital assistant, according to some embodiments.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if”′ may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

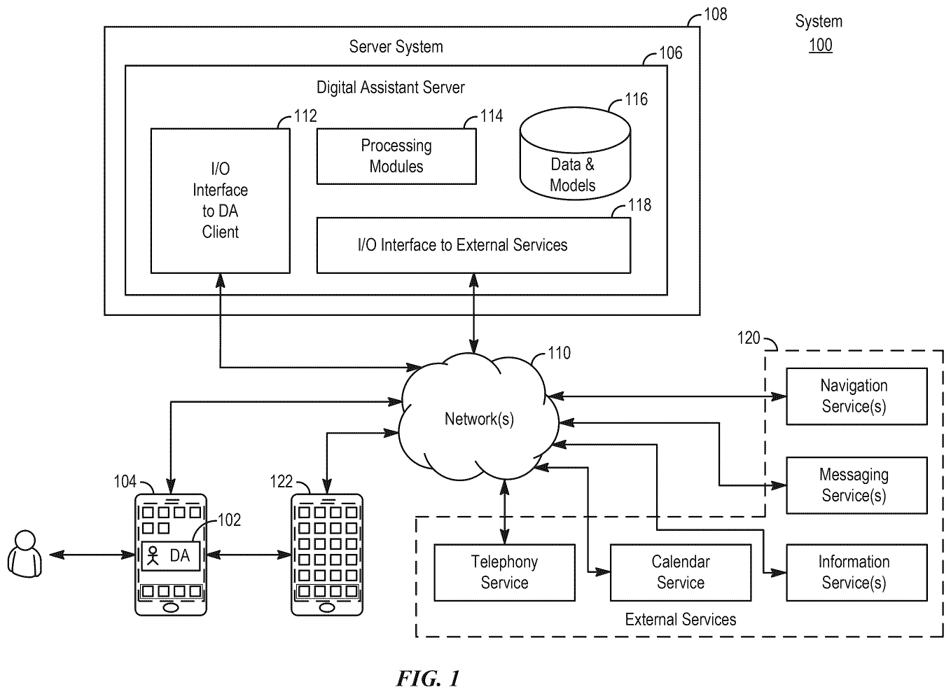

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

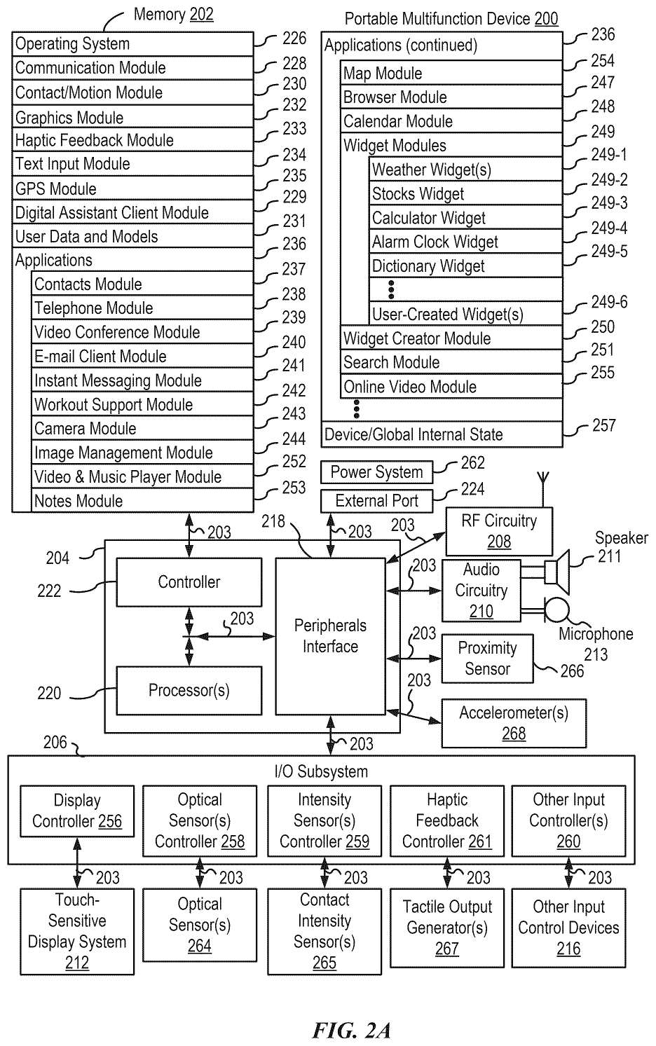

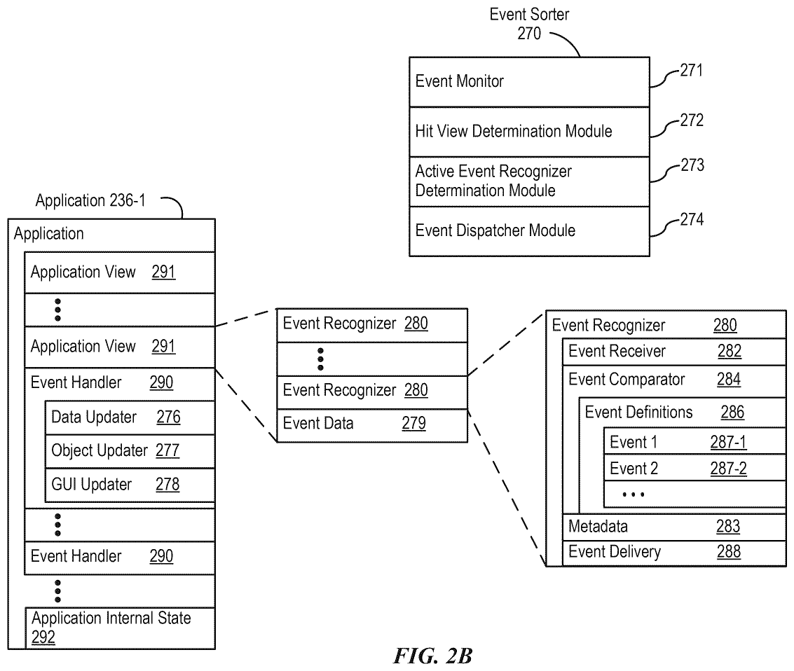

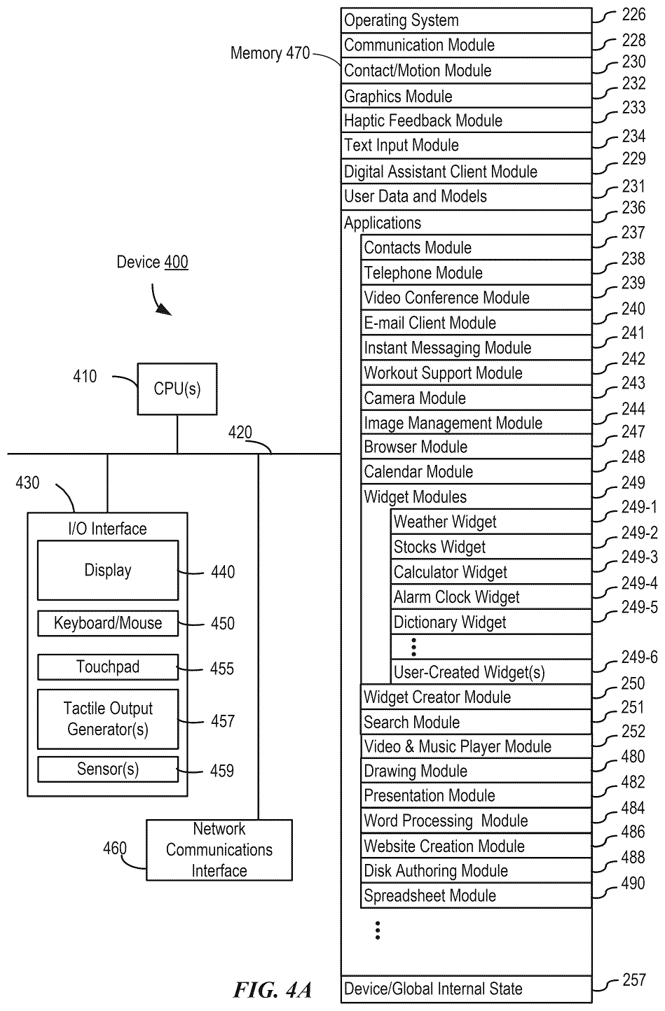

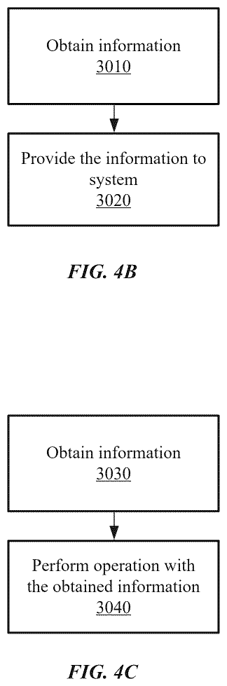

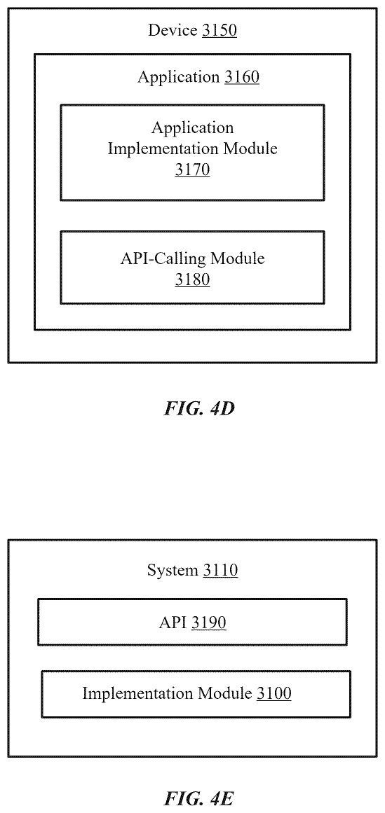

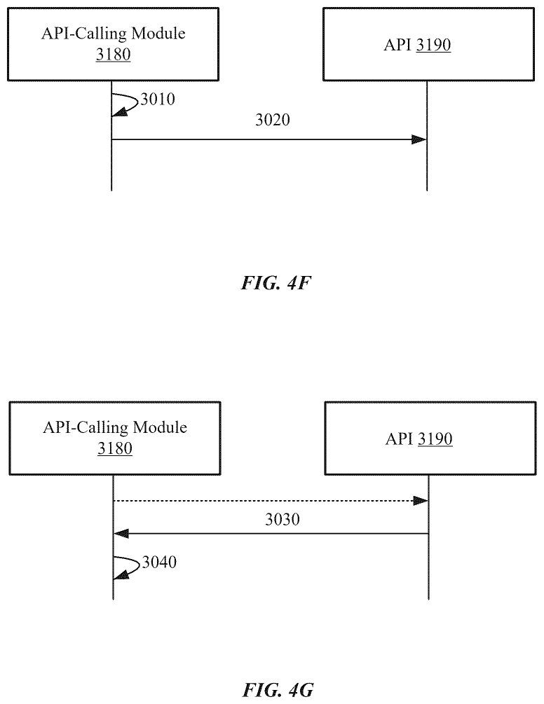

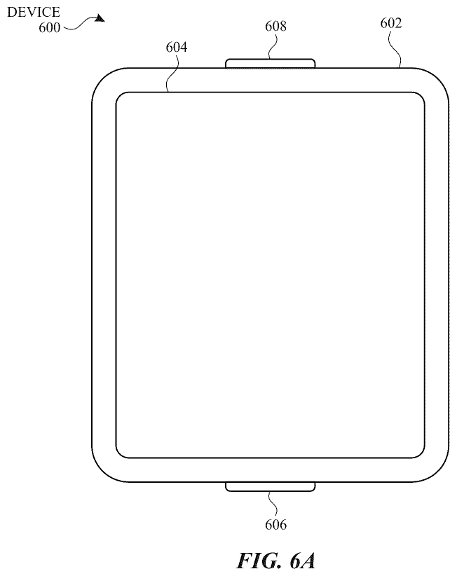

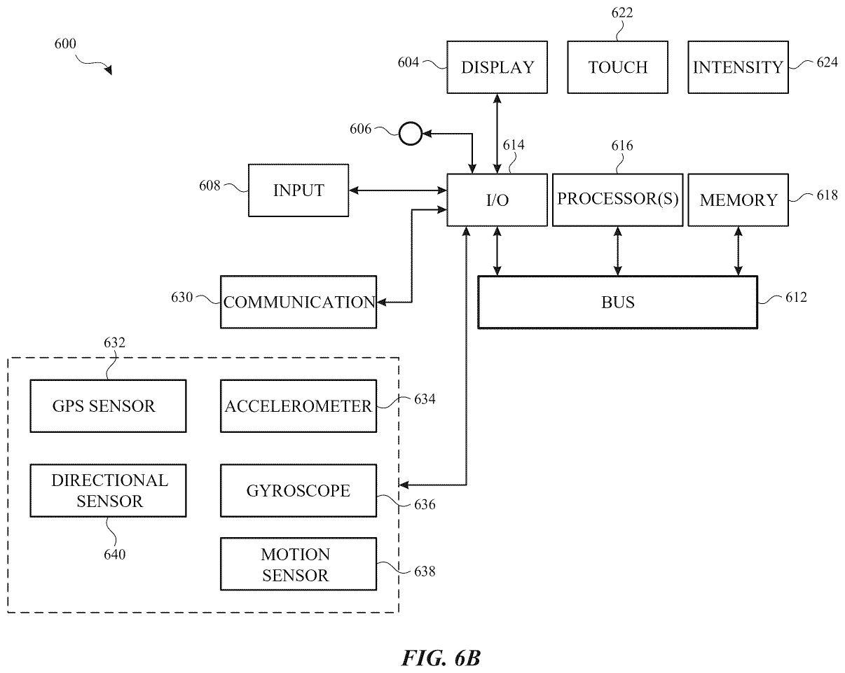

User device 104 can be any suitable electronic device. In some examples, user device 104 is a portable multifunctional device (e.g., device 200, described below with reference to FIG. 2A), a multifunctional device (e.g., device 400, described below with reference to FIG. 4A), or a personal electronic device (e.g., device 600, described below with reference to FIGS. 6A-6B). A portable multifunctional device is, for example, a mobile telephone that also contains other functions, such as PDA and/or music player functions. Specific examples of portable multifunction devices include the Apple Watch®, iPhone®, iPod Touch®, and iPad® devices from Apple Inc. of Cupertino, California. Other examples of portable multifunction devices include, without limitation, earphones/headphones, speakers, and laptop or tablet computers. Further, in some examples, user device 104 is a non-portable multifunctional device. In particular, user device 104 is a desktop computer, a game console, a speaker, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4A, and 6A-6B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and returns relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

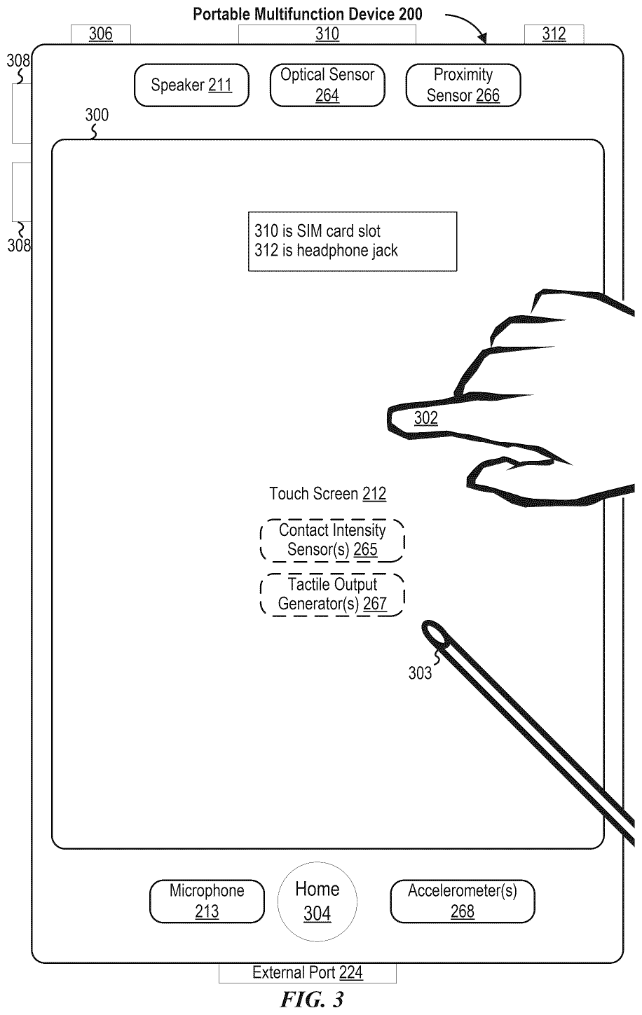

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both cars) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, California.

A touch-sensitive display in some embodiments of touch screen 212 is analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4A) stores device/global internal state 257, as shown in FIGS. 2A and 4. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts 237, email 240, IM 241, browser 247, and any other application that needs text input).

GPS module 235 determines the location of the device and provides this information for use in various applications (e.g., to telephone 238 for use in location-based dialing; to camera 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 264, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

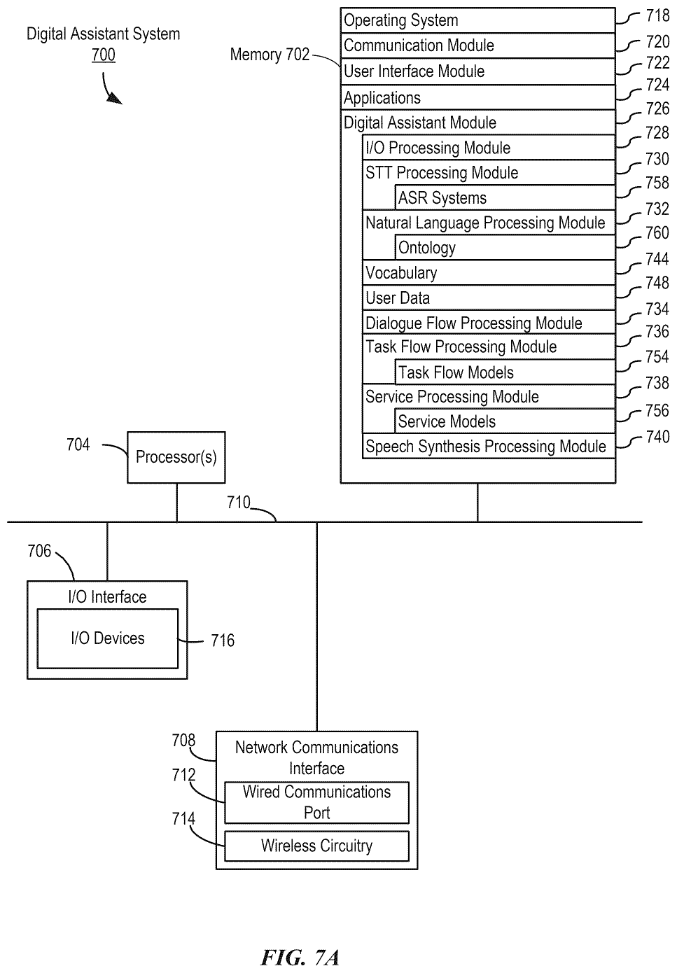

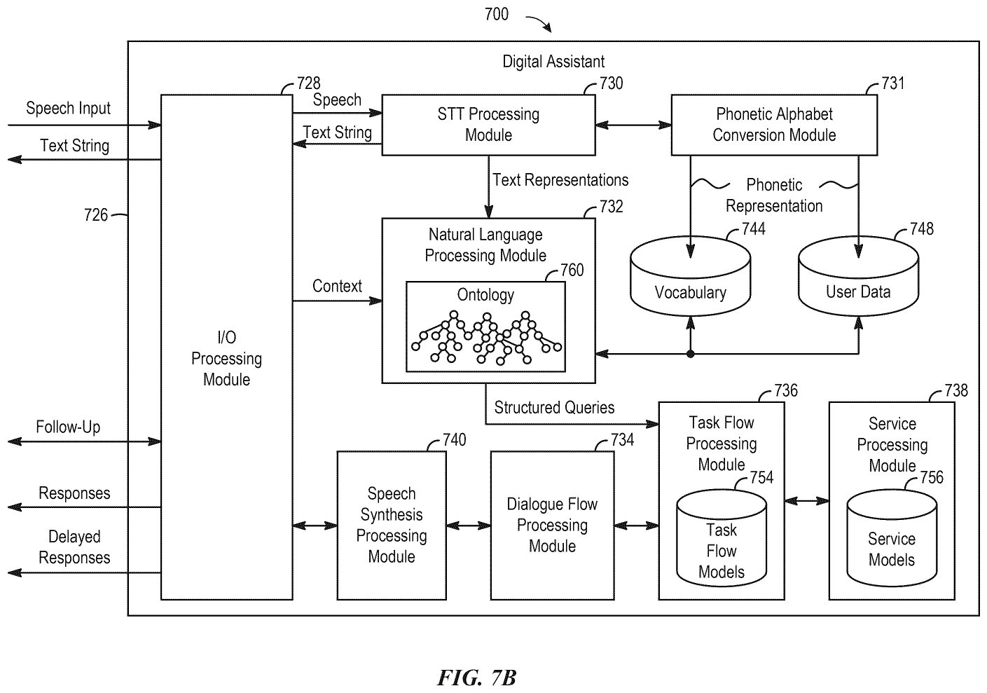

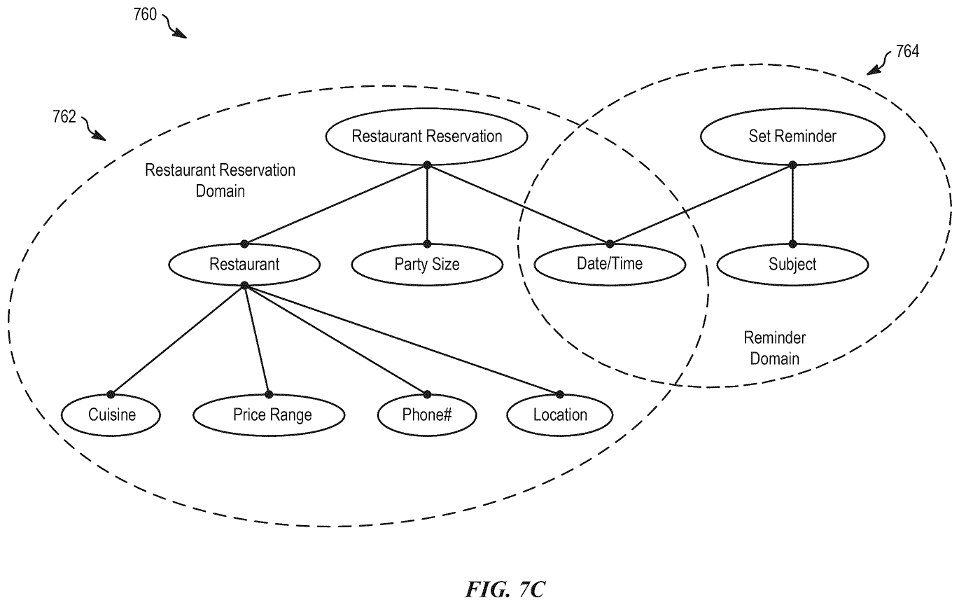

A more detailed description of a digital assistant is described below with reference to FIGS. 7A-7C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 238, video conference module 239, e-mail 240, or IM 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4A) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4A is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4A is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 4B, the method of FIG. 4C, and/or one or more other processes and/or methods described herein.

It should be recognized that application 3160 (shown in FIG. 4D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 4B and FIG. 4F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 4E) is an operating system hosted on device 3150. In some embodiments, the system (e.g., 3110 shown in FIG. 4E) is an external device (e.g., a server, a peripheral device, an accessory, and/or a personal computing device) that includes an operating system.

Referring to FIG. 4C and FIG. 4G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 4B and/or the method of FIG. 4C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 4B and/or the method of FIG. 4C by calling an application programming interface (API) (e.g., API 3190) provided by system 3110. In some embodiments, application 3160 performs at least a portion of the method of FIG. 4B and/or the method of FIG. 4C without calling API 3190.

In some embodiments, one or more steps of the method of FIG. 4B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 4D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 4D, device 3150 includes application 3160 and an operating system (e.g., system 3110 shown in FIG. 4E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 4D and 4E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 4E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

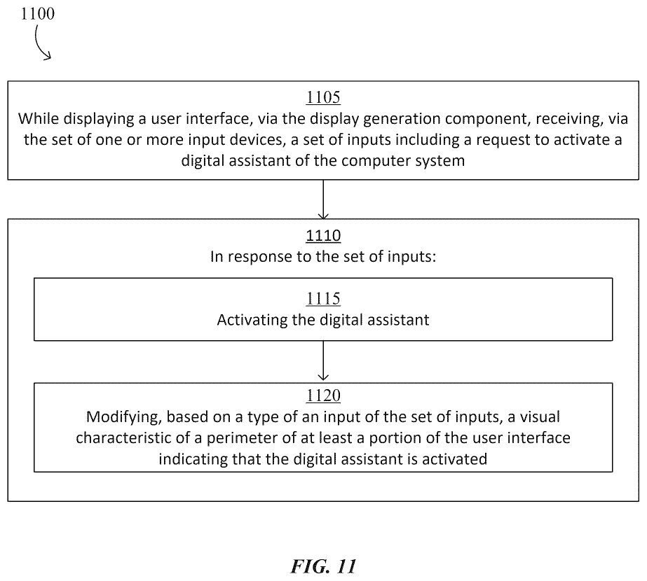

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 1100 and/or 1200 (FIGS. 11 and/or 12A-12B) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that can be implemented on, for example, portable multifunction device 200.

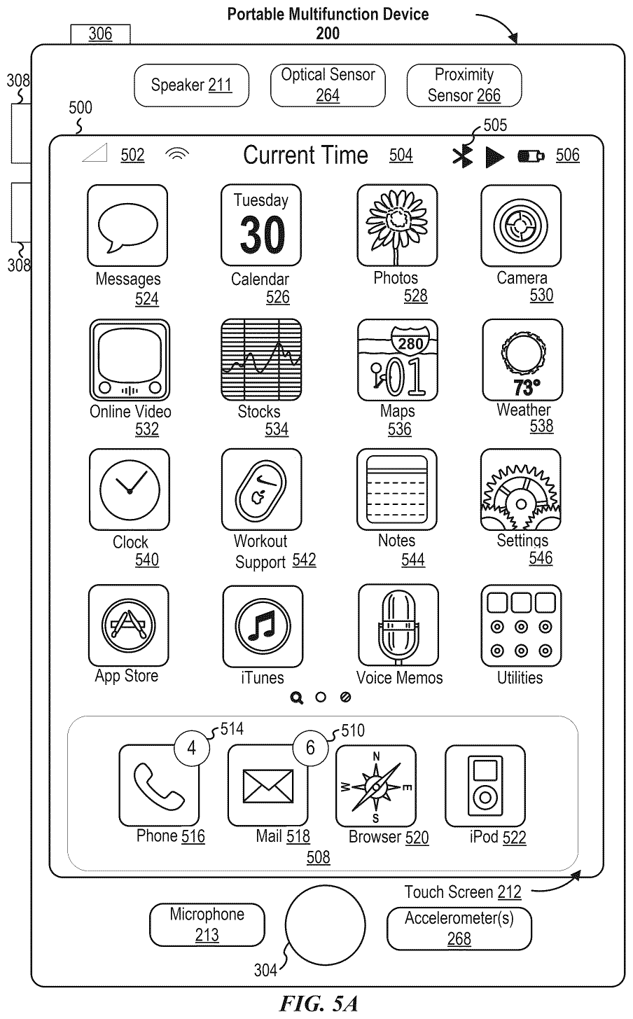

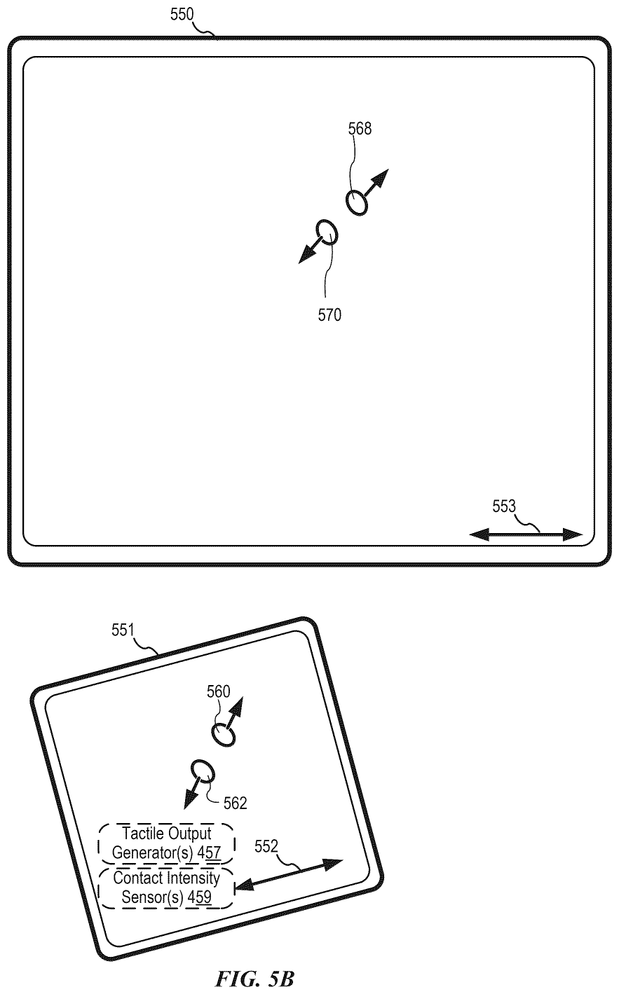

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4A) with a touch-sensitive surface 551 (e.g., a tablet or touchpad 455, FIG. 4A) that is separate from the display 550 (e.g., touch screen display 212). Device 400 also, optionally, includes one or more contact intensity sensors (e.g., one or more of sensors 459) for detecting intensity of contacts on touch-sensitive surface 551 and/or one or more tactile output generators 457 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4A). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, and/or 600 (FIGS. 2A, 4A, 6A-6B, 900, 1300, 1600, and 1800). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4A or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, 600, 900, 1300, 1600, 1800) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, 600, 900, 1300, 1600, or 1800 in FIGS. 2A, 4A, 6A-6B, 9A-90, 13A-13AF, respectively. In some examples, digital assistant system 700 represents the server portion of a digital assistant implementation, and can interact with the user through a client-side portion residing on a user device (e.g., devices 104, 200, 400, 600, 900, 1300, 1600, 1800).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VOIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIGS. 2A, 4A, 6A-6B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis processing module 740. Each of these modules has access to one or more of the following systems or data and models of the digital assistant module 726, or a subset or superset thereof: ontology 760, vocabulary index 744, user data 748, task flow models 754, service models 756, and ASR systems 758.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems 758. The one or more ASR systems 758 can process the speech input that is received through I/O processing module 728 to produce a recognition result. Each ASR system 758 includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system 758 includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of/te′merrou/and/te′matou/. Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation/te′merrou/is ranked higher than/te′matou/, because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation/te′merrou/is associated with the United States, whereas the candidate pronunciation/te′matou/is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation/te′merrou/(associated with the United States) is ranked higher than the candidate pronunciation/te′matou/(associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes/te′merrou/corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes/te′merrou/corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked property nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanisms are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string are described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=Mar. 12, 2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generates requests for the service in accordance with the protocols and APIs required by the service according to the service model.

For example, if a restaurant has enabled an online reservation service, the restaurant submits a service model specifying the necessary parameters for making a reservation and the APIs for communicating the values of the necessary parameter to the online reservation service. When requested by task flow processing module 736, service processing module 738 establishes a network connection with the online reservation service using the web address stored in the service model, and sends the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis processing module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis processing module 740 is configured to synthesize speech outputs for presentation to the user. Speech synthesis processing module 740 synthesizes speech outputs based on text provided by the digital assistant. For example, the generated dialogue response is in the form of a text string. Speech synthesis processing module 740 converts the text string to an audible speech output. Speech synthesis processing module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis processing module 740 is configured to synthesize individual words based on phonemic strings corresponding to the words. For example, a phonemic string is associated with a word in the generated dialogue response. The phonemic string is stored in metadata associated with the word. Speech synthesis processing module 740 is configured to directly process the phonemic string in the metadata to synthesize the word in speech form.

In some examples, instead of (or in addition to) using speech synthesis processing module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

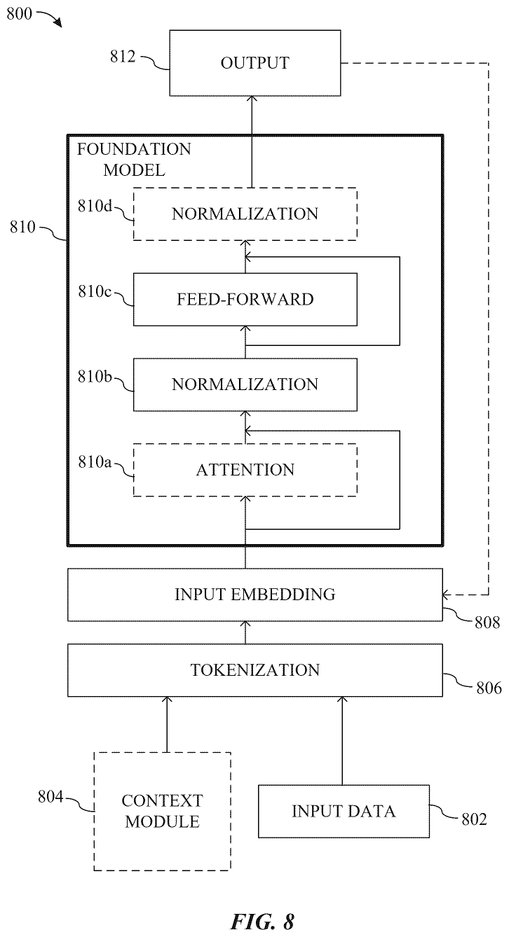

FIG. 8 illustrates exemplary foundation system 800 including foundation model 810, according to some embodiments. In some embodiments, the blocks of foundation system 800 are combined, the order of the blocks is changed, and/or blocks of foundation system 800 are removed.

Foundation system 800 includes tokenization module 806, input embedding module 808, and foundation model 810 which use input data 802 and, optionally, context module 804 to train foundation model 810 to process input data 802 to determine output 812.

In some examples, the various components of digital assistant system 700 (e.g., digital assistant module 726, operating system (e.g., 226 or 718), and/or software applications (e.g., 236 and/or 724) installed on device 104, 400, 500, 600, 900, 950, 1300, and/or 1350a) include and/or are implemented using generative artificial intelligence (AI) such as foundation model 810. In some examples, foundation model 810 include a subset of machine learning models that are trained to generate text, images, and/or other media based on sets of training data that include large amounts of a particular type of data. Foundation model 810 is then integrated into the components of digital assistant system 700 (or otherwise available to digital assistant system 700, (e.g., digital assistant module 726, operating system (e.g., 126 or 718), and/or software applications (e.g., 236 and/or 724) installed on device 104, 400, 500, 600, 900, 950, 1300, and/or 1350a via an API) to provide text, images, and/or other media that digital assistant system 700 uses to determine tasks, perform tasks, and/or provide the outputs of tasks.

Foundation models are generally trained using large sets unlabeled data first and then later adapted to a specific task within the architecture of digital assistant system 700 and/or operating system 718. Thus, a specific task or type of output is not encoded into the foundation models, rather the trained foundation model emerges based on the self-supervised training using the unlabeled data. The trained foundation model is then adapted to a variety of tasks based on the needs of the digital assistant system 700 to efficiently perform tasks for a user.

Generative AI models, such as foundation model 810, are trained on large quantities of data with self-supervised or semi-supervised learning to be adapted to a specific downstream task. For example, foundation model 810 is trained with large sets of different images and corresponding text or metadata to determine the description of newly captured image data as output 812. These descriptions can then be used by digital assistant system 700 to determine user intent, tasks, and/or other information that can be used to perform tasks. For example, generative AI models such as Midjourney, DALL-E, and stable diffusion are trained on large sets of images and are able to convert text to a generated image.

Large language models (LLM) are a type of foundation model that provide text output after being trained on large sets of input text data. As with other foundation models, LLM's can be trained in a self-supervised manner and thus the output of different LLM's trained on the same large set of input text can be different. These LLM's can then be adapted for use with digital assistant system 700 to specific types of text. Thus, in some examples, the LLM is trained to determine a summary of text provided to the LLM as an input while in other examples, the LLM is trained to predict text based on the set of input text. Thus, the LLM can efficiently process large amounts of input text to provide the digital assistant with text that can be used to determine and/or perform tasks. For example, ChatGPT, Copilot, and LLAMA are exemplary large language models that process large amounts of input text and generates text that can be used by a digital assistant, a software application, and/or an operating system.

In some examples, the LLM may be trained in a semi-supervised manner and/or provided human feedback to refine the output of the LLM. In this way, the LLM may be adapted to provide the specific output required for a particular task of digital assistant system 700, such as a summary of large amounts of text or a task for digital assistant system 700 to perform. Further, the input provided to the LLM can be adapted such that the LLM processes data as or more efficiently than digital assistant system 700 could without the use of the LLM.

Once foundation model 810 (e.g., a LLM) has been fully trained, foundation model 810 can process input data 802 as discussed below to determine output 812 which may be used to further train foundation model 810 or can be processed by digital assistant 700 to perform a task and/or provide an output to the user.

Specifically, input data 802 is received and provided to tokenization module 806 which converts input data 802 into a token and/or a series of tokens which can be processed by input embedding module 808 into a format that is understood by foundation model 810. Tokenization module 806 converts input data into a series of characters that has a specific semantic meaning to foundation model 810.

In some examples, tokenization module 806 tokenizes contextual data from context module 804 to add further information to input data 802 for processing by foundation model 810. For example, context module 804 can provide information related to input data 802 such as a location that input data 802 was received, a time that input data 802 was received, other data that was received contemporaneously with input data 802, and/or other contextual information that relates to input data 802. Tokenization module 806 can then tokenize this contextual data with input data 802 to be provided to foundation model 810.

After input data 802 has been tokenized, input data 802 is provided to input embedding module 808 to convert the tokens to a vector representation that can be processed by foundation model 810. In some examples, the vector representation includes information provided by context module 804. In some examples, the vector representation includes information determined from output 812. Accordingly, input embedding module 808 converts the various data provided as an input into a format that foundation model 810 can parse and process.

For example, when foundation model 810 is a large language model (LLM) tokenization module 806 converts input data 802 into text which is then converted into a vector representation by input embedding module 808 that can be processed by foundation model 810 to determine a response to input data 802 as output 812 or to determine a summary of input data 802 as output 812. As another example, when foundation model 810 is a model that has been trained to determine descriptions of images, input data 802 of images can be tokenized into characters and then converted into a vector representation by input embedding module 808 that is processed by foundation model 810 to determine a description of the images as output 812.

Foundation model 810 processes the received vector representation using a series of layers including, in some embodiments, attention layer 810a, normalization layer 810b, feed-forward layer 810c, and/or normalization layer 810d. In some examples, foundation model 810 includes additional layers similar to theses layers to further process the vector representation. Accordingly, foundation model 810 can be customized based on the specific task that foundation model 810 has been trained to perform. Each of the layers of foundation model 810 perform a specific task to process the vector representation into output 812.

Attention layer 810a provides access to all portions of the vector representation at the same time, increasing the speed at which the vector representation can be processed and ensuring that the data is processed equally across the portions of the vector representation. Normalization layer 810b and normalization layer 810d scale the data that is being processed by foundation model 810 up or down based on the needs of the other layers of foundation model 810. This allows foundation model 810 to manipulate the data during processing as needed. Feed-forward layer 810c assigns weights to the data that is being processed and provides the data for further processing within foundation model 810. These layers work together to process the vector representation provided to foundation model 810 to determine the appropriate output 812.

For example, as discussed above, when foundation model 810 is a large language model (LLM) foundation model 810 processes input text to determine a summary and/or further follow-up text as output 812. As another example, as discussed above, when foundation model 810 is a model trained to determine descriptions of images, foundation model 810 processes input images to determine a description of the image and/or tasks that can be performed based on the content of the images as output 812.

In some examples, output 812 is further processed by digital assistant system 700 (e.g., digital assistant module 726, operating system (e.g., 126 or 718), and/or software applications (e.g., 136 and/or 724) installed on device 104, 400, 500, 600, 900, 950, 1300 and/or 1350a) to provide an output or execute a task. For example, when output 812 is a sentence describing a task that digital assistant system 700 has performed, digital assistant system 700 can use the text to create a visual or audio output to be provided to a user. As another example, when output 812 is text that includes a function and a parameter for the function, digital assistant system 700 can perform a function call to execute the function with the provided parameter.

In some examples, digital assistant system 700 includes multiple generative AI (e.g., foundation) models that work together to process data in an efficient manner. In some examples, components of digital assistant system 700 may be replaced with generative AI (e.g., foundation) models trained to perform the same function as the component. In some examples, these generative AI models are more efficient than traditional components and/or provide more flexible processing and/or outputs for digital assistant system 700 to utilize.

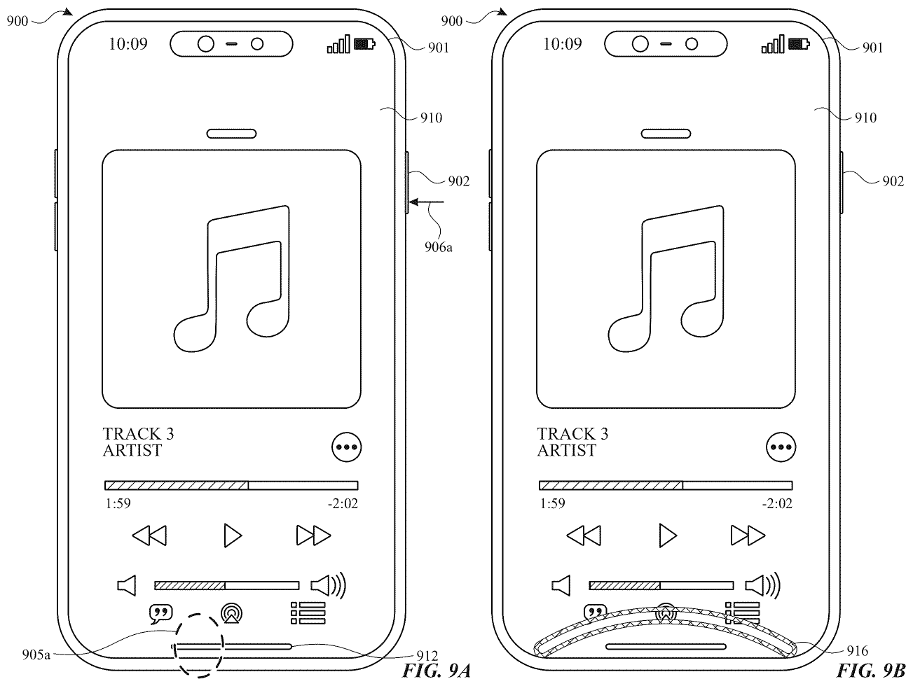

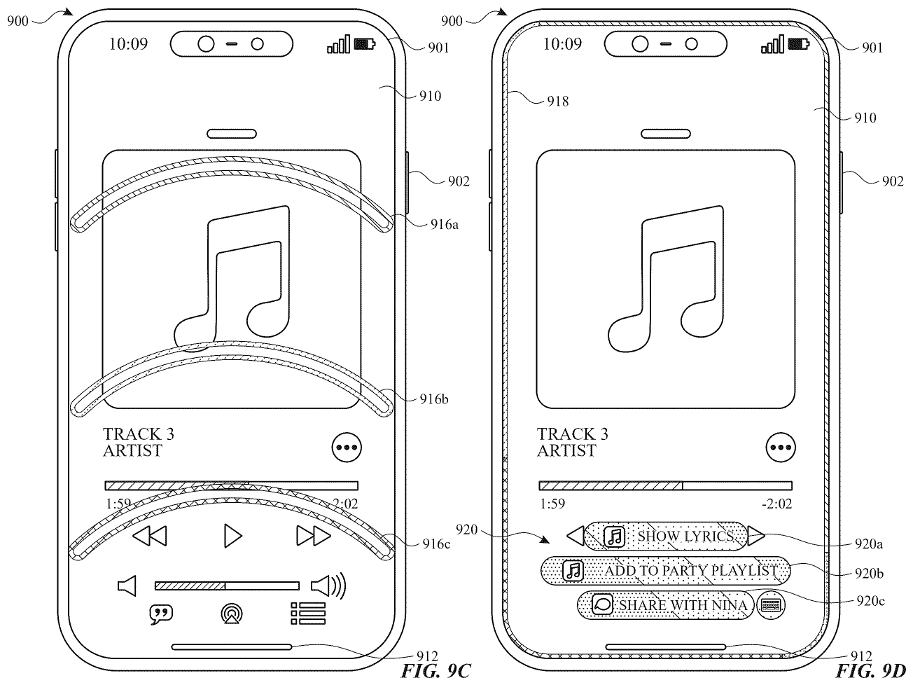

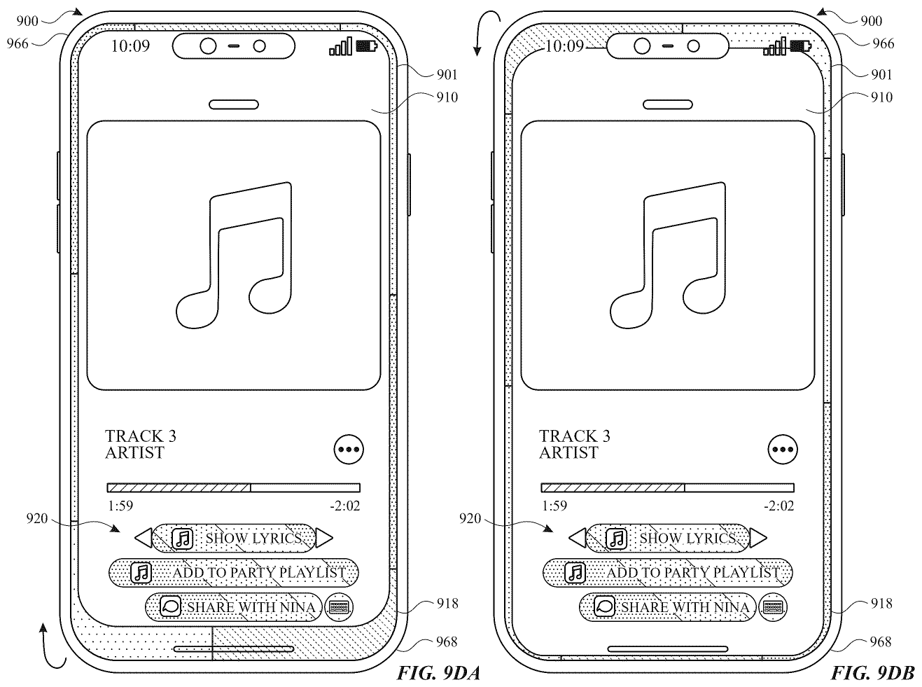

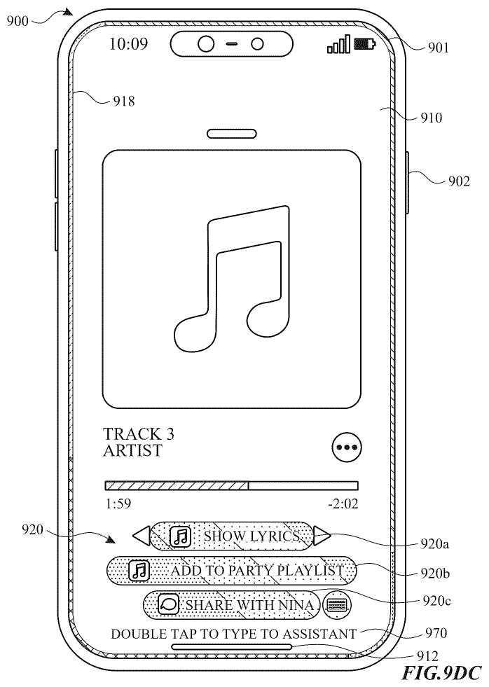

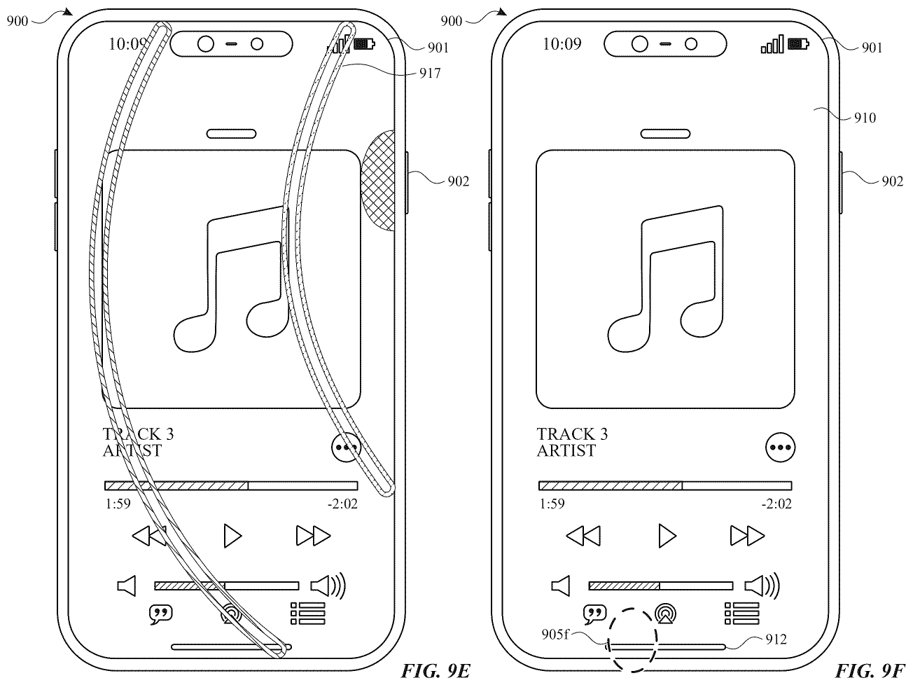

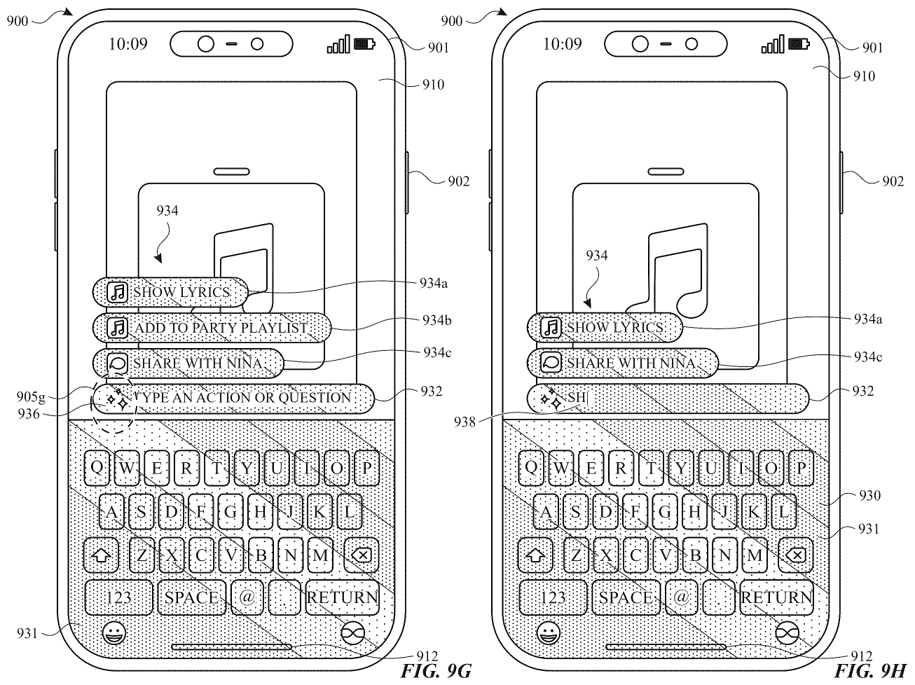

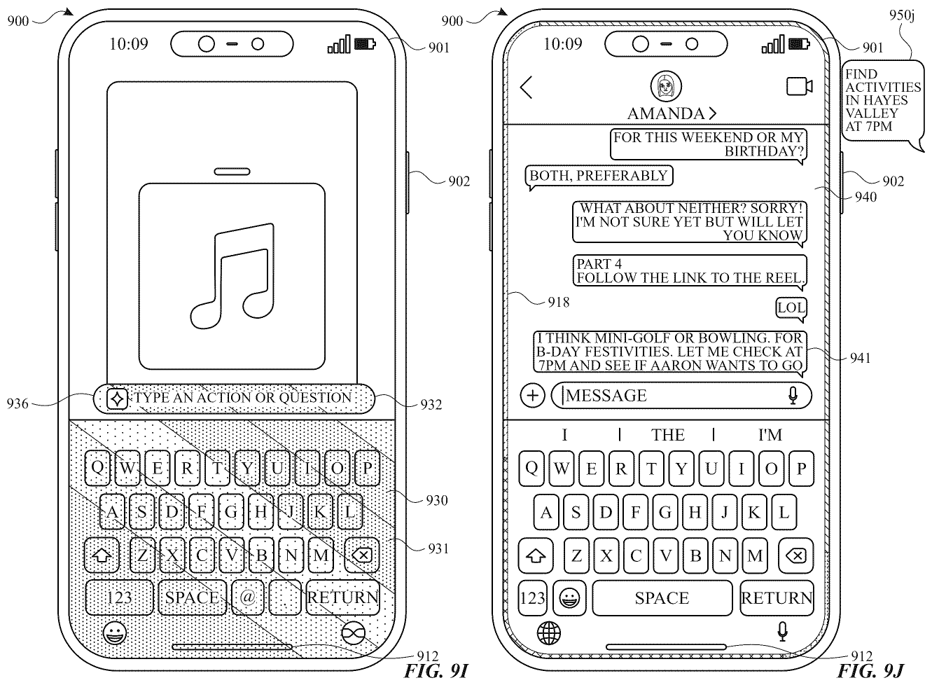

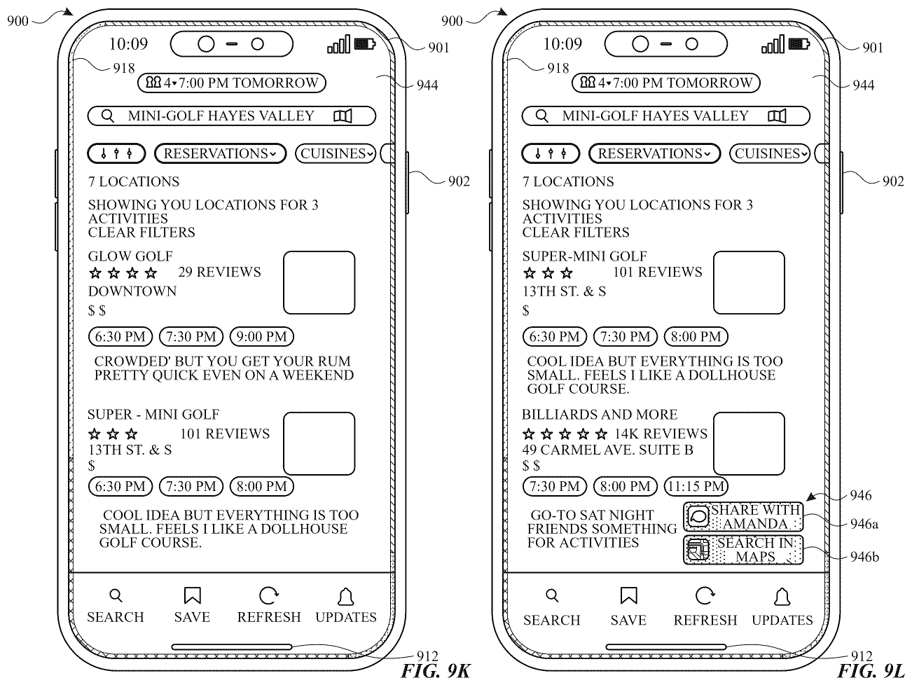

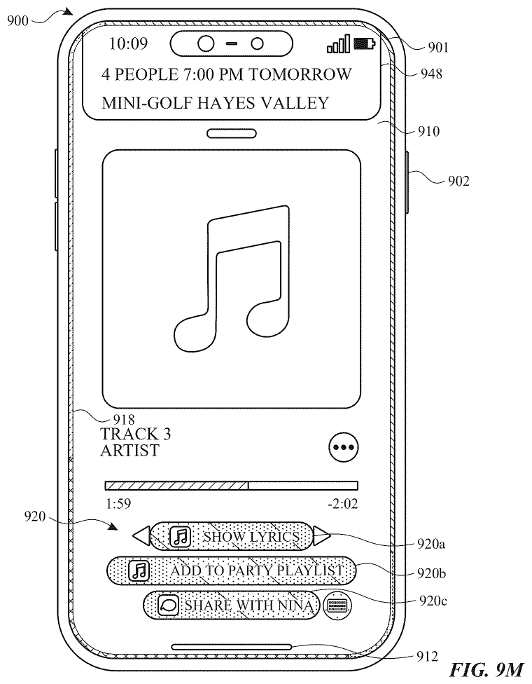

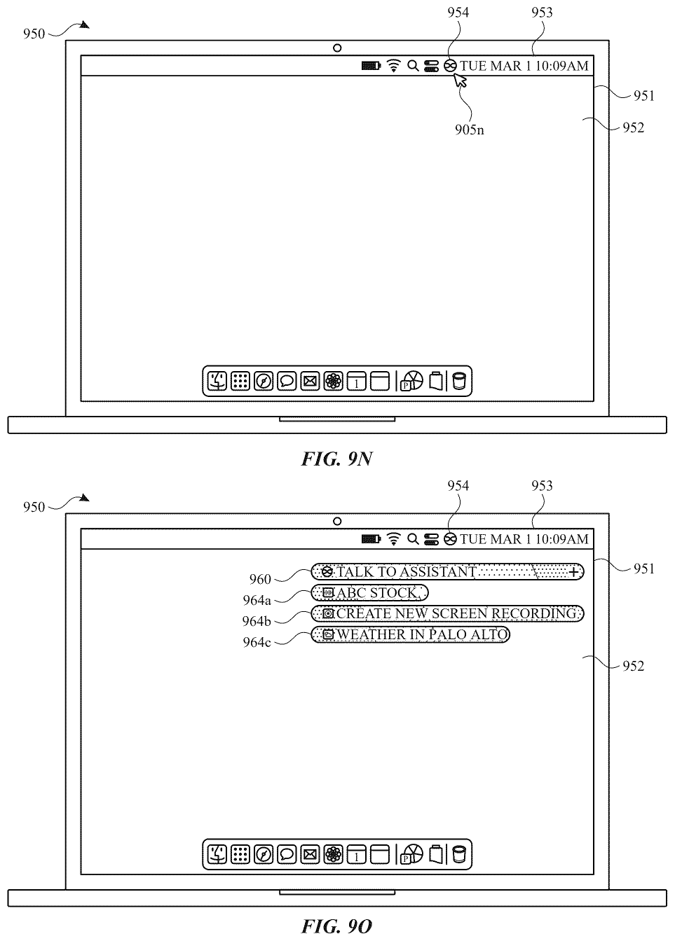

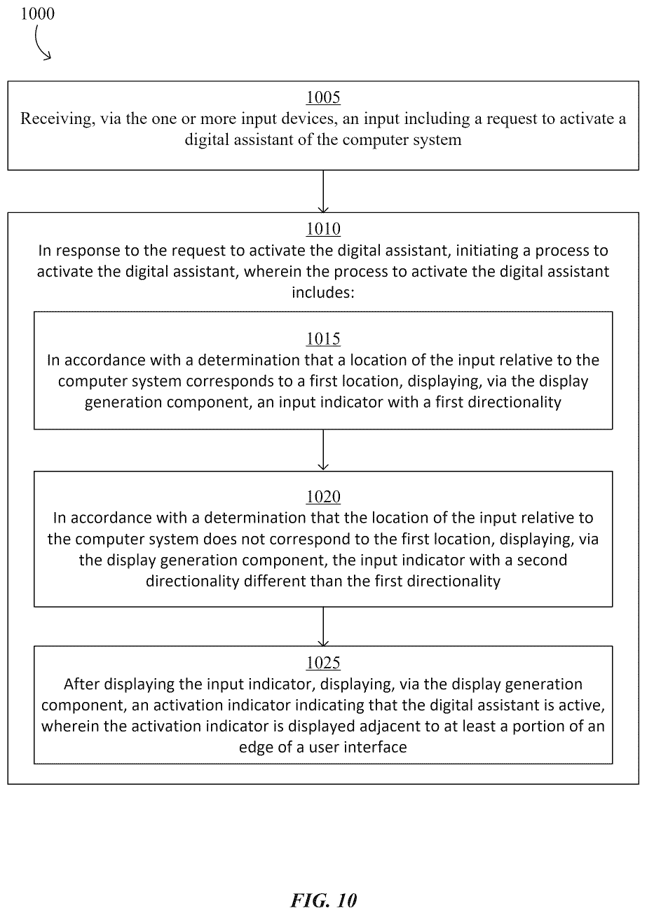

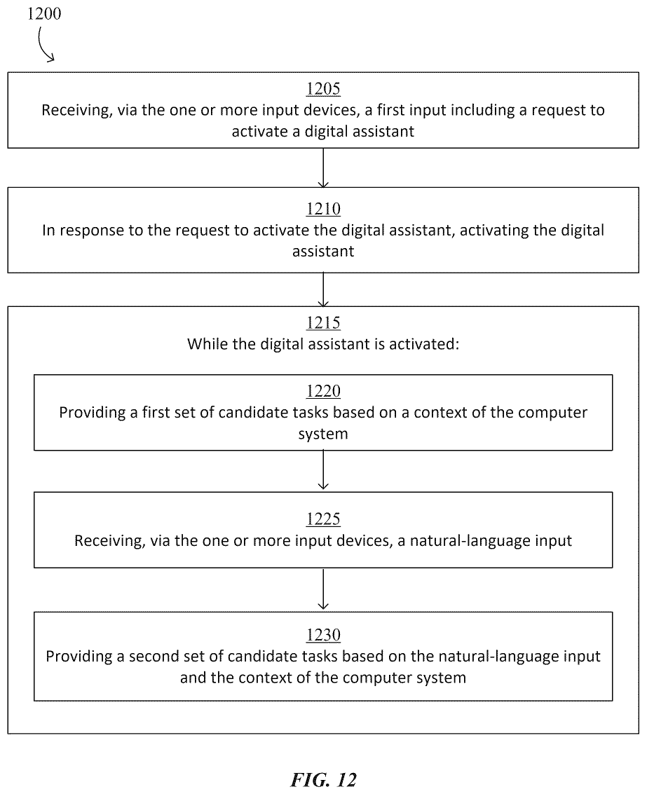

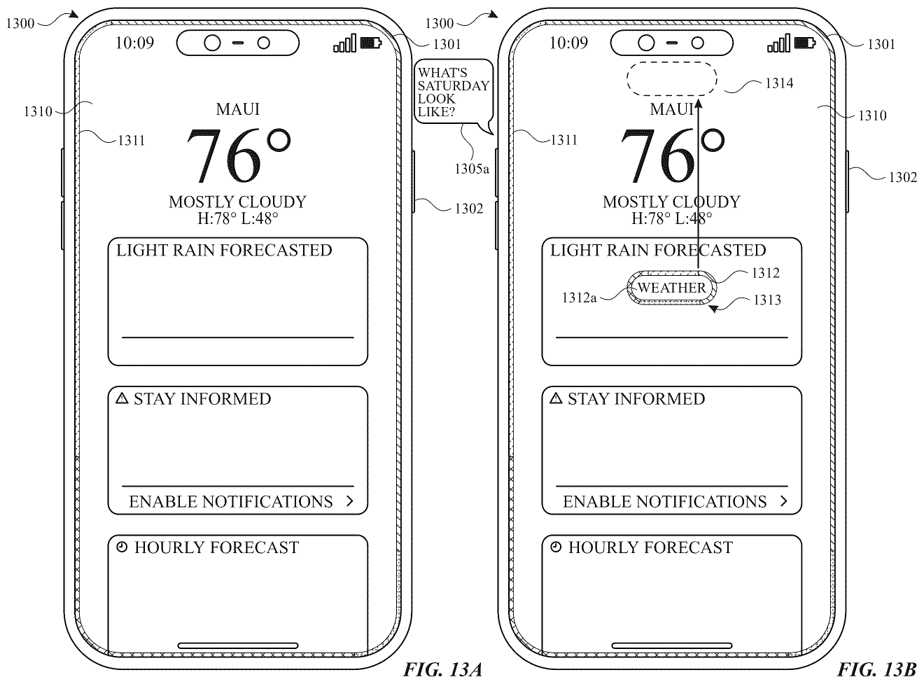

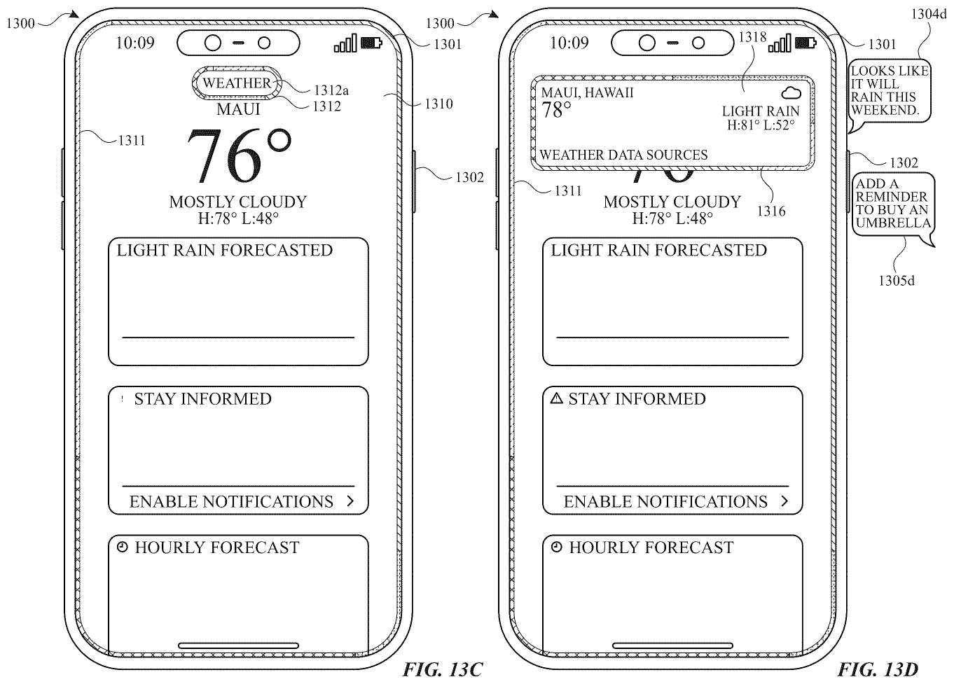

FIGS. 9A-90 illustrate exemplary user interfaces for managing a digital assistant, according to various examples. These figures are also used to illustrate processes described below, including process 1000 of FIG. 10, process 1100 of FIG. 11, and process 1200 of FIG. 12.

In some examples, a digital assistant of an electronic device can be activated (e.g., initialized) in a number of modes including a voice mode and a text input mode. Typically, when initialized in the voice mode, a digital assistant operates in a manner that allows a user to communicate with the digital assistant using voice inputs (e.g., natural-language speech inputs). In some examples, when activating a digital assistant, an electronic device displays an activation indicator (e.g., of a first type) to indicate to the user that the digital assistant has been activated in the voice mode. In some examples, the digital assistant is activated in the voice mode in response to any of a set of predefined input types, including but not limited to touch inputs (e.g., of a particular duration and/or at a particular location), button presses, and/or voice inputs requesting activation of the digital assistant (e.g., voice inputs including a trigger word or phrase). When initialized in the text input mode, a digital assistant operates in a manner that allows a user to communicate with the digital assistant using text inputs. In some examples, the electronic device displays an activation indicator (e.g., of a second type) and/or interface to indicate to a user that the digital assistant has been activated in the text input mode. In some examples, the digital assistant is activated in the text input mode in response to any of a set of predefined input types, including but not limited to touch inputs (e.g., of a particular duration and/or at a particular location).

In some examples, a digital assistant can communicate with a user using multiple types of communication in one or more modes. For example, when the digital assistant is operating in the voice mode, a user may communicate with (e.g. provide communications to) the digital assistant using text inputs and when the digital assistant is operating in the text mode, a user may communicate with the digital assistant using voice inputs.

FIG. 9A illustrates an electronic device 900 (e.g., device 104, device 122, device 200, device 600, or device 700). In the non-limiting exemplary embodiment illustrated in FIGS. 9A-9M, electronic device 900 is a smartphone. In other embodiments, electronic device 900 can be a different type of electronic device, such as a desktop or laptop computer, tablet device, wearable device (e.g., a smartwatch, headset), a smart speaker, and/or a set-top box. In some examples, electronic device 900 has a display 901, one or more input devices (e.g., a touchscreen of display 901, a button, a microphone), and a wireless communication radio. In some examples, electronic device 900 includes one or more forward facing and/or back facing cameras. In some examples, the electronic device includes one or more biometric sensors which, optionally, include a camera, such as an infrared camera, a thermographic camera, or a combination thereof.

FIGS. 9A-9E illustrate various aspects of activating a digital assistant in a voice mode. For example, at FIG. 9A, electronic device 900 displays, on display 901, application interface 910 on display 901 while a digital assistant of electronic device 900 is deactivated. In some examples, application interface corresponds to a music application (e.g., for performing audio playback) of electronic device 900 and includes a home affordance 912.

While displaying the application interface 910, electronic device 900 detects input 905a at a location corresponding to home affordance 912. In some examples, input 905a is a touch gesture persisting at least a threshold amount of time (e.g., 0.5s, 1.0s). In response to detecting input 905a, electronic device 900 activates the digital assistant in the voice mode. In some examples, the digital assistant may be activated in the voice mode in response to one or more other input types, such as a tap gesture (e.g., single tap, double tap) on home affordance 912.

With reference to FIGS. 9B-C, in some examples, while activating the digital assistant, electronic device 900 displays an input indicator 916 indicating that electronic device 900 is activating the digital assistant. In some examples, the input indicator 916 is an animation, such as a “ripple” animation including a ripple effect, e.g., waves of light and/or distortion moving across the display (in this example from the bottom to top of the display). In some examples, input indicator 916 is dynamically displayed. Each ripple of input indicator 916 may for instance, shimmer (e.g., independently of other ripples) across a predefined spectrum of colors. In some examples, one or more ripples may be displayed such that the colors and/or brightness of one or more ripples is displayed according to a random noise function and, optionally, one or more smoothing filters and/or blur filters. While in FIG. 9C input indicator is shown as having three ripples (e.g., ripples 916a-c), it will be appreciated that input indicator 916 may include any number of ripples (e.g., one, five). In some examples, input indicator 916 briefly modifies (e.g., distorts) display of one or more portions (e.g., objects) of application interface 910 as input indicator 916 traverses display 901. As an example, one or more portions of application interface 910 may be distorted (e.g., blurred, stretched in one or more directions, compressed in one or more directions) while input indicator 916 is displayed. In some examples, this may include distorting portions of application interface 910 that are proximate one or more ripples of input indicator 916 as input indicator 916 traverses across user interface 910. As illustrated in FIG. 9D, after displaying input indicator 916, electronic device 900 displays activation indicator 918 indicating that the digital assistant of the electronic device 900 has been activated in the first mode. In some examples, displaying activation indicator 918 includes highlighting (e.g., visually highlighting) at least a portion of application interface 910. In some examples, highlighting a portion of application interface 910 includes providing a glow effect on the portion of application interface 910. In some examples, activation indicator 918 is animated such that brightness and/or color of activation indicator 918 fluctuates, flickers, and/or changes in size dynamically.

In some examples, when the digital assistant is invoked in the voice mode, the electronic device 900 displays activation indicator 918 along the perimeter of display 901. Because, in some examples, application interface 910 is displayed on the entirety of display 901, activation indicator 918 can also be displayed along the perimeter of application interface 910. In some examples, activation indicator 918 is displayed along a portion of the perimeter of display 901 and/or application interface 910. In other examples, activation indicator 918 is displayed along the entirety of the perimeter of display 901 and/or application interface 910.

In some examples, activation indicator 918 is overlaid on a portion of application interface 910 and, optionally, is at least partially transparent such that the underlying portions of application interface 910 remain visible to a user when activation indicator 918 is displayed. In some examples, electronic device 900 displays activation indicator 918 without highlighting (e.g., changing and/or altering) portions of the display of electronic device 900 that are not included within the portion of the display that is highlighted as a result of displaying activation indicator 918.

In some examples, electronic device 900 modifies activation indicator 918 based on detected movement (e.g., rotation, translation, or other change in position) of electronic device 900. For example, with reference to FIG. 9DA, a user of electronic device 900 may rotate electronic device 900 in a first direction such that device end 968 is closer to the user and device end 966 is further from the user. In response, electronic device 900 may visually emphasize (e.g., enlarge, thicken, brighten, highlight, animate, change color) portions of activation indicator 918 proximate end 968 and visually deemphasize (e.g., shrink, thin, dim, change color) portions of activation indicator 918 proximate end 966. The magnitude to which activation indicator 918 is adjusted may, in some examples, depend on the magnitude of movement detected by electronic device 900.

In some examples, electronic device 900 continues to modify activation indicator 918 based on detected movement. As shown in FIG. 9DB, a user of electronic device 900 may rotate electronic device 900 in a second direction (e.g., opposite the first direction) such that device end 966 is closer to the user and device end 968 is further from the user. In response, electronic device 900 may visually emphasize (e.g., enlarge, thicken, brighten, highlight, animate, change color) portions of activation indicator 918 proximate end 966 and visually deemphasize (e.g., shrink, thin, dim, change color) portions of activation indicator 918 proximate end 968.

In some examples, electronic device 900 modifies activation indicator 918 based on user input. As an example, electronic device 900 can modify activation indicator 918 based on voice inputs. As a voice input is received, for instance, electronic device 900 can visually emphasize portions of activation indicator 918 closest to a location of the user (e.g., as determined based on the voice input), and/or visually deemphasize portions of activation indicator 918 furthest from the location of the user. In some examples, electronic device 918 further may visually emphasize (e.g., brighten) activation indicator 918 while a user is speaking, and optionally, a portion of activation indicator 918 to include a waveform reflecting the user's voice input. In some examples, the waveform is dynamic and/or updated in real-time as the user speaks.

As another example, electronic device 900 can modify activation indicator 918 based on user gaze. Electronic device 900 can, for instance, visually emphasize portions of activation indicator 918 proximate portions of display 901 viewed by a user and/or visually deemphasize portions of activation indicator 918 proximate portions if display 901 not viewed by a user.

In some examples, electronic device 900 prompts a user to activate a digital assistant in a particular mode. In some examples, while operating in a first mode (e.g., voice mode), electronic device 900 prompts the user to activate the digital assistant in a second mode (e.g., text input mode). For example, with reference to FIG. 9DC, while operating in a voice mode, electronic device 900 displays prompt 970 (e.g., “Double tap to type to Assistant”) indicating that a user input of a specified type (e.g., a double tap) may cause the digital assistant to be activated in the text input mode. In some examples, prompt 970 is provided proximate (e.g., above) home bar 912, and inputs (of the specified type) detected at a location corresponding to home bar 912 cause the digital assistant to be activated in the text input mode. In some examples, electronic device 900 prompts a user if, after being activated, no user input (e.g., of a particular type) is received for a predetermined amount of time.

With reference to FIG. 9D, in some examples, once the digital assistant of electronic device 900 is activated, electronic device 900 can, optionally, provide a set of candidate suggestions 920 (e.g., tasks). In some examples, once the digital assistant is activated, electronic device 900 automatically (e.g., without user input) displays candidate suggestions 920. In some examples, electronic device 900 displays candidate suggestions 920 in response to an input received after activation of the digital assistant (e.g., a swipe gesture on application interface 910). In some examples, electronic device 900 displays candidate suggestions 920 after performing a task. In some examples, one or more suggestions provided after performance of a task may correspond to the previous task.

In some examples, each candidate suggestion (e.g., any of suggestions 920a-c) corresponds to a respective task that may be performed by the digital assistant in response to selection of the candidate suggestion. In some examples, when displaying suggestions 920, electronic device 900 modifies a visual characteristic of the suggestions 920. As an example, electronic device 900 can highlight one or more of the suggestions, for instance, by providing a glow effect on the one or more suggestions.

In some examples, one or more of suggestions 920 are provided based on a context of electronic device 900. Context information used in this manner includes, but is not limited to, a currently displayed application on electronic device 900 (e.g., an application corresponding to application interface 910), one or more applications executing and/or stored on electronic device 900, a location of device 900, a position of a user relative to device 900, or any combination thereof. As shown in FIG. 9D, for example, electronic device 900 provides suggestion 920a (“Show lyrics”), suggestion 920b (“Add to party playlist”), and suggestion 920c (“Share with Nina”), each of which corresponds to the currently displayed application (recall that application interface 910 corresponds to a music application). Suggestions 920a,b are tasks that can be performed by electronic device 900 (and/or the digital assistant of electronic device 900) using the displayed application, and suggestion 920c can be performed by electronic device 900 using another application of electronic device 900 (e.g., a messaging application) with information provided by the current application.

In some examples, the digital assistant of electronic device 900 can be activated using other types of inputs. For example, with reference to FIG. 9A, while displaying user interface 910, electronic device 900 detects an input 906a. The input 906a is a button press (e.g., sustained press, double press) of button 902 in some examples. In response to input 906a, electronic device 900 activates the digital assistant and while activating the digital assistant, displays an input indicator. As shown in FIG. 9E, in response to input 906a, electronic device 900 activates the digital assistant and displays input indicator 917. In some examples, input indicator is a “ripple” animation including a ripple effect.

In some examples, an input indicator displayed by electronic device 900 has a directionality. An input indicator can, for instance, be associated with one or more particular directions based on a location of an input. As an example, an input indicator may have a directionality corresponding to a direction (or multiple directions) that moves away from a location of an input. As an example, in FIGS. 9B-9C, input indicator 916 has a directionality corresponding to a direction that movies away from a location of input 905a. Accordingly, input indicator 916 moves away (e.g., outward) from the location of input 905a. As another example, in FIG. 9E, input indicator 917 has a directionality corresponding to a direction (or multiple directions) that moves away from a location of input 906a. As a result, input indicator 917 moves away from the location of button 902.

In some examples, a directionality of an input indicator is based on a type of an input. For example, in some instances, the digital assistant of electronic device 900 is activated in the voice mode using a voice input, such as a speech input including a request (e.g., trigger word or phrase) to activate the digital assistant. In response, electronic device 900 activates the digital assistant, and, while activating the digital assistant displays an input indicator indicating that electronic device 900 is activating the digital assistant in response to the voice input. In some examples, because activation of the digital assistant was made in response to a voice input, the input indicator has a directionality that moves away from a location of an edge of display 901 (e.g., the edge nearest home affordance 912). In other examples, an input indicator corresponding to a voice input has a directionality based on a position of the user relative to electronic device 900, such as a directionality that is opposite the position of the user (e.g., the input indicator has a directionality opposite the direction of the user's voice).

FIGS. 9F-91 illustrate various aspects of activating a digital assistant in a text input mode. For example, at FIG. 9F, electronic device 900 displays, on display 901, application interface 910 on display 901 while a digital assistant of electronic device 900 is deactivated.

While displaying the application interface 910, electronic device 900 detects input 905f at a location corresponding to home affordance 912. In some examples, 905f is a tap gesture including at least a threshold number of taps (e.g., two, three). In response to detecting input 905f, electronic device 900 activates the digital assistant in the text input mode. Optionally, while electronic device 900 activates the digital assistant in the text input mode, electronic device 900 displays an input indicator, as described.

In some examples, when activating the digital assistant in the text input mode, electronic device 900 displays text communication user interface 930, which is, optionally, overlaid on user interface 910. In some examples, text communication interface 930 includes digital assistant keyboard 931 and text input field 932. In some examples, digital assistant keyboard 931 provides text communication between a user and the digital assistant of electronic device 900. By way of example, a user may provide text inputs using digital assistant keyboard 931 to insert one or more characters into text input field 932. Thereafter, text input may be provided to the digital assistant, for instance, to cause the digital assistant to perform one or more tasks corresponding to the text input.

Text communication user interface 930 further includes suggestions 934, which when selected, cause the digital assistant to perform respective tasks associated with the suggestions. In some examples, suggestions 934 are provided based on context of electronic device 900, as described.

In some examples, electronic device 900 highlights one or more elements of text communication user interface 930. Electronic device 900 may, for instance, highlight digital assistant keyboard 931, text input bar 932, and/or suggestions 934. In some examples, highlighting in this manner includes providing a glow effect. In some examples, highlighting includes highlighting the entirety of elements of text communication interface 930, and in other examples, highlighting includes highlighting a portion (e.g., a perimeter) of text communication interface 930. By highlighting elements of text communication user interface 930 in this manner, electronic device 900 can signal to a user that elements of the text communication user interface 930 are available for communication with a digital assistant of electronic device 900. This may, for instance, help to visually differentiate displayed elements that are intended for communication with the digital assistant (e.g., digital assistant keyboard 931) and those that corresponding to an application that was executing on the electronic device 900 when the digital assistant was activated in the text mode.

In some examples, electronic device 900 highlights different portions of elements (e.g., of text communication user interface 930) in respective manners. As an example, a perimeter of digital assistant keyboard 931 may be highlighted in a first manner (e.g., with a glow effect having a first brightness, color, and/or animation) and another portion (e.g., an interior portion) of digital assistant keyboard 931 may be highlighted in a second manner different than the first manner (e.g., with a glow effect having a second brightness, color, and/or animation different than the first brightness, color, and/or animation).

In some examples, a user can modify suggestions provided by electronic device 900. A user can, for instance, provide an input (e.g., a text input including one or more characters) into text input field 932 (e.g., using digital assistant keyboard 931) and in response, electronic device 900 modifies (e.g., update) suggestions 934 based on the input. With reference to FIG. 7H, for example, a user provides an input “sh” to text input field 932, and in response, electronic device 900 provides suggestions 934a (“Show lyrics”) and 934c (“Share with Nina”) corresponding to the text input “sh” and ceases to provide suggestion 934b (“Add to party playlist”), which does not correspond to the text input “sh”.

Text input field 932 can, optionally, include toggle affordance 936, which when selected, causes electronic device 900 to cease display of suggestions 934. For example, with reference to FIG. 9G, while displaying text communication user interface 930, electronic device 900 detects an input 905g. The input 905g is a tap input in some examples. As shown in FIG. 91, in response to input 905g, electronic device 900 ceases to display suggestions 934 and updates display of affordance 936 to indicate that display of suggestions is disabled.

At FIG. 9J, electronic device 900 displays, on display 901, application interface 940 while a digital assistant of electronic device 900 is activated in a voice mode. While the digital assistant is activated, electronic device 900 receives input 905j. In some examples, input 905j is a natural-language speech input indicative of a request directed to the digital assistant of electronic device 900 (e.g., “Find activities in Hayes Valley at 7 pm”).

In response to input 905j, electronic device 900 initiates performance of a task corresponding to input 905j. For example, as shown in FIG. 9K, electronic device 900 retrieves a set of search results corresponding to the request of input 905j and displays the search results in search interface 944.

In some examples, electronic device 900 performs tasks based on context information. Context information used in this regard can include information corresponding to a currently displayed application, user-specific information (e.g., contacts, calendar, user behavior), or a combination thereof. Context information used by electronic device 900 can be stored on electronic device 900, in applications of electronic device 900, or on another device in communication with electronic device 900. As shown in FIG. 9J, for example, message 941 references a potential activity “mini golf” which can be used by electronic device 900 when searching for activities as requested by input 905j.

After performing the task, electronic device 900 optionally displays suggestions 946 in search interface 944, as shown in FIG. 9L. In some examples, suggestions 946 are displayed at a same time as search interface 944. In some examples, suggestions 946 are displayed a threshold amount of time after search interface 944 is displayed. In some examples, suggestions 946 are displayed in response to an input (e.g., a swipe gesture) received by electronic device 900 while displaying search interface 944. In some examples, suggestions 946 are displayed based on context of electronic device (e.g., a current application, a previously used application), as described.

In some examples, when a digital assistant of electronic device 900 is activated, a result of a previous task (e.g., a task previously performed by a digital assistant) may be displayed. For example, in FIG. 9M, electronic device 900 displays, on display 901, application interface 910 while a digital assistant of electronic device 900 is activated in a voice mode. Because the digital assistant of electronic device 900 had previously provided a result, for instance during a previous digital assistant session, electronic device 900 displays result 948. In some examples, result 948 is partially displayed such that a user can reveal the entirety of result 948 using an input (e.g., a drag input or swipe gesture). In some examples, previous results are displayed in this manner if the previous result satisfies a set of results criteria. In some examples, the set of results criteria includes a criterion that is satisfied when the previous result was provided within a threshold amount of time (e.g., 8 minutes).

In some examples, additional results of one or more previous digital assistant sessions may be displayed. By way of example, multiple results may be displayed in response to a user selecting result 948 (e.g., a drag input or swipe gesture on result 948 causes electronic device 900 to display multiple results provided during previous digital assistant sessions). As another example, computing device 900 may display a results interface (not shown) in response to an input (e.g., a swipe input such as a left swipe input or a right swipe input). The results interface can, optionally, include any number of results previously provided by the digital assistant. In some examples, only those results satisfying the set of results criteria are included in the results interface.

FIGS. 9N-90 illustrate various aspects of activating a digital assistant of electronic device 950. FIGS. 9N-90 illustrates an electronic device 950 (e.g., device 104, device 122, device 200, device 600, or device 700). In the non-limiting exemplary embodiment illustrated in FIGS. 9N-90, electronic device 950 is a personal computer. In other embodiments, electronic device 950 can be a different type of electronic device, such as a mobile device, desktop or laptop device, tablet device, a wearable device (e.g., a smartwatch, headset), a smart speaker, and/or a set-top box. In some examples, electronic device 950 has a display 951, one or more input devices (e.g., a touchscreen of display 951, a button, a microphone, a keyboard, a mouse), and a wireless communication radio. In some examples, electronic device 950 includes one or more forward facing and/or back facing cameras. In some examples, the electronic device includes one or more biometric sensors which, optionally, include a camera, such as an infrared camera, a thermographic camera, or a combination thereof.

At FIG. 9N, electronic device 950 displays, on display 951, home interface 952, which is, optionally, a desktop interface. In some examples, home interface 952 includes a menu bar 952, which in turn includes various affordances for operating one or more aspects of electronic device 950. In some examples, affordances of menu bar 952 includes an activation affordance 954, which when selected, activates the digital assistant of electronic device 900. In some examples, selection of activation affordance 954 using a particular type of input (e.g., a mouse click of at least a threshold amount of time) activates the digital assistant in a voice mode. In some examples, the digital assistant of electronic device 950 may also be activated in the voice mode in response to other input types, such as voice inputs and/or one or more keyboard shortcuts.

For example, while displaying home interface 952, electronic device 900 detects selection of activation affordance 954. The selection is an input 905n (e.g., mouse click of a threshold amount of time) on the activation affordance 954. As shown in FIG. 9O, in response to input 905n, electronic device 950 activates the digital assistant in the voice mode and displays digital assistant interface 960. In some examples, displaying digital assistant interface 960 includes highlighting one or more elements of digital assistant interface 960, as described, indicating that the digital assistant of electronic device 950 has been activated.

In some examples, digital assistant interface 960 includes input field 962 which provides a textual representation of speech input provided by a user while the digital assistant is activated in the voice mode. Digital assistant interface 960 further includes suggestions 964 (e.g., suggestions 964a-c), each of which corresponds to a respective task that may be performed by the digital assistant and/or electronic device 900. In some examples, suggestions 964 are provided based on context of electronic device 950.

While description is made in FIGS. 9N-90 with respect to activating a digital assistant in the voice mode, it will be appreciated that the digital assistant of electronic device 950 can be activated in a text input mode. For example, the digital assistant of electronic device 950 may be activated in the text input mode in response to selection of activation affordance 954 using a particular input type (e.g., a double mouse click) and/or one or more keyboard shortcuts. In some examples, selection of speech field 962, for instance, using a mouse, causes electronic device 900 to transition the digital assistant from the voice mode to the text input mode.

FIG. 10 is a flowchart of an exemplary method 1000 for managing a digital assistant, according to various examples. Process 1000 is performed, for example, using one or more computer systems (e.g., electronic devices, such as electronic device 900) implementing a digital assistant. In some examples, process 1000 is performed using a client-server system (e.g., system 100), and the blocks of process 1000 are divided up in any manner between the server (e.g., DA server 106) and a client device. In other examples, the blocks of process 1000 are divided up between the server and multiple client devices (e.g., a mobile phone and a smart watch). Thus, while portions of process 1000 are described herein as being performed by particular devices of a client-server system, it will be appreciated that process 1000 is not so limited. In other examples, process 1000 is performed using only a client device (e.g., user device 104) or only multiple client devices. In process 1000, some blocks are, optionally, combined, the order of some blocks is, optionally, changed, and some blocks are, optionally, omitted. In some examples, additional steps may be performed in combination with the process 1000.

In some embodiments, the electronic device (e.g., 900) is a computer system (e.g., a personal electronic device (e.g., a mobile device (e.g., iPhone), a headset (e.g., Vision Pro), a tablet computer (e.g., iPad), a smart watch (e.g., Apple Watch), a desktop (e.g., iMac), or a laptop (e.g., MacBook)) or a communal electronic device (e.g., a smart TV (e.g., AppleTV) or a smart speaker (e.g., HomePod))). The computer system is optionally in communication (e.g., wired communication, wireless communication) with a display generation component (e.g., an integrated display and/or a display controller) and with one or more input devices (e.g., a touch-sensitive surface (e.g., a touchscreen), a mouse, and/or a keyboard). The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, via a wired or wireless connection, input from the one or more input devices.

The computer system receives (1005) an input (e.g., touch input, natural-language input, speech input) including a request to activate a digital assistant of the computer system. In some examples, the computer system receives an input (e.g., 905a, 906a, 905f) from a user. In some examples, the input is a touch input, such as a single tap, a double tap, or a long press (e.g., a press exceeding a threshold amount of time). In some examples, the input is a natural-language input, such as a speech input. In some examples, the input includes a request to activate a digital assistant of the computer system.

The computer system, in response to the request to activate the digital assistant, initiates (1010) a process to activate the digital assistant.

In some examples, the digital assistant is activated in one of any number of predefined modes. In some examples, a first mode is a voice mode and/or a second mode is a text input mode, each of which is invoked according to respective types of inputs. In some examples, the digital assistant is activated in the first mode in response to a trigger word provided by way of a voice input, a touch input of a particular type (e.g., long press) (e.g., 905a), and/or selection (e.g., 906a) of a button (e.g., 902) of the computer system. In some examples, the digital assistant is activated in the second mode in response to a touch input of a particular type (e.g., a double tap) (e.g., 905f), for instance, at a particular location on a user interface provided by the computer system.

In some examples, the process to activate the digital assistant includes, in accordance with a determination that a location of the input (e.g., 905a, 906a, 905f) relative to the computer system corresponds to a first location (e.g., a location on a display of the computer system, a location of a button of the computer system, the source of a voice input relative to the computer system), displaying (1015), via the display generation component, an input indicator (e.g., an animation, such as a ripple animation) (e.g., 916) with a first directionality (e.g., in a direction away from the first location).

In some examples, activating the digital assistant includes displaying an input indicator (e.g., 916) indicating that an input for activating the digital assistant has been received (e.g., detected) by the computer system. In some examples, the computer system displays the input indicator in a manner based on a type and/or location of an input for activating the digital assistant. In some examples, the input for activating the digital assistant (e.g., 905a, 906a, 905f) is detected at a location corresponding to a display of the computer system, and the input indicator is displayed based on the detected location. In some examples, the input for activating the digital assistant is a press (e.g., 906a) of a button (e.g., 902) of the computer system, and the input indicator is displayed based on the detected press of the button. In some examples, the input for activating the digital assistant is a voice input, and the input indicator is displayed based on the voice input (e.g., auditory characteristics of the voice input).

In some examples, the input indicator (e.g., 916) has a directionality; by way of example, display of the input indicator may include displaying, via the display generation component, a ripple animation that is translated across a display of (or a display in communication with) the computer system. In some examples, the ripple moves away from an input (and, optionally radially expands by virtue of being a ripple). For example, if the input is a touch input (e.g., 905a, 905f), the ripple moves in a direction away from a location of the touch input (e.g., if a touch input is detected near a bottom of a display, the ripple animation moves toward a top of the display). As another example, if the input is a press (e.g., 906a) of a button (e.g., 902), the ripple moves in a direction away from a location of the button. As yet another example, if the input is a voice input, the ripple moves away from a particular edge of the computer system (e.g., an edge at which a microphone is located) and/or moves away from a perceived direction from which the voice input was received.

In some examples, the process to activate the digital assistant includes, in accordance with a determination that the location of the input (e.g., 905a, 906a, 905f) relative to the computer system does not correspond to the first location, displaying (1020), via the display generation component, the input indicator (e.g., 916) with a second directionality different than the first directionality.

In some examples, the process to activate the digital assistant includes, after displaying the input indicator, displaying (1025), via the display generation component, an activation indicator (e.g., 918) indicating that the digital assistant is active. In some examples, the activation indicator is displayed adjacent to at least a portion of an edge of a user interface (e.g., 910).

In some examples, upon activation of the digital assistant of the computer system, the computer system displays an activation indicator (e.g., 918) indicating that the digital assistant has been activated (i.e., is active). In some examples, displaying the activation indicator includes visually highlighting one or more aspects of a user interface (e.g., 910). In some examples, displaying the activation indicator includes displaying the activation indicator at one or more edges of a display (e.g., 901) of (or a display in communication with) the computer system. In some examples, the activation indicator is displayed at each edge of the display, for instance, when the digital assistant is invoked in a first mode. In some examples, the activation indicator is displayed at a subset of the edges of the display, for instance, when the digital assistant is invoked in a second mode. In some examples, the activation indicator is used to highlight a perimeter of a user interface object (e.g., performance indicator, digital assistant keyboard (e.g., 931)). In some examples, the activation indicator is used to highlight the entirety of a UI object (e.g., performance indicator, digital assistant keyboard). In some examples, the activation indicator is an animation that provides, for instance, a shimmer effect (e.g., a multi-colored shimmer effect). In some examples, one or more characteristics of the activation indicator is based on an environment of the computing device. By way of example, a brightness of the activation indicator can be based on an intensity of ambient light detected by the computing device.

In some examples, once the digital assistant has been activated, the digital assistant remains active for the entirety of a digital assistant session with a user; the session may span, for instance, any number of conjunctive and/or successive interactions (e.g., requests, responses) between a user of the computer system and the digital assistant. In some examples, the activation indicator is displayed for the entirety of the session.

In some examples, a user can request that a mode of the digital assistant change during operation; a user can request that the digital assistant transition from a first mode (e.g., voice) to a second mode (e.g., text input) and vice versa. In some examples, display of the activation indicator is maintained across any changes in modes of the digital assistant. In some examples, maintaining display of the activation indicator includes modifying display of the activation indicator according to the respective modes of the digital assistant.

Displaying an activation indicator having a directionality corresponding to a location of an input provides improved user feedback as to whether a computing device is activating a digital assistant in response to the input. For example, displaying an activation indicator in this manner indicates not only that the computing device is activating the digital assistant, but also the manner in which a request to activate the digital assistant was provided. This enhances operability of the computer system, in turn making usage of the computer system more efficient, which, additionally, reduces power usage and improves battery life of the device by enabling the user to use the device more quickly and efficiently.

In some examples, receiving an input includes detecting a touch input (e.g., 905a, 905f) at the first location. In some examples, displaying the input indicator with the first directionality includes displaying the input indicator with a directionality opposite (e.g., moving away from) the first location.

In some examples, the input (e.g., 905a, 905f) is a touch input and detected by the computer system when lasting at least a threshold duration, detected at a particular location on a display (e.g., 901) of the computer system, detected as including multiple touches (e.g., a double tap, a triple tap), or any combination thereof.

In some examples, the computer system detects the touch input at a location and displays an input indicator indicating that the computer system has detected an input including a request to activate a digital assistant. In some examples, the computer system displays the input indicator (e.g., 916) based on a location of the input, and optionally with a directionality. In some examples, the directionality is one or more directions that are directed away from a location of the input. In some examples, displaying the input indicator includes displaying an animation in which the input indicator is translated across a display (e.g., 901) of (or in communication with) the computer system such that the input indicator moves away from the location of the input in one or more directions. In some examples, the animation is a ripple effect that ripples outward from the location of the input.

In some examples, receiving an input includes detecting a press (e.g., 906a) of a button (e.g., 902) at the first location. In some examples, displaying, the input indicator with the first directionality includes displaying the input indicator with a directionality opposite (e.g., moving away from) the first location.

In some examples, the input is a press of a button of the computer system. In some examples, the button press is detected when lasting at least a threshold duration and/or including multiple touches (e.g., a double press, a triple press). In some examples, the computer system detects the button press at a location and displays an input indicator indicating that the computer system has detected an input including a request to activate a digital assistant. In some examples, the computer system displays the input indicator based on a location of the button press, and optionally with a directionality. In some examples, the directionality is one or more directions that are directed away from a location of the input. In some examples, displaying the input indicator includes displaying an animation in which the input indicator is translated across a display of (or in communication with) the computer system such that the input indicator moves away from the location of the button press in one or more directions. In some examples, the animation is a ripple effect that ripples outward from the location of the button press.

In some examples, in response to detecting the button press, the computer system displays a contact indicator adjacent to the button (e.g., at an edge of the display closest to the button). In some examples, the contact indicator is displayed as a cut-out from a user interface displayed by the computer system while the button press is detected. In some examples, the contact indicator is shaped according to Gaussian function. In some examples, the magnitude of the contact indicator is proportional to the amount of force applied to the button of the computer system by the button press.

In some examples, receiving an input includes receiving a voice input (e.g., a natural-language speech input) spoken by a user and determining a location of the user (e.g., relative to the computer system) based on the voice input. In some examples, displaying, the input indicator with the first directionality includes displaying the input indicator with a directionality opposite (e.g., moving away from) the location of the user.

In some examples, the input is a voice input, such as a natural-language speech input provided by a user of the computer system. In some examples, when receiving the voice input, the computer system determines a location of the user. In some examples, the location is a location of the user relative to the computer system (e.g., distance and/or direction of the user relative to the computer system). In some examples, the voice input includes a trigger word or trigger phrase that constitutes a request to activate the digital assistant such that, when detected by the comping system, causes the computer system to activate the digital assistant of the computer system.

In some examples, the computer system detects the voice input and displays an input indicator indicating that the computer system has detected an input including a request to activate a digital assistant. In some examples, the computer system displays the input indicator based on a location (or direction) of the user and/or voice input, and optionally with a directionality. In some examples, the directionality is one or more directions that are directed away from a location (or direction) of the input. In some examples, displaying the input indicator includes displaying an animation in which the input indicator is translated across a display of (or in communication with) the computer system such that the input indicator moves away from the location of the button press in one or more directions. In some examples, the animation is a ripple effect that ripples outward from the location of the button press. In some examples, input indicators displayed in response to voice inputs are displayed at a same location regardless of input locations.

Displaying an input indicator having a directionality corresponding to (e.g., opposite) a location of a user provides improved visual feedback as to the location of the user as determined by the computer system while the digital assistant is activated.

In some examples, in accordance with a determination that the input (e.g., 905a, 905f) is an input of a first type (e.g., a touch input, such as a double tap at a particular location or a swipe input (e.g., a swipe input detected at a first edge of the display (e.g., a right edge) and translated across the display toward a second edge opposite the first edge)), the computer system displays (e.g., initially displays or maintaining display of) a digital assistant keyboard (e.g., 931). In some examples, displaying the activation indicator includes overlaying at least a portion of the activation indicator (e.g., 918) on the digital assistant keyboard. In some examples, if the input is an input of a particular type, the computer system activates the digital assistant in a particular mode. In some examples, if the input (e.g., 905f) is a touch input, such as a double tap on a home affordance, the computer system activates the digital assistant in a text input mode and displays a keyboard which a can use to communicate with a digital assistant using text inputs. In some examples, when activating the digital assistant in the text mode, the computer system blurs a currently displayed interface and overlays the keyboard and/or activation indicator on the blurred interface. In some examples, when activating the digital assistant in the text mode, the computer system displays a digital assistant interface including the keyboard and/or activation indicator. In some examples, the digital assistant interface includes one or more elements of an interface displayed by the computing device when the input was received. In some examples, the one or more elements are blurred. In some examples, when activating the digital assistant in the text input mode, the computer system displays the activation indicator at a location coinciding with the keyboard indicating that text inputs using the displayed keyboard will be communicated to the digital assistant (and not a currently displayed application, for instance). In some examples, displaying the activation indicator in this manner includes overlaying the activation indicator on the keyboard. In some examples, the activation indicator is at least partially transparent such that the keyboard and activation indicator are simultaneously viewable.

Overlaying an activation indicator on a digital assistant keyboard provides improved visual feedback as to the activation state of a digital assistant (e.g., activated in a text input mode). Additionally, modifying a visual characteristic in this manner signals to a user that text inputs provided via the digital assistant keyboard are available as a modality for communicating with the digital assistant.

In some examples, the digital assistant keyboard includes a voice affordance. In some examples, the computer system detects selection of the voice affordance (e.g., affordance located in the bottom right of digital assistant keyboard 931). In some examples, in response to selection of the voice affordance, the computer system transitions the digital assistant from a first (e.g., text input) mode to a second (e.g., voice) mode and ceases display of the digital assistant keyboard. In some examples, when operating in the text input mode, the computer system displays a digital assistant keyboard that can be used to communicate with a digital assistant using text inputs. In some examples, the keyboard includes a plurality of affordances including a voice affordance, which when activated, causes the digital assistant to switch from the text input mode to the voice mode. In some examples, switching modes in this manner includes ceasing display of the keyboard and modifying display of the activation indicator. In some examples, modifying display of the activation indicator in this manner (e.g., updating display of the indicator to reflect the voice mode) includes displaying the activation indicator along a perimeter of the display of the computing device.

Transitioning a digital assistant from a first mode to a second mode in response to selection of an affordance (e.g., voice affordance) provides an intuitive and efficient mechanism by which a user can select between operating modes of the digital assistant thereby improving the speed and reliability of usage of the computer system.

In some examples, displaying the digital assistant keyboard includes, in accordance with a determination that an application keyboard is displayed, replacing display of the application keyboard with the digital assistant keyboard (e.g., 931) and, in accordance with a determination that an application keyboard is not displayed, displaying the application keyboard.

In some examples, the digital assistant of the computing device is activated in a text input mode. In some examples, when the digital assistant is activated in the text input mode, the computer system displays a digital assistant keyboard by which a user can communicate with the digital assistant using the digital assistant keyboard. In some examples, the digital assistant keyboard includes a text field (e.g., 932) for entering text, a voice affordance for transitioning a mode of the digital assistant, and a glyph (e.g., 936) by which the display of task suggestions can be toggled. In some examples, the digital assistant is activated in the second mode when no keyboard is displayed, and the computer system displays a digital assistant keyboard. In some examples, displaying a digital assistant keyboard in this manner includes translating the digital assistant keyboard from the bottom of the display in an upward direction until the entire digital assistant keyboard is displayed. In some examples, the digital assistant is activated in the second mode when an application keyboard (e.g., of a first- or third-party application) is already displayed, and the computer system updates (e.g., replaces) display of the application keyboard with display of the digital assistant keyboard. In some examples, updating display of the application keyboard in this manner includes displaying an animation indicating that display of the application keyboard is updating. In some examples, the animation is a “bounce” effect after which the digital assistant keyboard is displayed.

Replacing display of an application keyboard with a digital assistant keyboard or displaying a digital assistant keyboard if no application keyboard is displayed allows the computing device to display a digital assistant keyboard without cluttering a user interface with additional controls that might otherwise be confused as modality for communicating with the digital assistant.

In some examples, replacing display of the application keyboard with the digital assistant keyboard includes displaying a text input field (e.g., 932) for communication with the digital assistant, the text input field including an affordance (e.g., 936), which when selected, selectively enables (e.g., toggles) display of a set of candidate tasks, and replacing display of a microphone affordance of the application keyboard with the voice affordance.

In some examples, the application keyboard includes a text input field that can be used for communication with the digital assistant. In some examples, the text input field includes an affordance, which when selected, toggles display of candidate tasks. In some examples, the candidate tasks are provided based on context of the computing device, such as an active application of the computing device (e.g., the currently displayed application).

In some examples, while the activation indicator is displayed, the computer system receives a request identifying a task and initiates performance of the task. In some examples, once a digital assistant is activated (and an activation indicator is displayed indicating the same), the digital assistant remains active after a user has requested that the digital assistant perform a task. In some examples, the digital assistant identifies an endpoint of a user request (e.g., the point at which the user has completed an input) and modifies the activation indicator to signal to the user that the endpoint has been detected. In some examples, signaling the endpoint includes modifying a color (e.g., to white) and/or adjusting (e.g., increasing) a brightness of the activation indicator. In some examples, after signaling the endpoint, the computing device initiates performance of the task requested by the user. In some examples, while when initiating the task, the computing device modifies the activation indicator an additional time. In some examples, modifying the activation indicator in this manner include reversing the first modification (e.g., the modification made in response to the endpoint) for at least a portion of the activation indicator (e.g., one or more portions of the activation indicator remain white while one or more other portions are returned to their original state). In some examples, the digital assistant further remains active during and/or after performance of the task. In some examples, a user can provide additional requests to the digital assistant at any point the digital assistant is active such that the digital assistant may receive, initiate and/or perform additional tasks when already performing one or more other tasks. In some examples, the digital assistant is deactivated when the digital assistant of the computer system (or another process of the computer system) determines that the user no longer intends to interact with the digital assistant.

In some examples, while the activation indicator (e.g., 918) is displayed, in accordance with a determination that the computer system has been moved (e.g., rotated, repositioned) in a first direction, the computer system visually emphasizes (e.g., brightening, enlarging) a first portion of the activation indicator (e.g., a portion proximate end 964). In some examples, while the activation indicator is displayed, in accordance with a determination that the computer system has been moved (e.g., rotated, repositioned) in a first direction, the computer system visually deemphasizes (e.g., dims, shrinks) a second portion of the activation indicator different than the first portion (e.g., a portion proximate end 962). In some examples, while the activation indicator is displayed, in accordance with a determination that the computer system has been moved in a second direction opposite the first direction, the computer system visually emphasizes the second portion of the activation indicator. In some examples, while the activation indicator is displayed, in accordance with a determination that the computer system has been moved in a second direction opposite the first direction, the computer system visually deemphasizes the first portion of the activation indicator. In some examples, the computer system modifies display of the activation indicator based on one or more changes in orientation of the computer system. In some examples, changes in orientation are rotations of the computer system (along any number of axes), changes in location of the computer system, or a combination thereof. As an example, if a first end of the computer system is tilted toward a user, the computer system can visually emphasize one or more portions of the activation indicator proximate the first end and, optionally, visually deemphasize one or more portions of the activation indicator proximate a second end opposite the first end. In some examples, visually emphasizing the activation indicator includes increasing brightness, saturation, an HDR value, and/or size (e.g., thickness) of the activation indicator, and visually deemphasizing the activation indicator includes decreasing brightness, saturation, an HDR value, and/or size of the activation indicator. In this manner, the computer system “weights” the activation indicator toward the user to indicate that the digital assistant is activated and ready to receive user inputs. In some examples, the greater the change in orientation of the computer system, the greater the degree to which respective portions of the activation indicator are visually emphasized and deemphasized. In some examples, if the orientation of the computing device does not change for a threshold amount of time, the computer system can cease visually emphasizing and/or deemphasizing respective portions of the activation indicator.

In some examples, in accordance with a determination that the computer system has a first position relative to a user, the computer system visually emphasizes (e.g., brightening, enlarging) a third portion of the activation indicator (e.g., a portion proximate end 964). In some examples, in accordance with a determination that the computer system has a first position relative to a user, the computer system visually deemphasizes (e.g., dims, shrinks) a fourth portion of the activation indicator different than the third portion (e.g., a portion proximate end 962). In some examples, in accordance with a determination that the computer system has a second position relative to the user different than the first position, the computer system visually emphasizes the fourth portion of the activation indicator. In some examples, in accordance with a determination that the computer system has a second position relative to the user different than the first position, the computer system visually deemphasizes the third portion of the activation indicator. In some examples, the computer system modifies display of the activation indicator based on a position of a user relative to the computer system. In some examples, the position of the user is determined based on one or more voice inputs provided by the user. User inputs may, for instance, be used to estimate an angle of arrival. In some examples, computer system can visually emphasize one or more portions of the activation indicator determined to be relatively close to the user and, optionally, visually deemphasize one or more portions of the activation indicator determined to be relatively further from the user. In some examples, visually emphasizing the activation indicator includes increasing brightness, saturation, an HDR value, and/or size (e.g., thickness) of the activation indicator, and visually deemphasizing the activation indicator includes decreasing brightness, saturation, an HDR value, and/or size of the activation indicator. In visually emphasizing and/or deemphasizing the activation indicator, the computer system “weights” the activation indicator toward the user to indicate that the digital assistant is activated and ready to receive user inputs.

In some examples, the computer system additionally or alternatively modifies the activation indicator based on one or more characteristics of user speech. In some examples, the computer system modifies (e.g., brightens, thickens) at least a portion of the activation indicator (e.g., a portion nearest a user) while a user is speaking. In some examples, the degree to which the computer system modifies display of the activation indicator is based on a volume of the user's voice and/or a distance of the user relative to the computer system. In some examples, the distance of the user is determined using one or more microphones and/or cameras of the computer system. In some examples, the further the user is from the computing device, the greater the amount the computing device modifies display of the activation indicator. In some examples, the further the user is from the computing device, the lesser the amount the computing device modifies display of the activation indicator. In some examples, modifying the activation indicator includes modifying the activation indicator to include a sound wave (e.g., curve) corresponding to voice inputs received by the computing device.

In some examples, after displaying the input indicator: in accordance with a determination that a determination that a set of result display criteria is met, the computer system displays a result (e.g., 948) corresponding to a previous digital assistant task, and in accordance with a determination that a determination that a set of result display criteria is not met, the computer system forgoes display of the result corresponding to the previous digital assistant task. In some examples, when activating a digital assistant, the computing device determines if a set of result display criteria is met. In some examples, the set of result display criteria is met when the digital assistant previously provided a result (e.g., corresponding to a task performed by the digital assistant, for instance, during a previous digital assistant session) within a threshold amount of time; if so, the computing device can, optionally, display the result when activating the digital assistant; if not, the computing device forgoes display of the result. In some examples, the result can be “hidden” by the computing device such that the result is displayed only in response to a particular type of input (e.g., a swipe input “dragging” the result into the displayed content of the computing device).

Selectively displaying a result from a previous digital assistant session allows for a user to intuitively and efficiently view a result from the previous digital assistant session, in turn providing for faster and more reliable usage of the computing device.

The operations described above with reference to FIG. 10 are optionally implemented by components depicted in FIGS. 1-4A, 6A-6B, 7A-7C, and FIGS. 9A-90. For example, the operations of process 1000 may be implemented by electronic device 900 and, optionally, a digital assistant executing thereon. It would be clear to a person having ordinary skill in the art how other processes are implemented based on the components depicted in FIGS. 1-4A, 6A-6B, 7A-7C, and 9A-90.

FIG. 11 is a flowchart of an exemplary method 1100 for managing a digital assistant, according to various examples. Process 1100 is performed, for example, using one or more computer systems (e.g., electronic devices, such as electronic device 900) implementing a digital assistant. In some examples, process 1100 is performed using a client-server system (e.g., system 100), and the blocks of process 1100 are divided up in any manner between the server (e.g., DA server 106) and a client device. In other examples, the blocks of process 1100 are divided up between the server and multiple client devices (e.g., a mobile phone and a smart watch). Thus, while portions of process 1100 are described herein as being performed by particular devices of a client-server system, it will be appreciated that process 1100 is not so limited. In other examples, process 1100 is performed using only a client device (e.g., user device 104) or only multiple client devices. In process 1100, some blocks are, optionally, combined, the order of some blocks is, optionally, changed, and some blocks are, optionally, omitted. In some examples, additional steps may be performed in combination with the process 1100.

In some embodiments, the electronic device (e.g., 900) is a computer system (e.g., a personal electronic device (e.g., a mobile device (e.g., iPhone), a headset (e.g., Vision Pro), a tablet computer (e.g., iPad), a smart watch (e.g., Apple Watch), a desktop (e.g., iMac), or a laptop (e.g., MacBook)) or a communal electronic device (e.g., a smart TV (e.g., AppleTV) or a smart speaker (e.g., HomePod))). The computer system is optionally in communication (e.g., wired communication, wireless communication) with a display generation component (e.g., an integrated display and/or a display controller) and with one or more input devices (e.g., a touch-sensitive surface (e.g., a touchscreen), a mouse, and/or a keyboard). The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

While displaying a user interface (e.g., 910), via the display generation component, the computer system receives (1105), via the set of one or more input devices, a set of inputs (e.g., 905a, 906a, 905f) including a request to activate a digital assistant of the computer system.

In some examples, the computer system receives a set of inputs while displaying a user interface. In some examples, the set of inputs includes one or more voice inputs (e.g., natural-language inputs, speech inputs), one or more touch inputs (e.g., taps., swipes, double taps, long presses), one or more inputs based on user state (e.g., gaze direction, hand gestures, etc.), or any combination thereof.

In some examples, the set of inputs includes a request to activate a digital assistant of the computer system. In some examples, the request to activate a digital assistant of the computer system is a user utterance of a digital assistant trigger (e.g., “Hey Siri”). In some examples, the request to activate a digital assistant of the computer system is a touch input, for instance, of a particular type (e.g., long press, double tap) and/or at a particular location. In some examples, the request to activate a digital assistant of the computer system is a button press, for instance, of a particular duration (e.g., 1 second), or cadence (e.g., double press).

In some examples, the set of inputs includes a request for the digital assistant to perform a task (e.g., “Get directions to Starbucks”, “What's the weather this weekend?”, “Send Joe a message that I'll be late”). In some examples, an input of the set of inputs includes both a request to activate a digital assistant of the computer system and a request for the digital assistant to perform a task. In some examples, a first input of the set of inputs includes a request to activate a digital assistant of the computer system, and a second input of the set of inputs includes a request for the digital assistant to perform a task.

In some examples, in response (1110) to the set of inputs, the computer system activates (1115) the digital assistant. In some examples, in response to one or more inputs of the set of inputs, the computer system activates the digital assistant. In some examples, activating the digital assistant in this manner includes displaying an input indicator (e.g., 916). In some examples, the input indicator has a directionality based on a location of one or more inputs of the set of inputs. In some examples, the input indicator is an animation that includes a ripple effect that moves away from a location of one or more inputs of the set of inputs.

In some examples, in response (1110) to the set of inputs, the computer system modifies (1120), based on a type of an input of the set of inputs, a visual characteristic of a perimeter of at least a portion of the user interface (e.g., by displaying activation indicator 918) indicating that the digital assistant is activated. In some examples, the computer system modifies a visual characteristic of a portion (or the entirety) of a user interface in response to the set of inputs. In some examples, the visual characteristic is modified to indicate that the digital assistant of the computer system is active. In some examples, modification of the visual characteristic is maintained so long as the digital assistant of the computer system remains active.

In some examples, modifying the visual characteristic in this manner includes modifying a visual characteristic of a perimeter of the portion (or entirety) of the user interface. In some examples, modifying the visual characteristic in this manner includes modifying a visual characteristic of the entirety of the portion of the user interface (e.g., 910) (e.g., an entire object or entire user interface is modified). In some examples, modifying a visual characteristic of a portion of a user interface includes modifying a visual characteristic of a user interface object (e.g., 930, 931, 932) included in the user interface.

In some examples, modifying a visual characteristic of a user interface or user interface object includes visually highlighting the user interface or user interface object. In some examples, highlighting in this manner includes displaying an animation producing a “glow” or “light” effect. In some examples, the animation is a shimmer effect and/or is multi-colored such that colors of highlighted portions dynamically fluctuate.

In some examples, which portions and/or manner in which portions are modified is based on the set of inputs. In some examples, in response to the set of inputs, the computer system activates the digital assistant in a first mode and modifies a perimeter of the user interface and/or a perimeter (or entirety) of a user interface object (e.g., performance indicator). In some examples, in response to the set of inputs, the computer system activates the digital assistant in a second mode and modifies the entirety of a first user interface object (e.g., digital assistant keyboard (e.g., 931)) and/or a second user interface object (e.g., performance indicator). In some examples, one or more objects highlighted in response to the set of inputs are user interface objects displayed in response to activating the digital assistant.

Modifying a visual characteristic of a perimeter of at least a portion of a user interface provides improved visual feedback as to the activation state of a digital assistant (e.g., whether the digital assistant is activated). As a result, a user can readily observe the activation state of the digital assistant, allowing for more efficient and enhanced operation of the computing device. In this manner, operation is faster and more reliable, which additionally reduces power usage and improves battery life of the device by enabling the user to use the device more quickly and efficiently.

In some examples, modifying a visual characteristic of a perimeter of at least a portion of the user interface includes modifying a visual characteristic of an edge of the user interface (e.g., 910). In some examples, upon activation of the digital assistant of the computer system, the computer system displays an activation indicator indicating that the digital assistant has been activated (i.e., is active). In some examples, displaying the activation indicator includes modifying (e.g., visually highlighting) one or more aspects of a user interface. In some examples, modifying in this manner includes modifying a visual characteristic of a perimeter of a portion (or entirety) of a user interface.

Modifying a visual characteristic of an edge of the user interface provides improved visual feedback as to the activation state of a digital assistant (e.g., activated in a voice mode).

In some examples, activating the digital assistant includes displaying a digital assistant keyboard (e.g., 931). In some examples, modifying a visual characteristic of a perimeter of at least a portion of the user interface includes modifying a visual characteristic of the digital assistant keyboard. In some examples, upon activation of the digital assistant of the computer system, the computer system displays an activation indicator indicating that the digital assistant has been activated (i.e., is active). In some examples, displaying the activation indicator includes modifying (e.g., visually highlighting) one or more aspects of a user interface. In some examples, modifying in this manner includes modifying a visual characteristic of a perimeter of a portion (or entirety) of a user interface. In some examples, the user interface includes one or more user interface objects, and in response to the set of inputs, the computer system modifies one or more of the user interface objects. In some examples, a perimeter of a user interface object is modified. In some examples, the entirety of a user interface object (e.g., keyboard) is modified.

Modifying a visual characteristic of a digital assistant keyboard provides improved visual feedback as to the activation state of a digital assistant (e.g., activated in a text input mode).

In some examples, in response to the set of inputs, the computer system modifies a visual characteristic (e.g., highlights) of an interior portion (e.g., a portion other than the perimeter) of the digital assistant keyboard (e.g., 931). In some examples, the user interface includes one or more user interface objects, and in response to the set of inputs, the computer system modifies one or more of the user interface objects. In some examples, a perimeter of a user interface object is modified. In some examples, at least a portion of the user interface object is modified. In some examples, the entirety of a user interface object (e.g., keyboard) is modified.

Modifying a visual characteristic of an interior portion of a digital assistant keyboard provides improved visual feedback as to the activation state of a digital assistant (e.g., activated in a text input mode). Additionally, modifying a visual characteristic in this manner signals to a user that the current modality for communicating with the digital assistant is through the digital assistant keyboard.

In some examples, the set of inputs include a task request (e.g., a request for the digital assistant to perform a task specified in the request). In some examples, modifying a visual characteristic of a perimeter of at least a portion of the user interface includes modifying a perimeter of a performance indicator corresponding to the task request. In some examples, the computer system receives a request to perform a task, and in response, the digital assistant activates and thereafter initiates performance of the task. In some examples, initiating performance includes displaying a performance indicator indicating that the task has been initiated, and optionally, one or more aspects of the task, such as a task intent. In some examples, when while displaying the performance indicator, the computer system modifies display of a perimeter and/or entirety of the performance indicator. In some examples, the performance indicator is translated (e.g., vertically) across a display of the computing device for at least a portion of the time the performance indicator is displayed.

Modifying a visual characteristic of a perimeter of a performance indicator provides improved visual feedback as to the activation state of a digital assistant. Further, modifying a visual characteristic in this manner signals to a user that the digital assistant (and/or the computing device generally) is initiating performance of a task.

In some examples, modifying a perimeter of a performance indicator corresponding to the task request includes translating the performance indicator across a display (e.g., 901) of the computer system.

In some examples, activating the digital assistant includes displaying a text input field (e.g., 932). In some examples, modifying a visual characteristic of a perimeter of at least a portion of the user interface includes modifying a visual characteristic of a perimeter of the text input field. In some examples, when the digital assistant is activated in a particular mode (e.g., text input mode), the computing device displays a text input field that may be used for communication with the digital assistant. In some examples, at least a portion (e.g., a perimeter) of the text input field is visually modified upon activation of the digital assistant.

Modifying a visual characteristic of a perimeter of a text input field provides improved visual feedback as to the activation state of a digital assistant (e.g., activated in a text input mode). Modifying in this manner signals to a user that the text input field is an available modality for communicating with the digital assistant.

In some examples, the set of inputs includes a second task request. In some examples, while modifying a visual characteristic of a perimeter of at least a portion of the user interface, the computer system performs a task associated with second task request. In some examples, once the digital assistant has been activated, the digital assistant remains active for the entirety of a digital assistant session with a user; the session may span, for instance, any number of conjunctive and/or successive interactions (e.g., requests, responses) between a user of the computer system and the digital assistant. In some examples, a modification to a visual characteristic by the computing device is displayed for the entirety of the digital assistant session. In some examples, once the digital assistant concludes (e.g., ends, terminates), the computing device deactivates the digital assistant and/or ceases to modify the visual characteristic.

Performing a task while modifying a visual characteristic of a perimeter of at least a portion of a user interface provides improved visual feedback as to the activation state of a digital assistant while the digital assistant and/or computing device performs a task.

In some examples, activating the digital assistant includes initiating a digital assistant session. In some examples, in accordance with a determination that the digital assistant session has not ended, the computer system maintains modification of the visual characteristic of the perimeter of the at least a portion of the user interface. In some examples, in accordance with a determination that the digital assistant session has ended, the computer system deactivates the digital assistant and ceases to modify the visual characteristic of the perimeter of the at least a portion of the user interface.

Ceasing to modify the visual characteristic of a perimeter of a portion of a user interface after a digital assistant session has ended provides improved visual feedback as to the activation state of a digital assistant after a digital assistant session has concluded (e.g., the digital assistant is no longer activated).

In some examples, modifying a visual characteristic of a perimeter of at least a portion of the user interface includes displaying a shimmer animation at a location corresponding to the perimeter of the at least a portion of the user interface.

In some examples, modifying a visual characteristic of a perimeter of a UI object (e.g., performance indicator) includes displaying an animation that provides, for instance, one or more visual effects, such as a shimmer effect (e.g., a multi-colored shimmer effect). In some examples, modifying the visual characteristic of the perimeter includes, in accordance with a determination that the computer system has been moved (e.g., rotated, repositioned) in a first direction, visually emphasizing (e.g., brightening, enlarging) a first portion of the perimeter (e.g., a portion proximate end 964). In some examples, modifying the visual characteristic of the perimeter includes, in accordance with a determination that the computer system has been moved (e.g., rotated, repositioned) in a first direction, visually deemphasizing (e.g., dimming, shrinking) a second portion of the perimeter different than the first portion (e.g., a portion proximate end 962). In some examples, modifying the visual characteristic of the perimeter includes, in accordance with a determination that the computer system has been moved in a second direction opposite the first direction, visually emphasizing the second portion of the perimeter. In some examples, modifying the visual characteristic of the perimeter includes, in accordance with a determination that the computer system has been moved in a second direction opposite the first direction, visually deemphasizing the first portion of the perimeter.

In some examples, the computer system modifies display of at least a portion of the user interface perimeter based on one or more changes in orientation of the computer system. In some examples, changes in orientation are rotations of the computer system (along any number of axes), changes in location of the computer system, or a combination thereof. As an example, if a first end of the computer system is tilted toward a user, the computer system can visually emphasize one or more portions perimeter proximate the first end and, optionally, visually deemphasize one or more portions of the perimeter proximate a second end opposite the first end. In some examples, visually emphasizing the perimeter includes increasing brightness, saturation, an HDR value, and/or size (e.g., thickness) of the perimeter, and visually deemphasizing the perimeter includes decreasing brightness, saturation, an HDR value, and/or size of the perimeter. In this manner, the computer system “weights” the visual emphasis of the perimeter toward the user to indicate that the digital assistant is activated and ready to receive user inputs. In some examples, the greater the change in orientation of the computer system, the greater the degree to which respective portions of the perimeter are visually emphasized and deemphasized. In some examples, if the orientation of the computing device does not change for a threshold amount of time, the computer system can cease visually emphasizing and/or deemphasizing respective portions of the perimeter.

In some examples, modifying the visual characteristic of the perimeter includes, in accordance with a determination that the computer system has a first position relative to a user, visually emphasizing (e.g., brightening, enlarging) a third portion of the perimeter (e.g., a portion proximate end 964). In some examples, modifying the visual characteristic of the perimeter includes, in accordance with a determination that the computer system has a first position relative to a user, visually deemphasizing (e.g., dimming, shrinking) a fourth portion of the perimeter different than the third portion (e.g., a portion proximate end 962). In some examples, modifying the visual characteristic of the perimeter includes, in accordance with a determination that the computer system has a second position relative to the user different than the first position, visually emphasizing the fourth portion of the perimeter. In some examples, modifying the visual characteristic of the perimeter includes, in accordance with a determination that the computer system has a second position relative to the user different than the first position, visually deemphasizing the third portion of the perimeter. In some examples, the computer system modifies display of the activation indicator based on a position of a user relative to the computer system. In some examples, the position of the user is determined based on one or more voice inputs provided by the user. User inputs may, for instance, be used to estimate an angle of arrival. In some examples, computer system can visually emphasize one or more portions of the activation indicator determined to be relatively close to the user and, optionally, visually deemphasize one or more portions of the activation indicator determined to be relatively further from the user. In some examples, visually emphasizing the activation indicator includes increasing brightness, saturation, an HDR value, and/or size (e.g., thickness) of the activation indicator, and visually deemphasizing the activation indicator includes decreasing brightness, saturation, an HDR value, and/or size of the activation indicator. In visually emphasizing and/or deemphasizing the activation indicator, the computer system “weights” the activation indicator toward the user to indicate that the digital assistant is activated and ready to receive user inputs.

In some examples, the computer system additionally or alternatively modifies the activation indicator based on one or more characteristics of user speech. In some examples, the computer system modifies (e.g., brightens, thickens) at least a portion of the activation indicator (e.g., a portion nearest a user) while a user is speaking. In some examples, the degree to which the computer system modifies display of the activation indicator is based on a volume of the user's voice and/or a distance of the user relative to the computer system. In some examples, the distance of the user is determined using one or more microphones and/or cameras of the computer system. In some examples, the further the user is from the computing device, the greater the amount the computer system modifies display of the activation indicator. In some examples, the further the user is from the computing device, the lesser the amount the computing device modifies display of the activation indicator. In some examples, modifying the activation indicator includes modifying the activation indicator to include a sound wave (e.g., curve) corresponding to voice inputs received by the computing device.

In some examples, activating the digital assistant includes activating the digital assistant in a first mode. In some examples, while the digital assistant is activated in a first mode (e.g., voice mode), in accordance with a determination that an input of a predetermined type (e.g., voice input) has not been received for a threshold amount of time, the computer system provides (e.g., displays) a prompt to activate the digital assistant in a second mode (e.g., text input mode) different than the first mode.

In some examples, while activated, the digital assistant of the computing system determines whether an input has been provided within a threshold amount of time. In some examples, the threshold amount of time is measured from a time at which the digital assistant is activated. In some examples, the threshold amount of time is measured from a time at which the visual characteristic of the perimeter is modified.

In some examples, if the digital assistant determines whether an input was not provided within the threshold amount of time, and if not, the computing system provides (e.g., displays) a prompt for a user to activate the digital assistant (e.g., in a different mode than a current mode of the digital assistant). In some examples, the digital assistant is operating in a voice mode and prompts the user to activate the digital assistant in a text input mode. In some examples, the digital assistant is operating in a text input mode and prompts the user to activate the digital assistant in a voice mode. In some examples, the prompt is a natural-language output (e.g., “Double tap to type to Assistant”) and, optionally, is displayed proximate (e.g., above) a user interface object (e.g., a home bar) of a user interface. In some examples, the digital assistant determines whether the prompt has been previously displayed a threshold number of times, and if so, forgoes display of the prompt.

In some examples, while the digital assistant is activated, the computing system visually highlights a user interface object (e.g., a home bar, the prompt) of a user interface. In some examples, visually highlighting the user interface object includes providing a bounce effect on the user interface object (e.g., shrinking the user interface object and returning to the user interface object to its original size one or more times). In some examples, visually highlighting the user interface object includes providing a glow effect on the user interface object. In some examples, the computing system visually highlights the user interface object in response to determining that an input was not provided within the threshold amount of time. In some examples, the computing system visually highlights the user interface object in response to detecting an input of a type corresponding to the prompt (e.g., in response to detecting a tap (e.g., single tap, double tap), for instance, at the specified location (e.g., home bar)).

In some examples, the digital assistant determines whether an input of a particular type is provided within the threshold amount of time. In some examples, the digital assistant determines whether an input of a first type (e.g., voice input) was not provided within the threshold amount of time, and if not, and prompts the user to activate the digital assistant (e.g., in a different mode) using an input of a second type (e.g., type input) different than the first type.

The operations described above with reference to FIG. 11 are optionally implemented by components depicted in FIGS. 1-4A, 6A-6B, 7A-7C, and FIGS. 9A-90. For example, the operations of process 1100 may be implemented by electronic device 900 and, optionally, a digital assistant executing thereon. It would be clear to a person having ordinary skill in the art how other processes are implemented based on the components depicted in FIGS. 1-4A, 6A-6B, 7A-7C, and 9A-90.

FIG. 12 is a flowchart of an exemplary method 1200 for managing a digital assistant, according to various examples. Process 1200 is performed, for example, using one or more computer systems (e.g., electronic devices, such as electronic device 900) implementing a digital assistant. In some examples, process 1200 is performed using a client-server system (e.g., system 100), and the blocks of process 1200 are divided up in any manner between the server (e.g., DA server 106) and a client device. In other examples, the blocks of process 1200 are divided up between the server and multiple client devices (e.g., a mobile phone and a smart watch). Thus, while portions of process 1200 are described herein as being performed by particular devices of a client-server system, it will be appreciated that process 1200 is not so limited. In other examples, process 1200 is performed using only a client device (e.g., user device 104) or only multiple client devices. In process 1200, some blocks are, optionally, combined, the order of some blocks is, optionally, changed, and some blocks are, optionally, omitted. In some examples, additional steps may be performed in combination with the process 900.

In some embodiments, the electronic device (e.g., 900) is a computer system (e.g., a personal electronic device (e.g., a mobile device (e.g., iPhone), a headset (e.g., Vision Pro), a tablet computer (e.g., iPad), a smart watch (e.g., Apple Watch), a desktop (e.g., iMac), or a laptop (e.g., MacBook)) or a communal electronic device (e.g., a smart TV (e.g., AppleTV) or a smart speaker (e.g., HomePod))). The computer system is optionally in communication (e.g., wired communication, wireless communication) with a display generation component (e.g., an integrated display and/or a display controller) and with one or more input devices (e.g., a touch-sensitive surface (e.g., a touchscreen), a mouse, and/or a keyboard). The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

The computer system receives (1205), via the one or more input devices, a first input (e.g., 905a, 905f) including a request to activate a digital assistant. In some examples, the computer system receives an input from a user. In some examples, the input is a touch input, such as a single tap, a double tap, or a long press (e.g., a press exceeding a threshold amount of time). In some examples, the input is a natural-language input, such as a speech input. In some examples, the input includes a request to activate a digital assistant of the computer system.

In response to the request to activate the digital assistant, the computer system activates (1210) the digital assistant. In some examples, in response to one or more inputs of the set of inputs, the computer system activates the digital assistant. In some examples, activating the digital assistant in this manner includes displaying an input indicator (e.g., 916). In some examples, the input indicator has a directionality based on a location of one or more inputs of the set of inputs. In some examples, the input indicator is an animation that includes a ripple effect that moves away from a location of one or more inputs of the set of inputs.

While the digital assistant is activated (1215), the computer system provides (1220) a first set of candidate tasks (e.g., 934, 934a-c) based on a context of the computer system.

In some examples, while the digital assistant of the computer system is activated, the computer system provides a set of one or more candidate suggestions (e.g., tasks) to the user. In some examples, the set of candidate suggestions includes suggestions for tasks that may be performed by the digital assistant.

In some examples, one or more candidate suggestions (e.g., 934a-c) of the set of candidate suggestions are provided based on context of the computer system and/or a user of the computer system. By way of example, candidate suggestions can be provided based on applications currently active (e.g., displayed, executing) on the computer system. As another example, candidate suggestions can be displayed based on prior user behavior of the computer system and/or other devices, a location of the computer system, user-specific data (e.g., contacts, notes, emails), operating characteristics of the computer system (e.g., battery level, temperature of the computer system), or any combination thereof.

In some examples, one or more candidate suggestions (e.g., 934, 934a-c) are provided in response to activation of the digital assistant. In this manner, candidate suggestions are automatically provided such that, following activation of the digital assistant, user input is not required for the computer system to provide suggestions.

In some examples, one or more candidate suggestions corresponds to a currently active application of the computer system. In some examples, one or more candidate suggestions corresponds to one or more other applications of the computer system, respectively. In some examples, the candidate suggestions corresponding to one or more other applications of the computer system may leverage one or more aspects of the currently active application (e.g., a music application is currently active on the computer system and a task includes sending a current song using a messaging application).

While the digital assistant is activated (1215), the computer system receives (1225), via the one or more input devices, a natural-language input (e.g., 938). In some examples, after providing the set of candidate suggestions, (and, optionally, while the digital assistant remains active), the computer system receives an input, such as a natural-language input. In some examples, the natural-language input is a word or phrase. In some examples, the natural-language input is a portion of a word or phrase. In some examples, the natural-language input is a speech input, a text input, or a combination thereof (e.g., a first portion of the natural-language input is provided by voice and a second portion of the natural-language input is provided by typing)

While the digital assistant is activated (1215), the computer system provides (1230) a second set of candidate tasks based on the natural-language input and the context of the computer system. In some examples, the computer system provides a second set of candidate suggestions (e.g., 934a and 934c). In some examples, the second set of candidate suggestions is based on the natural-language input and/or the context of the computer system. In some examples, providing the second set of candidate suggestions includes updating the first set of candidate suggestions based on the natural-language input and/or context of the computer system. In some examples, the context of the computer system used to provide the first set of candidate suggestions is the same as the context used to provide the second set of candidate suggestions. In some examples, the context of the computer system used to provide the first set of candidate suggestions is different from the context used to provide the second set of candidate suggestions. In some examples, updating the first set of candidate suggestions includes filtering (e.g., reducing) the first set of candidate suggestions using the natural-language input such that the second set of candidate suggestions reflects a subset of the first set of candidate suggestions according to a filter defined by the natural-language input. In some examples, only a subset of the first set of candidate suggestions are displayed, and reducing the first set of candidate suggestions using the natural-language input allows for candidate suggestions that were previously not displayed to be displayed (e.g., some suggestions become “higher ranked”)

Providing candidate tasks in this manner allows the computing device to provide candidate tasks that are salient to a current operative state of the computer system (e.g., the tasks are relevant to an application currently in use on the computer system). In this manner, the selection and initiation of tasks is both faster and more reliable, which additionally reduces power usage and improves battery life of the device by enabling the user to use the device more quickly and efficiently.

In some examples, the first input is an input (e.g., 905a) of a first type (e.g., a voice input, a long press of a home affordance, a selection of a voice affordance). In some examples, activating the digital assistant includes activating the digital assistant in a voice mode. In some examples, in response to an input of a particular type, the digital assistant of the computer system is activated in a voice mode. In some examples, the digital assistant is activated in the voice mode in response to voice inputs, touch inputs (e.g., a long press of an affordance), and/or button presses. In some examples, when the digital assistant is activated in the voice mode, the computer system displays an activation indicator indicating that the digital assistant has been activated. In some examples, when the digital assistant is activated in the voice mode, displaying the activation indicator includes modifying a perimeter (e.g., edge) of the display of the computing device.

Activating the digital assistant in a voice mode in this manner allows a user to activate the digital assistant in the voice mode with a single input, thereby reducing the number of inputs required to operate the computer system.

In some examples, the first input is an input (e.g., 905f) of a second type different than the first type (e.g., swipe gesture, a double press of a home affordance). In some examples, activating the digital assistant includes activating the digital assistant in a text input mode. In some examples, in response to an input (e.g., 905f) of a particular type, the digital assistant of the computer system is activated in a text input mode. In some examples, the digital assistant is activated in the text input mode in response to voice inputs, touch inputs (e.g., a long press of an affordance), and/or button presses. In some examples, when the digital assistant is activated in the text input mode, the computer system displays an activation indicator (e.g., 930) indicating that the digital assistant has been activated. In some examples, when the digital assistant is activated in the text input mode, the computer system displays a text communication interface (e.g., 930) which, optionally, includes a digital assistant keyboard (e.g., 931). In some examples, when the digital assistant is activated in the text input mode, displaying the activation indicator includes modifying a perimeter the digital assistant keyboard and/or one or more other portions of the text communication interface. In some examples, when the digital assistant is activated in the text input mode, displaying the activation indicator includes modifying the entirety of the digital assistant keyboard and/or one or more other portions of the text communication interface.

Activating the digital assistant in a text input mode in this manner allows a user to activate the digital assistant in the text input mode with a single input, thereby reducing the number of inputs required to operate the computer system.

In some examples, activating the digital assistant in the second mode includes displaying a text communication user interface (e.g., 930). In some examples, displaying the text communication user interface includes translating the text communication user interface from an edge (e.g., bottom) of a display of the computer system until the text communication user interface is fully displayed.

Displaying a text communication user interface when activating the digital assistant provides improved visual feedback as to the activation state of a digital assistant (e.g., activated in a text input mode).

In some examples, the text communication user interface includes a text input field (e.g., 932) for communicating with the digital assistant.

In some examples, the text input field is configured to display multiple lines of text simultaneously.

In some examples, displaying a text communication user interface includes visually highlighting at least a portion of the text communication user interface.

Visually highlighting at least a portion of the text communication user interface provides improved visual feedback as to the activation state of a digital assistant (e.g., activated in a text input mode). Additionally, modifying a visual characteristic in this manner signals to a user that text inputs provided via the digital assistant keyboard are available as a modality for communicating with the digital assistant.

In some examples, activating the digital assistant includes displaying the first set of candidate tasks (e.g., 934, 934a-c). In some examples, one or more candidate suggestions of the set of candidate suggestions are provided based on context of the computer system and/or a user of the computer system; by way of example, candidate suggestions can be provided based on applications currently active (e.g., displayed, executing) on the computer system; as another example, candidate suggestions can be displayed based on prior user behavior of the computer system and/or other devices, a location of the computer system, user-specific data (e.g., contacts, notes, emails), operating characteristics of the computer system (e.g., battery level, temperature of the computer system), or any combination thereof.

In some examples, one or more candidate suggestions are provided in response to activation of the digital assistant; in this manner, candidate suggestions are automatically provided such that, following activation of the digital assistant, user input is not required for the computer system to provide suggestions. In some examples, one or more candidate suggestions are provided in response to a user input (e.g., a swipe gesture). In some examples, one or more candidate suggestions are not provided on activation of the digital assistant and instead are provided after the digital assistant of the computing device has performed a task (e.g., when operating in the voice mode).

In some examples, one or more candidate suggestions corresponds to a currently active application (e.g., an application corresponding to application interface 910) of the computer system. In some examples, one or more candidate suggestions corresponds to one or more other applications of the computer system, respectively. In some examples, the candidate suggestions corresponding to one or more other applications of the computer system may leverage one or more aspects of the currently active application (e.g., a music application is currently active on the computer system and a task includes sending a current song using a messaging application).

Displaying a set of candidate tasks allows for a user to quickly and efficiently initiate performance of one or more contextually salient tasks, thereby improving the speed and reliability of usage of the computer system.

In some examples, the context of the computer system indicates a set of predefined intents associated with an application executing (e.g., currently displayed) on the computer system. In some examples, context of the computer system is based on an application (e.g., first-party application, third-party application) currently executing on and/or displayed by the computer system. In some examples, one or more applications of the computing device “donates” (e.g., provides, transmits, stores) one or more intents to the computing device, each of which corresponds to one or more tasks that may be performed within the application; in this manner, the computer system is made aware of the task capabilities of applications, and in turn, can provide salient task suggestions in response to activation of the digital assistant (e.g., the computer system displays relevant intents corresponding to a currently active application).

In some examples, a first candidate task (e.g., 934a, 934b) of the first set of candidate tasks corresponds to a first application and a second candidate task (e.g., 934c) of the first set of candidate tasks corresponds to a second application different than the first application. In some examples, the computer system provides task suggestions corresponding to multiple applications. In some examples, a first subset of the set of suggestions corresponds to a currently active (e.g., displayed) application, and a second subset of the set of suggestions corresponds to a second application of the computing device. In some examples, the second subset of suggestions is selected based on a nexus between the applications—that is, the computer system provides suggestions tasks supported by the second application that are determined to be relevant to the first application; as an example, a user may be listening to a song and a suggestion may be to send the song to a contact using a messaging application; as another example, a user may be looking at a website for a restaurant and a suggestion may be to generate driving directions to the restaurant using a map application.

Providing candidate tasks corresponding to multiple applications allows for the computing device to provide candidate tasks that correspond to an application currently in use may be provided in combination with candidate tasks that correspond to applications not currently in use. As a result, a broader array of candidate tasks identified as salient may be provided.

In some examples, the computer system receives a selection of a candidate task of the second set of candidate tasks and initiates performance of the selected candidate task.

In some examples, initiating performance of the selected candidate task includes initiating a process to disambiguate a parameter associated with the selected candidate task. In some examples, when initiating performance of a task (e.g., in response to selection of a task suggestion), the computing device may determine that a value for one or more parameters of the task cannot be resolved, for instance, with a predetermined level of confidence. In some examples, when a parameter value cannot be resolved in this manner, the computer system disambiguates values for the parameter by providing a query to a user for selection of a parameter value and/or information which would allow the computing device to select a parameter value.

In some examples, providing a second set of candidate tasks (e.g., 934a and 934c) includes modifying (e.g., filtering, reducing) the first set of candidate tasks (e.g., 934a-c) based on the natural-language input. In some examples, the set of candidate suggestions is dynamic such that the set of candidate suggestions can be modified (e.g., adapted) in real time by the computing device; by way of example, while displaying the set of candidate suggestions, the computing device can receive an input (e.g., 938), such as a natural-language input, which may be used to eliminate one or more suggestions of the set of suggestions and/or select one or more new suggestions to be added to the set of suggestions. In some examples, the input is provided in a text input field of a text communication user interface (recall that the text communication interface is, optionally, displayed when the digital assistant is activated in a text input mode). In some examples, the modified set of suggestions is displayed in lieu of the previous set of suggestions.

Modifying a set of candidate tasks based on a natural-language input in this manner provides a mechanism by which the computing device can provide an adjusted (e.g., filtered) set of candidates corresponding to a user's input. As such, a user can intuitively and efficiently filter through candidate tasks as desired.

In some examples, while receiving the natural-language input, the computer system provides a set of candidate input predictions based on the natural-language input. In some examples, the computing device provides a set of candidate input predictions based on the natural-language input. In some examples, the candidate input predictions are autocompletion predictions for various intents of applications of the computing device; that is, the set of candidate input predictions allow for autocompletion of not just known words, but rather a subset of words which correspond to actionable intents. In some examples, selection of a candidate input prediction autocompletes a term displayed in a text entry field of a text communication user interface.

In some examples, the natural-language input includes a speech portion and a text portion. In some examples, providing a second set of candidate tasks includes providing the second set of candidates based on the speech portion and the text portion. In some examples, the digital assistant receives a natural-language input that includes both a text portion and a speech portion. In some examples, the speech portion is received prior to the text portion. In some examples, the ty text ped portion is received prior to the speech portion: In some examples, the speech portion and text portion are interleaved.

Providing a set of candidate tasks based on a speech portion of an input and a text portion of an input allows for the computing device to provide a set of tasks across multiple modalities, thereby providing greater flexibility in the manner by which a user can provide inputs pertaining to the set of candidate tasks.

The operations described above with reference to FIG. 11 are optionally implemented by components depicted in FIGS. 1-4A, 6A-6B, 7A-7C, and FIGS. 9A-90. For example, the operations of process 1100 may be implemented by electronic device 900 and, optionally, a digital assistant executing thereon. It would be clear to a person having ordinary skill in the art how other processes are implemented based on the components depicted in FIGS. 1-4A, 6A-6B, 7A-7C, and 9A-90.

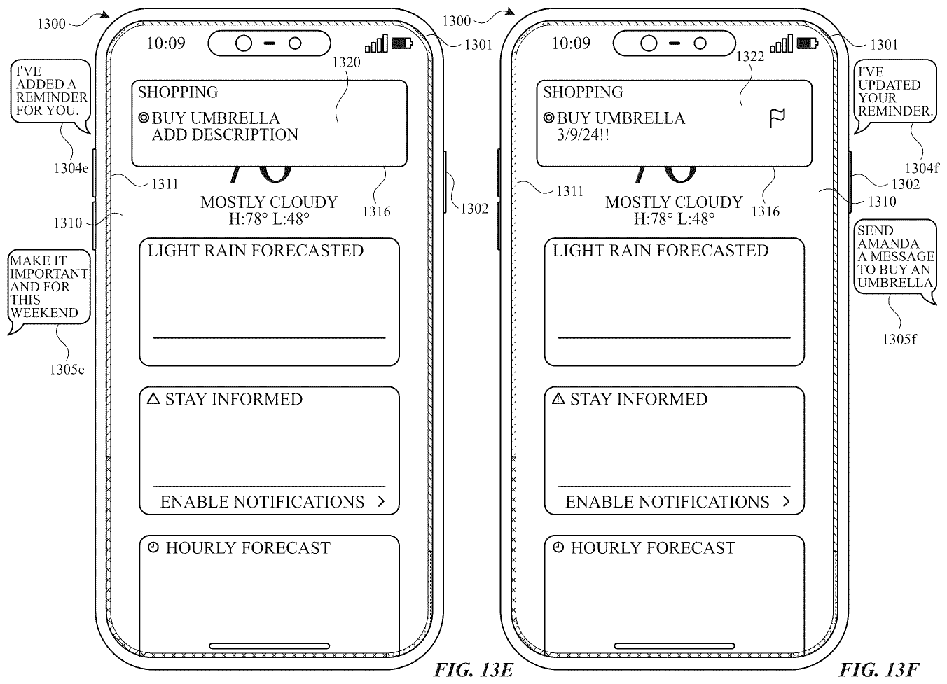

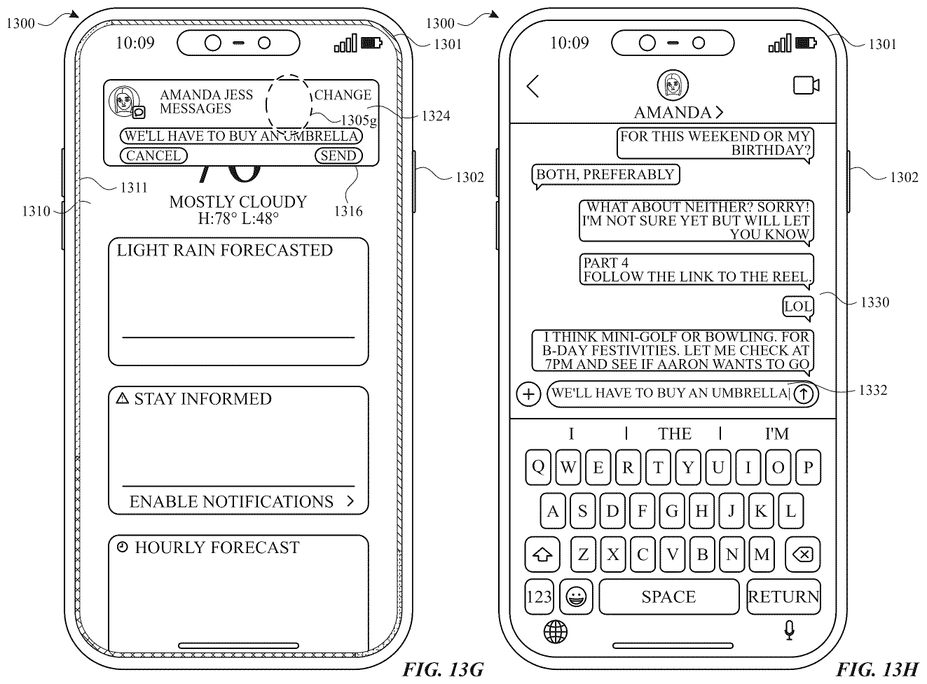

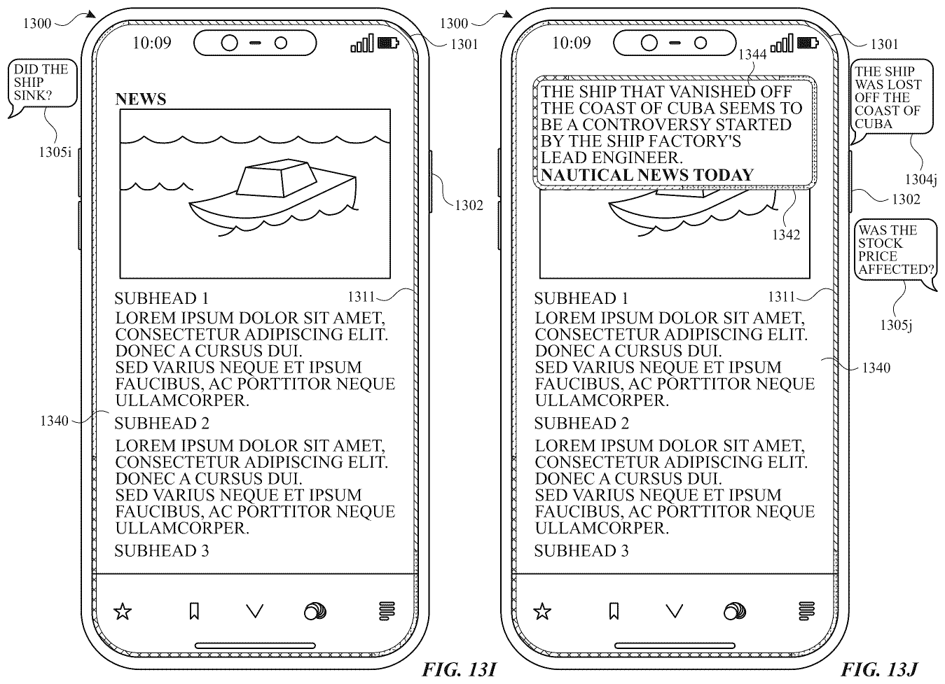

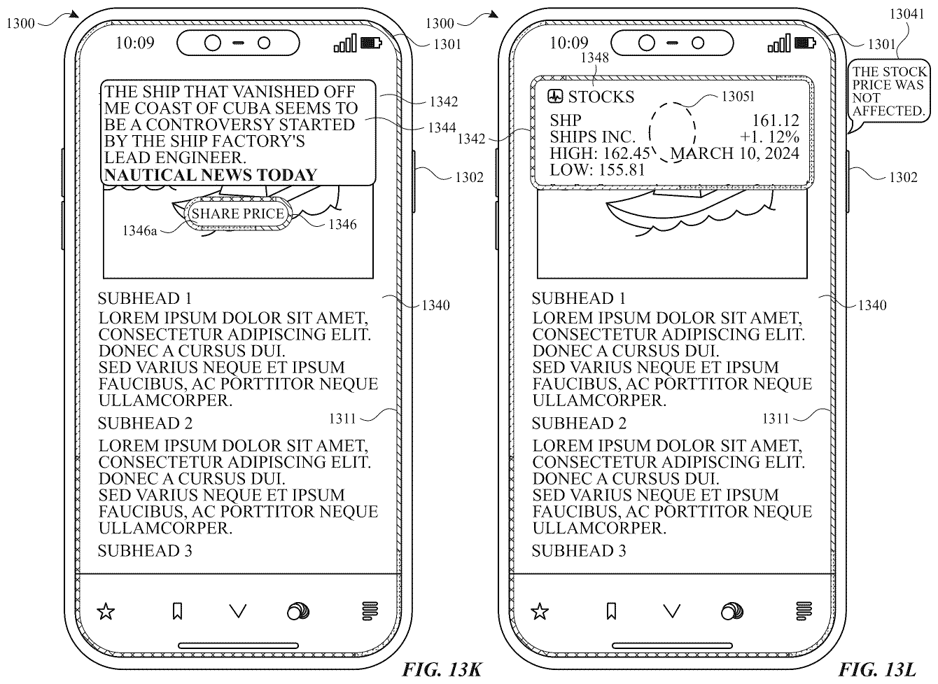

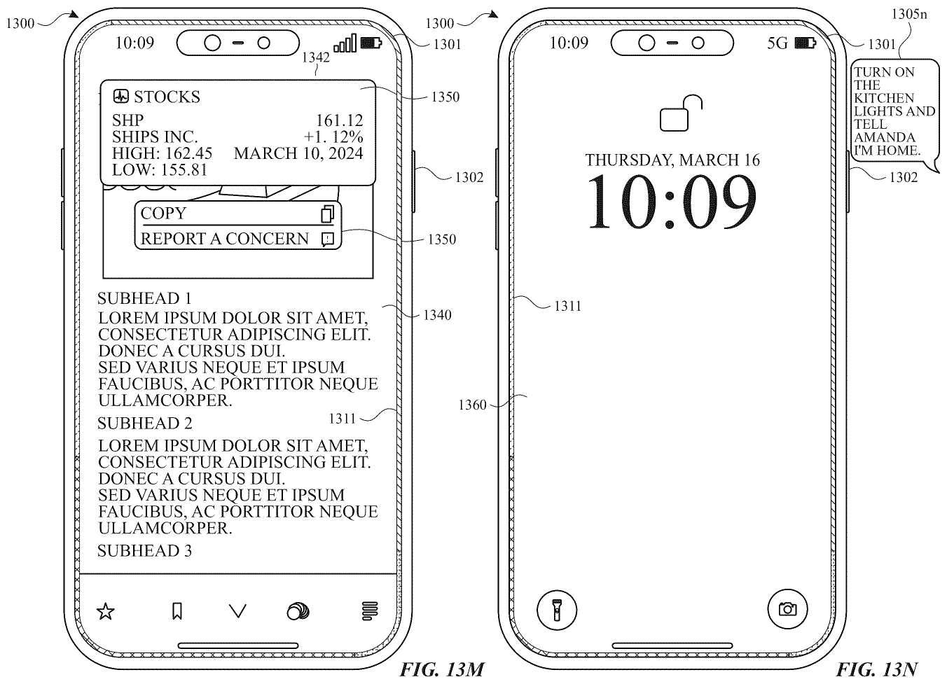

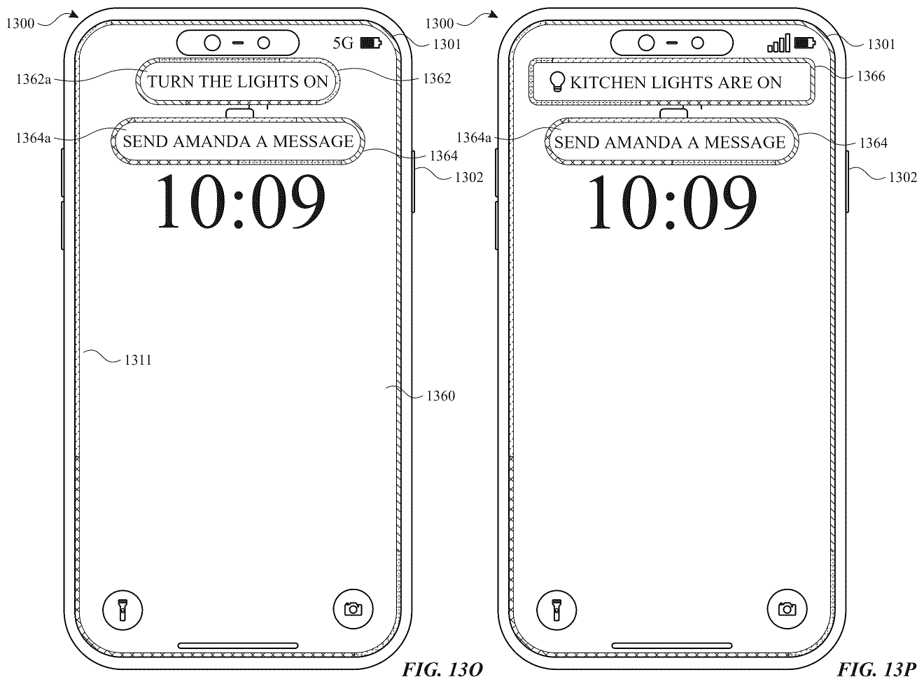

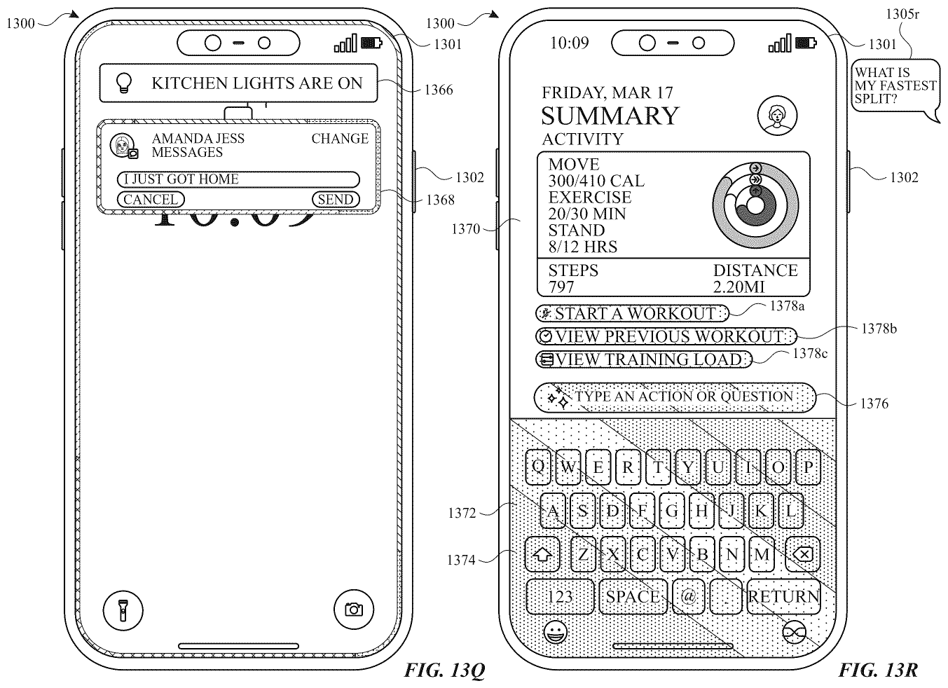

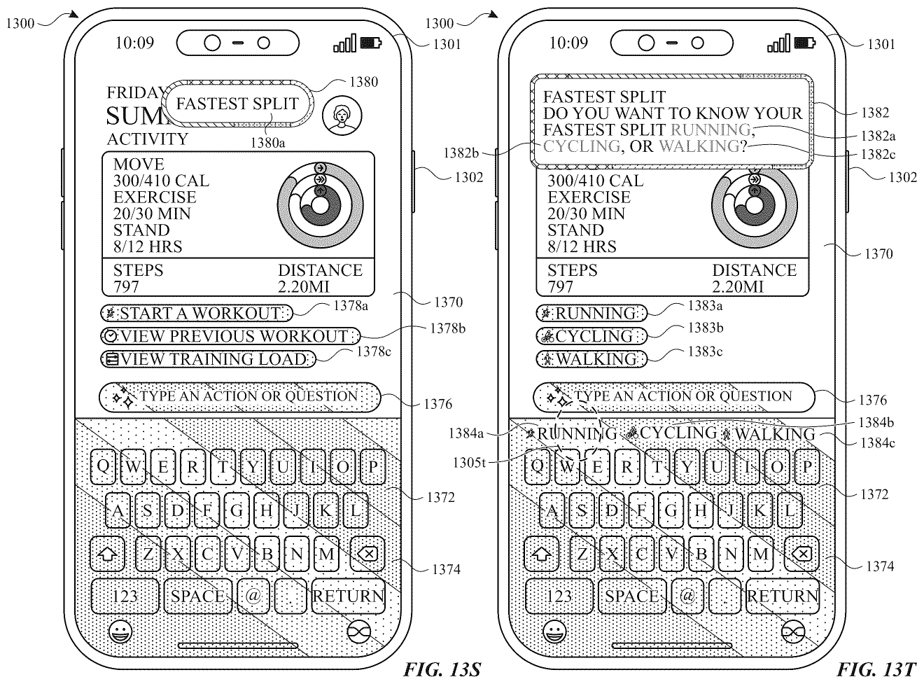

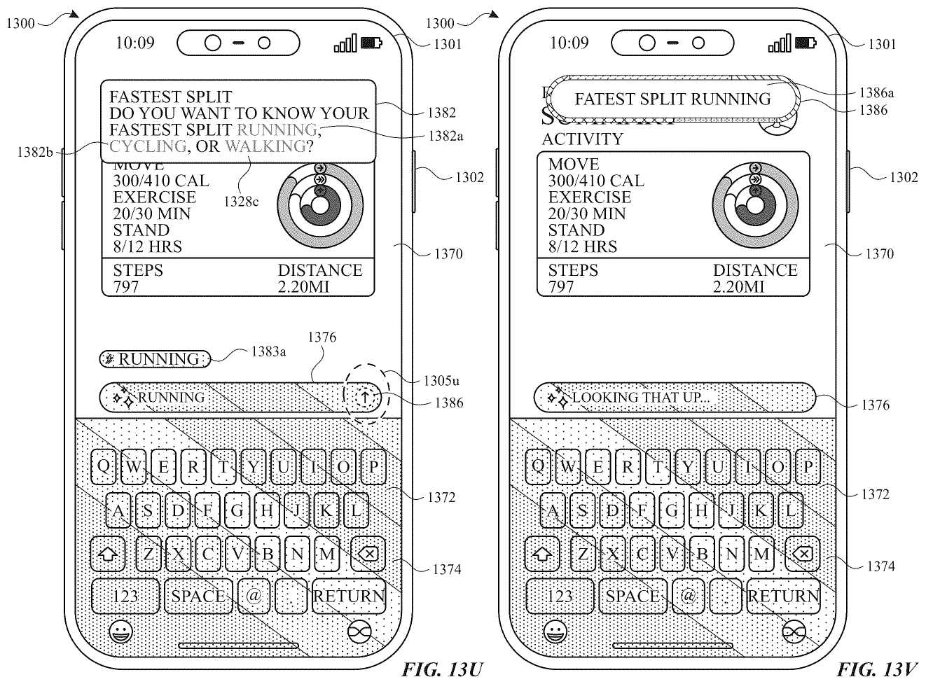

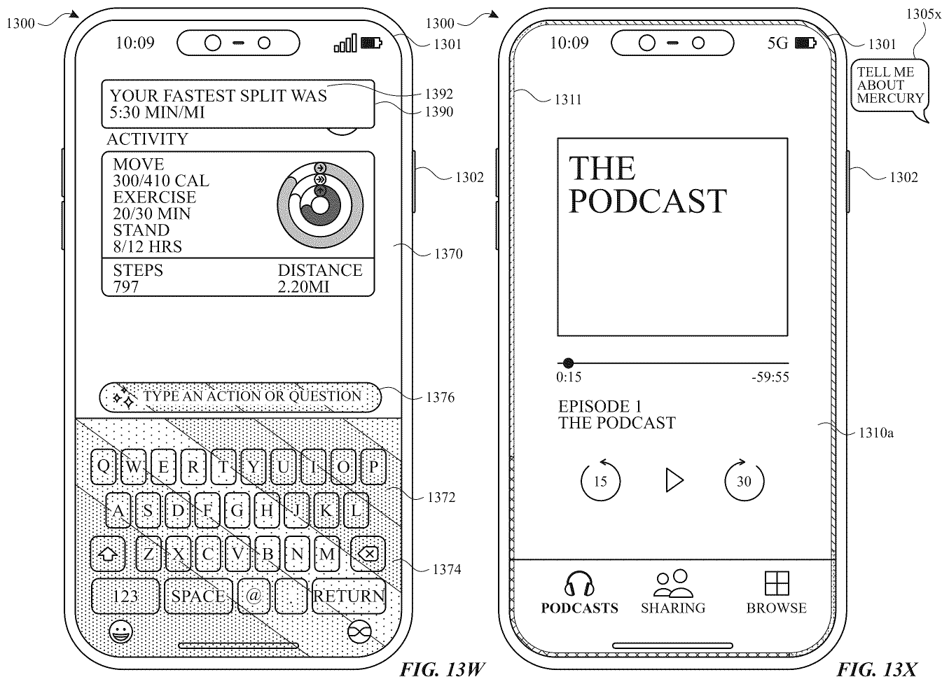

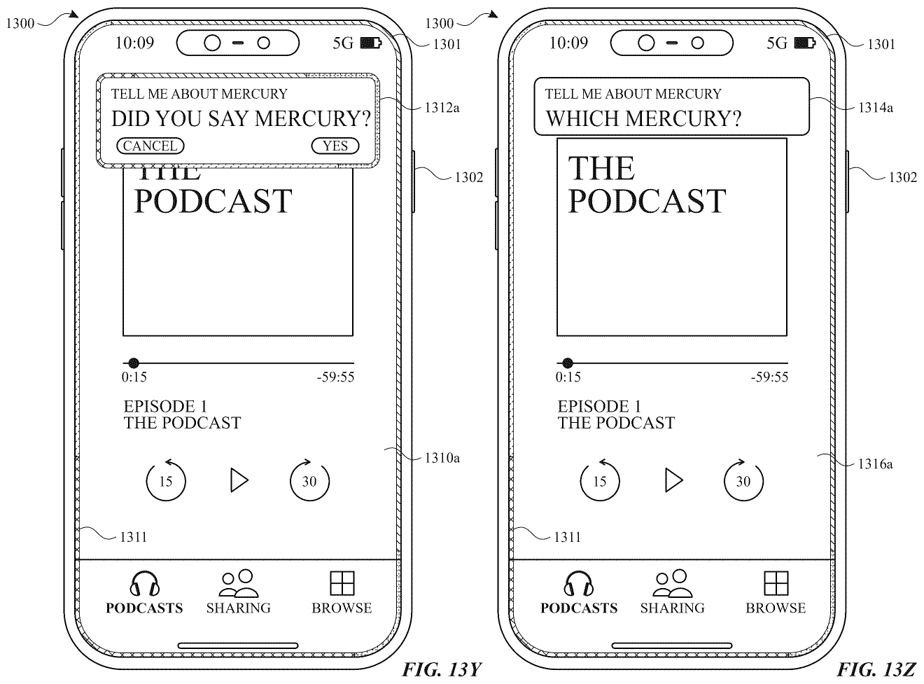

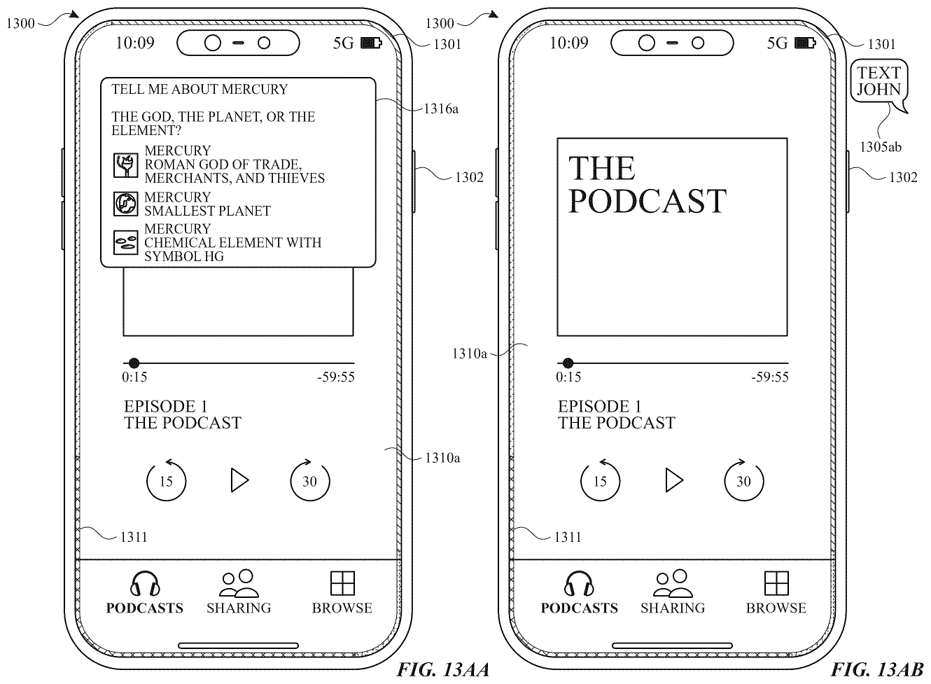

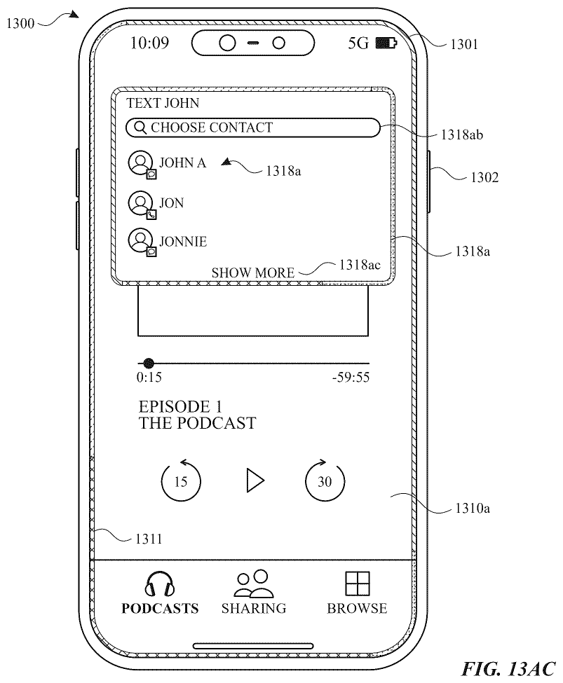

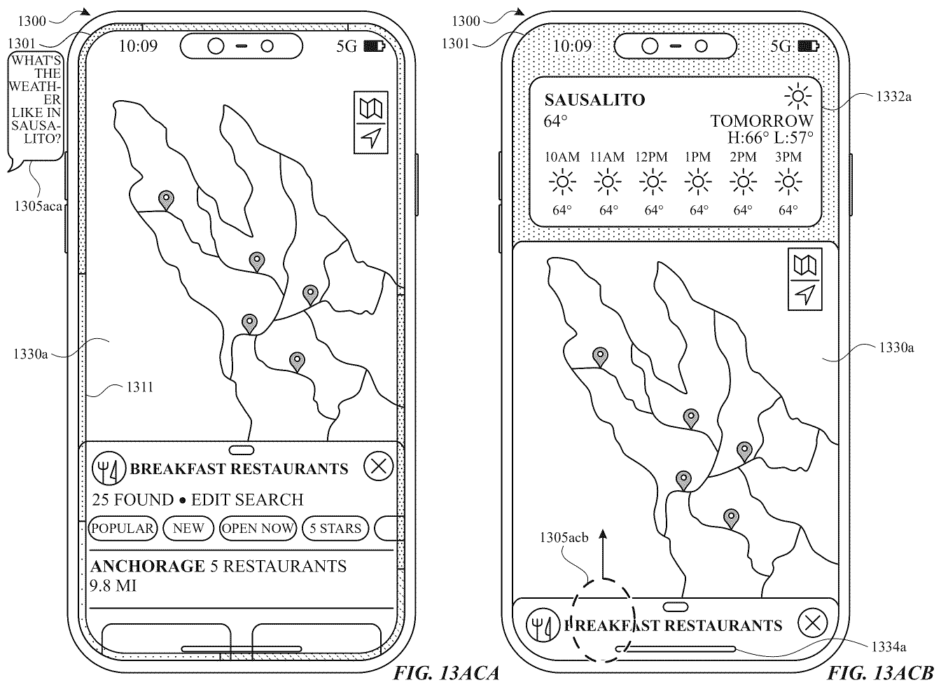

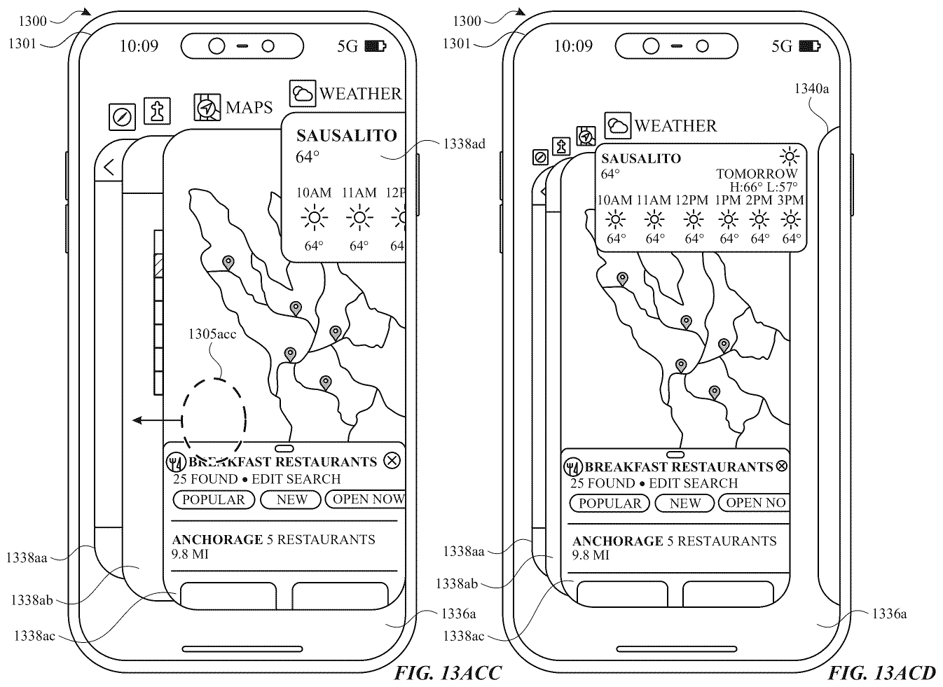

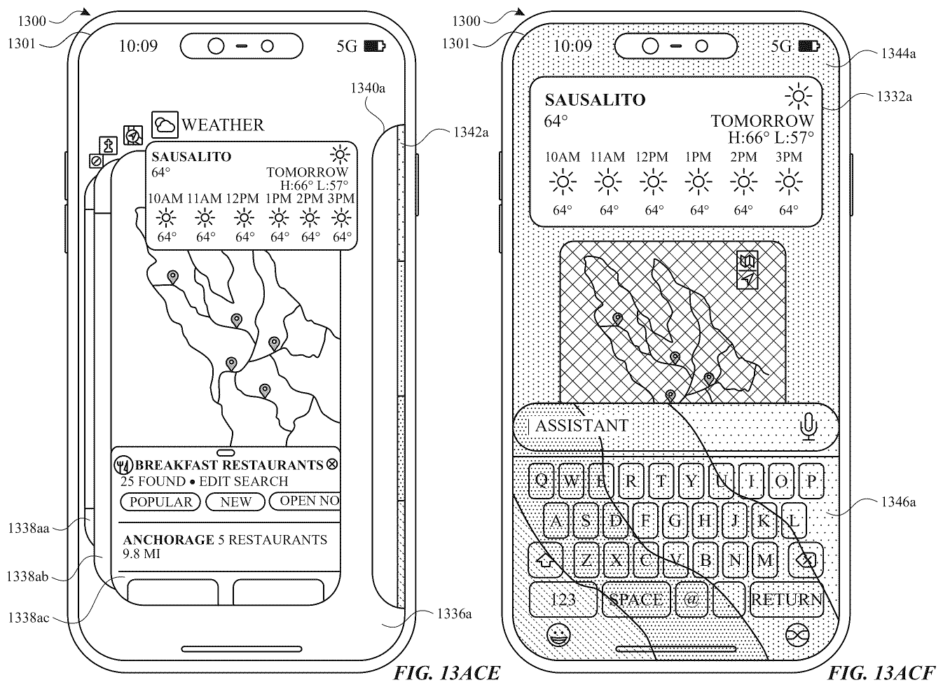

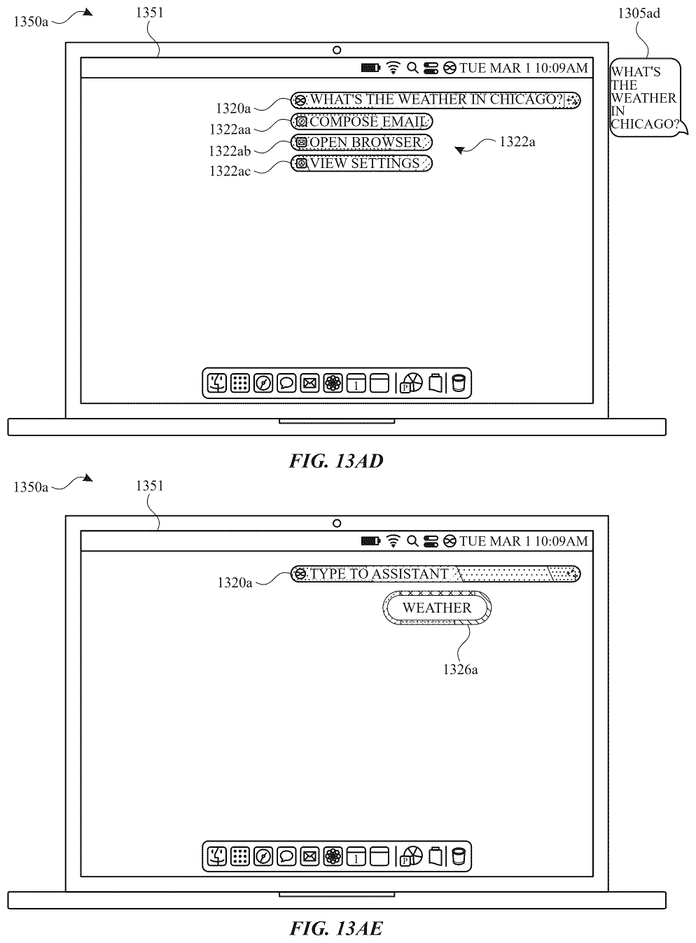

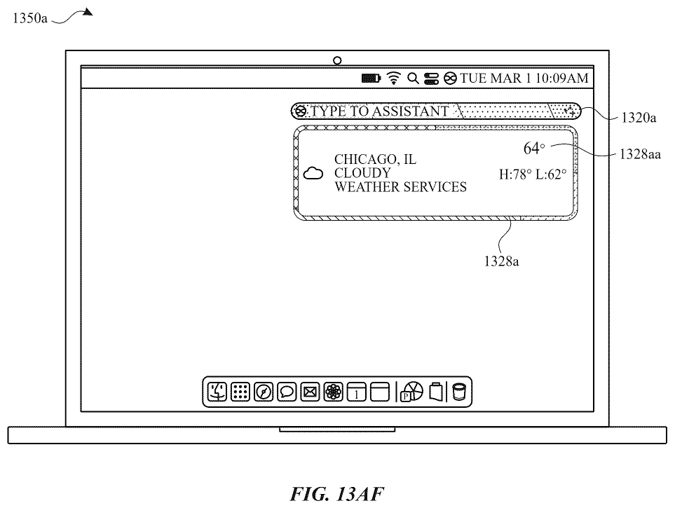

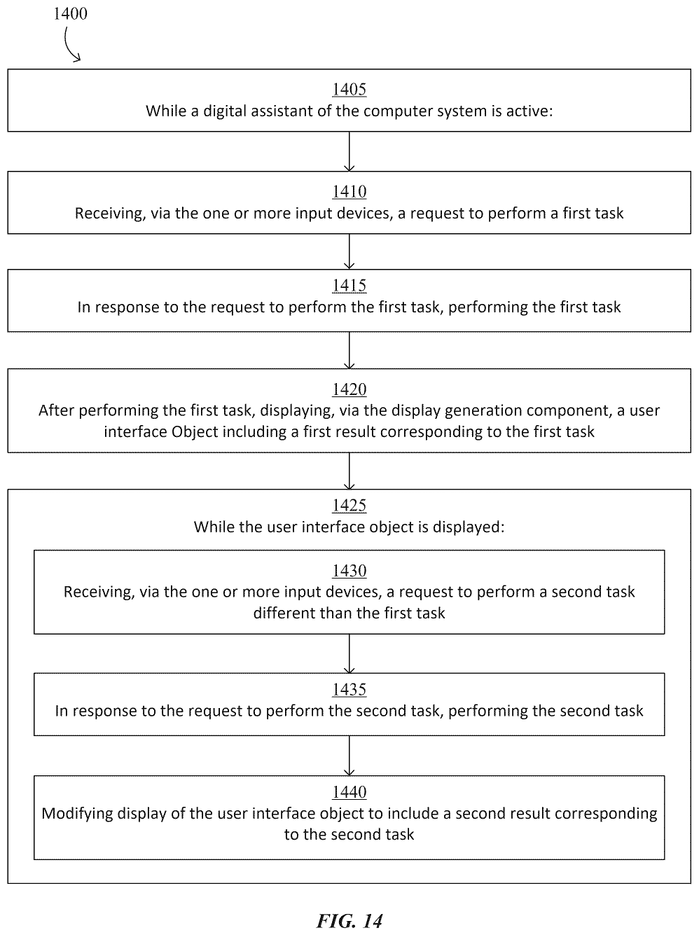

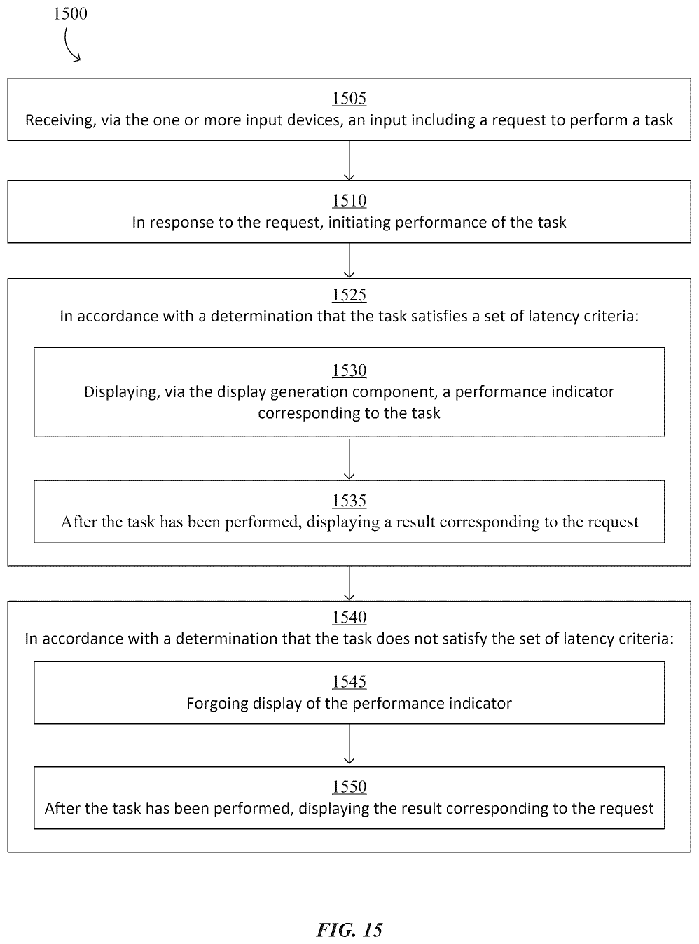

FIGS. 13A-13AF illustrate exemplary user interfaces for managing a digital assistant, according to various examples. These figures are also used to illustrate processes described below, including process 1400 of FIG. 14 and process 1500 of FIG. 15.

FIG. 13A illustrates an electronic device 1300 (e.g., device 104, device 122, device 200, device 600, or device 700). In the non-limiting exemplary embodiment illustrated in FIGS. 13A-13AF, electronic device 1300 is a smartphone. In other embodiments, electronic device 1300 can be a different type of electronic device, such as a wearable device (e.g., a smartwatch, headset), a laptop or desktop computer, a tablet, a smart speaker, and/or a set-top box. In some examples, electronic device 1300 has a display 1301, one or more input devices (e.g., a touchscreen of display 1301, a button, a microphone), and a wireless communication radio. In some examples, electronic device 1300 includes one or more forward facing and/or back facing cameras. In some examples, the electronic device includes one or more biometric sensors which, optionally, include a camera, such as an infrared camera, a thermographic camera, or a combination thereof.

In FIG. 13A, electronic device 1300 displays, on display 1301, application interface 1310 on display 1301 while a digital assistant of electronic device 1300 is activated (e.g., in a voice mode). In some examples, application interface 1310 corresponds to a weather application (e.g., for viewing weather forecasts) of electronic device 1300. Electronic device 1300 further displays an activation indicator 1311 indicating that the digital assistant is activated in the voice mode.

While displaying application interface 1310, electronic device 1300 receives input 1305a. In some examples, input 1305a is a natural-language speech input indicative of a request directed to the digital assistant of electronic device 1300 (e.g., “What's Saturday look like?”). In some examples, while receiving input 1305a, electronic device 1300 modifies activation indicator 1311, thereby signaling to a user that input 1305a is being received by electronic device 1300. In some examples, modifying activation indicator 1311 in this manner includes modifying (e.g., increasing, fluctuating) a brightness and/or size of activation indicator 1311, changing one or more colors of activation indicator 1311, modifying an animation of activation indicator 1311, or a combination thereof.

In response to input 1305a, electronic device 1300 identifies a task corresponding to input 1305a. In some examples, electronic device identifies the task based on context of electronic device 1300. In the illustrated example of FIG. 13A, for instance, input 1305a asks “What Saturday looks like?” but may not otherwise indicate what information the user is requesting. Because a weather application is currently active (e.g., displayed), electronic device 1300 can determine that the request is directed to information corresponding to the weather application, and in view of input 1305a, that the user is requesting a weather forecast for the forthcoming Saturday. It will be appreciated that currently active applications are one of several types of context that may be considered by a digital assistant in identifying a task and that, in some examples, electronic device 1300 can determine that a request is directed to information that does not correspond (or solely correspond) to information corresponding to a currently active application.

After identifying the task (e.g., providing a weather forecast for Saturday), electronic device 1300 initiates performance of the task. In some examples, initiating performance of the task includes determining a latency of the task. Generally, a latency is the amount of time expected to perform a task and/or a measured amount of time a task is taking to perform. In some examples, latency may be determined based on any number of performance considerations, such as a type of the identified task, parameters corresponding to the identified task, performance of a network hosting electronic device 1300, computing performance of electronic device 1300 and/or a device in communication with electronic device 1300, responsiveness of a remote device, or any combination thereof.

Once electronic device 1300 determines a latency of the task, electronic device 1300 determines whether the latency of the task satisfies a set of latency criteria. In some examples, the set of latency criteria includes a criterion that is satisfied when the latency exceeds a threshold latency (e.g., 1s). If electronic device 1300 determines that the latency of the task does not satisfy the latency criteria, electronic device 1300 displays a result corresponding to the task (e.g., result 1318 of FIG. 13D) without displaying a performance indicator.

As shown in FIG. 13B, if electronic device 1300 determines that the latency of the task satisfies the set of latency criteria, electronic device 1300 displays a performance indicator 1312 indicating that electronic device 1300 (or the digital assistant) is performing the requested task. In some examples, while displaying performance indicator 1312, electronic device translates performance indicator 1312 across display 1301 from location 1313 to location 1314, as shown in FIG. 13C. While location 1313 is shown as being located at or near the center of display 901, it will be appreciated that in other examples, location 1313 may be located at any other location on display 901. As an example, location 1313 may be located at or near an edge (e.g., bottom edge proximate the home bar of application interface 1310), and performance indicator 1312 may be translated from an edge of display 901 to location 1314. As another example, in instances in which the electronic device 1300 is operating in a text mode, location 1313 may be located on or near a digital assistant keyboard displayed by the electronic device 1300, and performance indicator 1312 may be translated from a location at or near the digital assistant keyboard to location 1314.

In some examples, electronic device 1300 highlights at least a portion (e.g., perimeter) of performance indicator 1312. In some examples, performance indicator 1312 includes an intent indicator 1312a. In some examples, intent indicator 1312a indicates (e.g., identifies) a task currently being performed by electronic device 1300 (or the digital assistant). In this manner, electronic device 1300 can signal a status of a current task to a user while the task is performed. In some examples, performance indicator 1312 is displayed without an intent indicator.

Once electronic device 1300 (or the digital assistant) completes the task, electronic device 1300 displays results interface 1316 including result 1318 corresponding to the requested task of input 1305a (e.g., a weather forecast for the upcoming Saturday), as shown in FIG. 13D. In some examples displaying results interface 1316 includes transitioning performance indicator 1312 into results interface 1316, for instance, using an animation. In some examples, further in response to completing the task, electronic device 1300 provides output (e.g., auditory output) 1304d (e.g., “Looks like it will rain this weekend”) indicating that the task has been completed and/or summarizing one or more aspects of result 1318.

In some examples, electronic device 1300 highlights results interface 1316. In some examples, results interface is highlighted for a threshold amount of time and thereafter is not highlighted.

In some examples, a digital assistant remains in an activated state after performing a task, and as a result, the digital assistant can continue to receive requests and/or perform tasks in response to inputs provided by a user. For example, with reference to FIG. 13D, after performing the task corresponding to input 1305a (FIG. 13A) and displaying result 1318 in results interface 1316, the digital assistant of electronic device 1300 remains in an activated state (e.g., as indicated by display of activation indicator 1311). While the digital assistant remains in the activated state, electronic device 1300 receives input 1305d. In some examples, input 1305d is a natural-language speech input indicative of a request directed to the digital assistant of electronic device 1300 (e.g., “Add a reminder to buy an umbrella”).

In response to input 1305d, electronic device 1300 identifies a task corresponding to input 1305d (e.g., creating a reminder), and initiates performance of the task. As described, initiating performance of the task may include determining whether a latency of the identified task satisfies a set of latency criteria. In the illustrated example of FIG. 13D, electronic device 1300 determines that the requested task does not satisfy the set of latency criteria, and, optionally, forgoes displaying a performance indicator.

As shown in FIG. 13E, after completing the task corresponding to input 1305d, electronic device 1300 updates results interface 1316 to include result 1320 corresponding to the requested task of input 1305d. In some examples, updating results interface 1316 in this manner includes replacing result 1318 with result 1320. In some examples, updating results interface 1316 further includes modifying a size and/or shape of results interface 1316 to ensure that result 1320 properly fits within results interface 1316. In some examples, updating results interface 1316 includes highlighting results interface 1316 for a threshold amount of time, and in other examples, results interface 1316 is not highlighted when updated. Further in response to completion of the request task of input 1305d, electronic device 1300 provides output (e.g., auditory output) 1304e (“I've added a reminder for you”) indicating that the task has been completed.

While displaying result 1320 in results interface 1316 (and while the digital assistant remains in the activated state), electronic device 1300 receives input 1305e. In some examples, input 1305e is a natural-language speech input indicative of a request directed to the digital assistant of electronic device 1300 (e.g., “Make it important for this weekend”).

In response to input 1305e, electronic device 1300 identifies a task corresponding to input 1305e (e.g., updating a reminder), and initiates performance of the task. As described, initiating performance of the task may include determining whether a latency of the identified task satisfies a set of latency criteria. In the illustrated example of FIG. 13E, electronic device 1300 determines that the requested task does not satisfy the set of latency criteria, and, optionally, forgoes displaying a performance indicator.

As shown in FIG. 13F, after completing the task corresponding to input 1305c, electronic device 1300 updates results interface 1316 to include result 1322 corresponding to the requested task of input 1305e. In some examples, updating results interface 1316 in this manner includes replacing result 1320 with result 1322. In some examples, updating results interface 1316 further includes modifying a size and/or shape of results interface 1316 to ensure that result 1322 properly fits within results interface 1316. Further in response to completion of the request task of input 1305e, electronic device 1300 provides output (e.g., auditory output) 1304f (“I've updated your reminder”) indicating that the task has been completed.

While displaying result 1322 in results interface 1316 (and while the digital assistant remains in the activated state), electronic device 1300 receives input 1305f. In some examples, input 1305f is a natural-language speech input indicative of a request directed to the digital assistant of electronic device 1300 (e.g., “Send Amanda a message to buy an umbrella”).

In response to input 1305f, electronic device 1300 identifies a task corresponding to input 1305f (e.g., sending a message), and initiates performance of the task. As described, initiating performance of the task may include determining whether a latency of the identified task satisfies a set of latency criteria. In the illustrated example of FIG. 13F, electronic device 1300 determines that the requested task does not satisfy the set of latency criteria, and, optionally, forgoes displaying a performance indicator.

As shown in FIG. 13G, after completing the task corresponding to input 1305f, electronic device 1300 updates results interface 1316 to include result 1324 corresponding to the requested task of input 1305f. In some examples, updating results interface 1316 in this manner includes replacing result 1320 with result 1324. In some examples, updating results interface 1316 further includes modifying a size and/or shape of results interface 1316 to ensure that result 1324 properly fits within results interface 1316.

In some examples, while displaying result 1324 in results interface 1316 (and while the digital assistant remains in the activated state), electronic device 1300 receives input 1305g. In some examples, input 1305g is a tap gesture on result 1324. In response to input 1305g, electronic device displays (e.g., replaces display of application interface 1310 and/or results interface 1316 with) application interface 1330. In some examples, application interface 1330 corresponds to a messaging application and is, optionally, preloaded with a parameter corresponding to result 1324 (e.g., “We'll have to buy an umbrella”). In some examples, the digital assistant of electronic device is deactivated in response to input 1305g.

In FIG. 13I, electronic device 1300 displays, on display 1301, application interface 1340 on display 1301 while a digital assistant of electronic device 1300 is activated (e.g., in a voice mode). In some examples, application interface 1340 corresponds to a news application (e.g., for viewing news articles) of electronic device 1300. Electronic device 1300 further displays an activation indicator 1311 indicating that the digital assistant is activated (e.g., in the voice mode).

While displaying application interface 1340 (and while the digital assistant remains in the activated state), electronic device 1300 receives input 1305i. In some examples, input 1305i is a natural-language speech input indicative of a request directed to the digital assistant of electronic device 1300 (e.g., “Did the ship sink?”).

In response to input 1305i, electronic device 1300 identifies a task corresponding to input 1305i (e.g., providing information related to a displayed article), and initiates performance of the task. As described, initiating performance of the task may include determining whether a latency of the identified task satisfies a set of latency criteria. In the illustrated example of FIG. 13I, electronic device 1300 determines that the requested task does not satisfy the set of latency criteria, and, optionally, forgoes displaying a performance indicator.

Once electronic device 1300 (or the digital assistant) completes the task, electronic device 1300 displays results interface 1342 including result 1344 corresponding to the requested task of input 1305i, as shown in FIG. 13J. In some examples, further in response to completing the task, electronic device 1300 provides output (e.g., auditory output) 1304j (e.g., “The ship was lost off the coast of Cuba”) indicating that the task has been completed and/or summarizing one or more aspects of result 1342.

While displaying application interface 1340 (and while the digital assistant remains in the activated state), electronic device 1300 receives input 1305j. In some examples, input 1305j is a natural-language speech input indicative of a request directed to the digital assistant of electronic device 1300 (e.g., “Was the stock price affected?”).

In response to input 1305j, electronic device 1300 identifies a task corresponding to input 1305j (e.g., providing a share price), and initiates performance of the task. As described, initiating performance of the task may include determining whether a latency of the identified task satisfies a set of latency criteria. In the illustrated example of FIG. 13J, electronic device 1300 determines that the requested task satisfies the set of latency criteria and displays performance indicator 1346, as shown in FIG. 13K.

As shown in FIG. 13L, after completing the task corresponding to input 1305j, electronic device 1300 updates results interface 1342 to include result 1348 corresponding to the requested task of input 1305j. In some examples, updating results interface 1342 in this manner includes replacing result 1344 with result 1348. In some examples, updating results interface includes merging performance indicator 1346 into result interface 1342, for instance, using an animation. In some examples, updating results interface 1342 further includes modifying a size and/or shape of results interface 1342 to ensure that result 1348 properly fits within results interface 1342. In some examples, further in response to completing the task, electronic device 1300 provides output (e.g., auditory output) 13041 (e.g., “The stock price was not affected”) indicating that the task has been completed and/or summarizing one or more aspects of result 1348.

In some examples, while displaying result 1348 in results interface 1342 (and while the digital assistant remains in the activated state), electronic device 1300 receives input 13051. In some examples, input 13051 is a tap gesture (e.g., a long press) on result 1348. As shown in FIG. 13M, in response to input 13051, electronic device 1300 displays options menu 1350 including a variety of options corresponding to result 1348. As an example, options menu 1350 can include a first option for copying at least a portion of result 1348. As another example, options menu can include an option for reporting any concerns pertaining to result 1348 (e.g., for reporting potentially inaccurate information).

In FIG. 13N, electronic device 1300 displays, on display 1301, home interface 1360 on display 1301 while a digital assistant of electronic device 1300 is activated (e.g., in a voice mode). Electronic device 1300 further displays an activation indicator 1311 indicating that the digital assistant is activated (e.g., in the voice mode). While displaying application interface 1360 (and while the digital assistant remains in the activated state), electronic device 1300 receives input 1305n. In some examples, input 1305n is a natural-language speech input including multiple requests directed to the digital assistant of electronic device 1300 (e.g., “Turn on the kitchen lights”, Tell Amanda I'm Home”).

In some examples, the digital assistant of electronic device 1300 is configured to initiate performance of multiple tasks simultaneously. For example, in response to input 1305n, electronic device 1300 identifies a task corresponding to each request in input 1305n (e.g., turning on lights, sending a message). In the illustrated example, electronic device 1300 determines that the latency of each task satisfies latency criteria and as a result displays performance indicators corresponding to the tasks, respectively. In some examples, performance indicators displayed in this manner are displayed at a predetermined location (e.g., at or near a center of display 901), or set of locations, on display 901 and translated across display 901, as described. In some examples, the order in which the performance indicators are displayed is based on an expected latency and/or measured latency of tasks corresponding to the performance indicators. A first performance indicator may be displayed above a second performance indicator, for instance, if the task for the first performance indicator is expected to finish prior to the task for the second performance indicator. In some examples, if the expected order of tasks changes, the displayed order of performance indicators may be modified commensurately.

As illustrated in FIG. 13O, for example, electronic device 1300 displays performance indicator 1362 corresponding to a task for turning lights on and displays performance indicator 1364 corresponding to a task for sending a message. As shown, each of the performance indicators 1362, 1364 includes a respective intent indicator (e.g., 1362a, 1364a) indicating (e.g., identifying) a task currently being performed by electronic device 1300 (or the digital assistant).

Thereafter, as each task is completed, electronic device 1300 provides a corresponding result. With reference to FIG. 13P, for example, electronic device 1300 completes the task corresponding to performance indicator 1362 (e.g., turning on lights) and displays results interface 1366 including a result indicating that the task has been completed. In some examples, displaying results interface 1366 includes transitioning performance indicator 1362 into results interface 1366, for instance, using an animation.

As shown in FIG. 13Q, after completing the task corresponding to performance indicator 1364 (e.g., sending a message), electronic device displays results interface 1368 including a result for the task (e.g., a confirmation prompt for sending a message). In some examples, displaying results interface 1368 includes transitioning performance indicator 1364 into results interface 1368, for instance, using an animation.

In FIG. 13R, electronic device 1300 displays, on display 1301, application interface 1370 on display 1301 while a digital assistant of electronic device 1300 is activated (e.g., in a text input mode). In some examples, application interface 1370 corresponds to a fitness application (e.g., for managing user fitness) of electronic device 1300. Because electronic device 1300 may be activated in a text input mode, electronic device 1300 displays a text communication user interface 1372 including digital assistant keyboard 1374, text input field 1376, and suggestions 1378 (e.g., suggestions 1378a-c). Electronic device 1300 further modifies a visual characteristic of one or more elements of text communication user interface 1372 indicating that the digital assistant is activated (e.g., in the text input mode).

While displaying application interface 1370 (and while the digital assistant remains in the activated state), electronic device 1300 receives input 1305r. In the illustrated example, input 1305r is a natural-language speech input including a request directed to the digital assistant of electronic device 1300 (e.g., “What is my fastest split?”). In other examples, input 1305r may be an input of a different type, such as a text input provided to the digital assistant using the text communication user interface 1372.

In response to input 1305r, electronic device 1300 identifies a task corresponding to input 1305r (e.g., providing fitness information), and initiates performance of the task. As described, initiating performance of the task may include determining whether a latency of the identified task satisfies a set of latency criteria. In the illustrated example, electronic device 1300 determines that the requested task satisfies the set of latency criteria and displays performance indicator 1380, as shown in FIG. 13S. Performance indicator 1380 optionally includes an intent indicator 1380a which indicates (e.g., identifies) a task currently being performed by electronic device 1300.

In some examples, after initiating a task, electronic device 1300 determines that more information is required to complete performance of the task. As shown in FIG. 13T, for example, electronic device 1300 may determine that more information is required to provide a “fastest split” as requested and prompt a user to disambiguate between parameters such that electronic device 1300 is able to complete the task. In some examples, electronic device 1300 prompts a user by displaying disambiguation prompt 1382. In some examples, disambiguation prompt 1382 includes disambiguation candidates 1382a (e.g., “running”), 1382b (e.g., “cycling”), and 1382c (“walking”), each of which may be selected by a user (e.g., using a touch input) to identify a desired task parameter (e.g., which type of split was intended by the task request). In some examples, displaying disambiguation prompt 1382 includes transitioning performance indicator 1380 into disambiguation interface 1382, for instance, using an animation.

In some examples, electronic device 1300 prompts a user by displaying disambiguation suggestions 1383 (e.g., disambiguation suggestions 1383a-c). In some examples, displaying disambiguation suggestions 1383 replacing display of suggestions 1378 with disambiguation suggestions 1383. Each disambiguation suggestion 1383 may be selected by a user to indicate a desired task parameter (e.g., which type of split was intended by the task request). In some examples, when prompting a user to disambiguate, electronic device 1300 does not display disambiguation suggestions 1383 and, optionally, maintains display of suggestions 1378.

In some examples, when operating in the text input mode, electronic device 1300 provides predictions (e.g., autocompletion predictions) that may be used to select text to be inserted in a text input field of a text communication user interface. In some examples, when a user is prompted to disambiguate, one or more predictions may correspond to parameters for a current task. For example, as illustrated in FIG. 13T, electronic device 1300 displays predictions 1384 (e.g., predictions 1384a-c). While displaying predictions 1384 (and while the digital assistant remains in the activated state), electronic device 1300 receives input 1305t. In some examples, input 1305t is a tap input detected at a location corresponding to prediction 1384a (e.g., “Running”).

In response to input 1305t, electronic device 1300 inserts prediction 1384b into text input field 1376, as shown FIG. 13U. Thereafter, electronic device 1300 detects input 1305u. Input 1305u is a tap input in some examples. In response to input 1305u, electronic device 1300 provides text of text input field 1386 (“Running”) to the digital assistant as a desired task parameter for the current task.

In some examples, once electronic device 1300 has received a task parameter for the current task (e.g., from a selection of a disambiguation candidate, selection of a disambiguation suggestion, or text inserted into a text input field), electronic device 1300 resumes performance of the task. In some examples, resuming performance of a task includes determining if a latency of the task satisfies latency criteria. In the illustrated example of FIG. 13V, electronic device 1300 determines that the resumed task satisfies the set of latency criteria and displays performance indicator 1386. Performance indicator 1386, optionally, includes intent indicator 1386a which indicates (e.g., identifies) the updated (e.g., disambiguated) task currently being performed by electronic device 1300. In some examples, displaying performance indicator 1386 includes transitioning disambiguation interface 1382 into performance indicator 1386, for instance, using an animation.

Once electronic device 1300 (or the digital assistant) completes the task, electronic device 1300 displays results interface 1392 including result 1392 corresponding to the requested task of input 1305r (FIG. 13R), as shown in FIG. 13W.

FIGS. 13X-13AC describe various aspects of disambiguation performed by electronic device 1300. In FIG. 13X, electronic device 1300 displays, on display 1301, application interface 1310A on display 1301 while a digital assistant of electronic device 1300 is activated (e.g., in a voice mode). Electronic device 1300 further displays an activation indicator 1311 indicating that the digital assistant is activated (e.g., in the voice mode). While displaying application interface 1310A (and while the digital assistant remains in the activated state), electronic device 1300 receives input 1305x. In some examples, input 1305x is a natural-language speech input including a request directed to the digital assistant of electronic device 1300 (e.g., “Tell me about Mercury”).

In response to input 1305x, electronic device 1300 identifies a task corresponding to input 1305x (e.g., providing information about Mercury), and initiates performance of the task. As described, in some examples, after initiating the task, electronic device 1300 may determine that more information is required to complete performance of the task and prompt a user to provide input to allow electronic device 1300 to complete performance of the task.

As illustrated in FIG. 13Y, in some examples, prompting a user includes confirming one or more aspects of the user request. As shown, in response to the user request, electronic device 1300 confirms the user request by displaying disambiguation prompt 1312A, which prompts a user to confirm whether the user asked about “Mercury.”

As illustrated in FIG. 13Z, in some examples, prompting a user includes prompting the user to provide an answer to an open-ended query (e.g., the query “Which Mercury?” in disambiguation prompt 1314A). In response, the user can provide an input (e.g., a voice input) clarifying one or more aspects of the user's request (e.g., “The planet”).

As illustrated in FIG. 13AA, in some examples, prompting a user includes providing a list of candidates (e.g., the list of candidates in disambiguation prompt 1316A) from which a user can select a candidate parameter. In some examples, the electronic device 1300 can, optionally, provide additional information to assist the user in making a selection (e.g., “Roman god”, “smallest planet”, “chemical element”).

As another example, in FIG. 13AB, electronic device 1300 receives input 1305ab. In some examples, input 1305ab is a natural-language speech input including a request directed to the digital assistant of electronic device 1300 (e.g., “Text John”). In response to input 1305ab, electronic device 1300 identifies a task corresponding to input 1305ab (e.g., sending a message), and initiates performance of the task. After initiating the task, electronic device 1300 determines that more information is required to complete performance of the task (e.g., disambiguation of “John”), and prompts a user to provide input to allow electronic device 1300 to complete performance of the task.

As illustrated in FIG. 13AC, to prompt the user, electronic device 1300 displays disambiguation prompt 1318A. As shown, disambiguation prompt 1318A includes a number of candidates 1318Aa from which the user can select a parameter (e.g., to indicate which John was intended). Disambiguation prompt further includes search field 1318Ab, which can be used to search for a particular parameter, for instance, if not included in candidates 1318Aa. Disambiguation prompt 1318A further includes a show affordance 1318Ac, which when selected causes electronic device 1300 to display an interface (not shown) including a full list of available parameters for the task.

FIGS. 13ACA-13ACF illustrate various aspects of navigating between interfaces using electronic device 1300. In FIG. 13ACA, electronic device 1300 displays, on display 1301, application interface 1330a on display 1301 while a digital assistant of electronic device 1300 is activated (e.g., in a voice mode). Electronic device 1300 further displays an activation indicator 1311 indicating that the digital assistant is activated (e.g., in the voice mode). While displaying application interface 1330a (and while the digital assistant remains in the activated state), electronic device 1300 receives input 1305aca. In some examples, input 1305aca is a natural-language speech input including a request directed to the digital assistant of electronic device 1300 (e.g., “What's the weather like in Sausalito?”).

In response to input 1305aca, electronic device 1300 identifies a task corresponding to input 1305aca (e.g., providing weather information), and initiates performance of the task. As shown in FIG. 13ACB, after completing the task corresponding to input 1305aca, electronic device 1300 displays results interface 1332a including the requested weather information. In some examples, displaying results interface 1332a includes translating application interface 1330a (e.g., downward) across display 901 to allow for display of results interface 1332a without overlaying results interface 1332a over application interface 1330a.

In some examples, while displaying results interface 1332a (and application interface 1330a), electronic device 1300 receives input 1305acb. In some examples, input 1305acb is a swipe gesture (e.g., an upward swipe gesture) on home bar 1334a of application interface 1330a. As shown in FIG. 13ACC, in response to input 1305acb, electronic device 1300 displays (e.g., replaces display of application interface 1330a and/or results interface 1332a with) application switch interface 1336a. In some examples, application switch interface 1336a includes applications indicators 1338aa-1338ac, each of which, when selected, causes electronic device 1300 to launch a respective corresponding application. Application switch interface 1336a further includes results indicator 1338ad corresponding to results interface 1332a, which when selected, causes electronic device to display results interface 1332a and, optionally, application interface 1330a or digital assistant interface 1344a (FIG. 13ACF).

In some examples, a user may activate a digital assistant (e.g., in a text mode) using application switch interface 1336a. For example, while displaying application switch interface 1336a, electronic device 1300 receives input 1305acc. In some examples, input 1305acc is a swipe gesture (e.g., a leftward swipe gesture) on a portion of application switch interface 1336a. As shown in FIG. 13ACD, in response to input 1305acc, electronic device 1300 translates application switch interface 1336a to display digital assistant indicator 1340a.

As shown in FIG. 13ACE, as input 1305acc is provided (e.g., as a user continues to swipe), electronic device 1300 translates application switch interface 1336a to display an additional portion of digital assistant indicator 1340a, and optionally, indicator 1342a on a portion of digital assistant indicator 1340, indicating that input 1305acd is nearing a point at which a digital assistant of electronic device 1300 will be activated. In some examples, indicator 1342a provides a glow effect, and optionally, is increasingly visually emphasized (e.g., enlarged, brightened) as the magnitude (e.g., length) of input 1305acc increases.

As shown in FIG. 13ACF, once input 1305acc reaches a threshold distance, electronic device 1300 activates a digital assistant (e.g., in a text mode). In some examples, activating the digital assistant in this manner may include displaying digital assistant interface 1344a, and optionally, results interface 1332a. In some examples, results interface 1332a is displayed if results corresponding to results interface 1332a were provided within a threshold amount of time of activating the digital assistant (e.g., 30 seconds). In some examples, digital assistant interface 1344a includes text communication interface 1346a, which can, optionally, be used to provide text inputs to a digital assistant of electronic device 1300 as described. In some examples, one or more elements of text communication user interface 1346a is visually highlighted.

FIGS. 13AD-13AF illustrate various aspects of operating a digital assistant of electronic device 1350. FIGS. 13AD-AF illustrates an electronic device 1350 (e.g., device 104, device 122, device 200, device 600, or device 700). In the non-limiting exemplary embodiment illustrated in FIGS. 13AD-13AF, electronic device 1350 is a personal computer. In other embodiments, electronic device 1350 can be a different type of electronic device, such as a mobile device, a wearable device (e.g., a smartwatch, headset), a smart speaker, and/or a set-top box. In some examples, electronic device 1350 has a display 1351, one or more input devices (e.g., a touchscreen of display 1351, a button, a microphone, a keyboard, a mouse), and a wireless communication radio. In some examples, electronic device 1350 includes one or more forward facing and/or back facing cameras. In some examples, the electronic device includes one or more biometric sensors which, optionally, include a camera, such as an infrared camera, a thermographic camera, or a combination thereof.

At FIG. 13AD, electronic device 950 is operating while a digital assistant of computing device 1350 is activated (e.g., in a voice mode). Because electronic device 1350 may be activated, electronic device 1350 displays input field 1320A and suggestions 1322 (e.g., suggestions 1322a-c). Electronic device 1350 further modifies a visual characteristic of text input field 1320A and/or suggestions 1322A indicating that the digital assistant is activated (e.g., in the voice mode).

While the digital assistant is activated, electronic device 1350 receives input 1305ad. In the illustrated example, input 1305ad is a natural-language speech input including a request directed to the digital assistant of electronic device 1300 (e.g., “What is the weather in Chicago?”). In other examples, input 1305ad may be an input of a different type, such as a text input provided to the digital assistant using the text input field 1320A. In some examples, electronic device 1300 displays a text representation of input 1305ad in input field 1320A.

In response to input 1305ad, electronic device 1350 identifies a task corresponding to input 1350ad (e.g., providing a weather forecast), and initiates performance of the task. As described, initiating performance of a task may include determining whether a latency of the identified task satisfies a set of latency criteria. In the illustrated example, electronic device 1350 determines that the requested task satisfies the set of latency criteria and displays performance indicator 1326A, as shown in FIG. 13AE. In some examples, electronic device 950 highlights performance indicator 1326A.

Once electronic device 1350 (or the digital assistant) completes the task, electronic device 1350 displays results interface 1328A including result 1328Aa corresponding to the requested task of input 1305ad, as shown in FIG. 13AF. In some examples, electronic device 1350 highlights result 1328Aa, for instance, for a threshold amount of time.

FIG. 14 is a flowchart of an exemplary method 1400 for managing a digital assistant, according to various examples. Process 1400 is performed, for example, using one or more computer systems (e.g., electronic devices, such as electronic device 1300) implementing a digital assistant. In some examples, process 1400 is performed using a client-server system (e.g., system 100), and the blocks of process 1400 are divided up in any manner between the server (e.g., DA server 106) and a client device. In other examples, the blocks of process 1400 are divided up between the server and multiple client devices (e.g., a mobile phone and a smart watch). Thus, while portions of process 1400 are described herein as being performed by particular devices of a client-server system, it will be appreciated that process 1400 is not so limited. In other examples, process 1400 is performed using only a client device (e.g., user device 104) or only multiple client devices. In process 1400, some blocks are, optionally, combined, the order of some blocks is, optionally, changed, and some blocks are, optionally, omitted. In some examples, additional steps may be performed in combination with the process 1400.

In some embodiments, the electronic device (e.g., 1300) is a computer system (e.g., a personal electronic device (e.g., a mobile device (e.g., iPhone), a headset (e.g., Vision Pro), a tablet computer (e.g., iPad), a smart watch (e.g., Apple Watch), a desktop (e.g., iMac), or a laptop (e.g., MacBook)) or a communal electronic device (e.g., a smart TV (e.g., AppleTV) or a smart speaker (e.g., HomePod))). The computer system is optionally in communication (e.g., wired communication, wireless communication) with a display generation component (e.g., an integrated display and/or a display controller) and with one or more input devices (e.g., a touch-sensitive surface (e.g., a touchscreen), a mouse, and/or a keyboard). The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

The operations described above with reference to FIG. 14 are optionally implemented by components depicted in FIGS. 1-4A, 6A-6B, 7A-7C, and FIGS. 13A-13AF. For example, the operations of process 1400 may be implemented by electronic device 1300 and, optionally, a digital assistant executing thereon. It would be clear to a person having ordinary skill in the art how other processes are implemented based on the components depicted in FIGS. 1-4A, 6A-6B, 7A-7C, and 13A-13AF.

While a digital assistant of the computer system is active (1405), the computer system receives (1410), via the one or more input devices, a request (e.g., 1305a, 1305d, 1305e, 1305f, 1305i, 1305j, 1305n, 1305r, 1305x, 1305ab, 1305ad) to perform a first task.

In some examples, the digital assistant can operate in one of any number of predefined modes. In some examples, a first mode is a voice mode and/or a second mode is a text input mode, each of which is invoked according to respective types of inputs. In some examples, the digital assistant is activated in the first mode is activated in response to a trigger word provided by way of a voice input, a touch input of a particular type (e.g., long press), and/or selection of a button of the computer system. In some examples, the digital assistant is activated in the second mode in response to a touch input of a particular type (e.g., a double tap), for instance, at a particular location on a user interface provided by the computer system.

In some examples, the computer system receives an input (e.g., 1305a, 1305d, 1305e, 1305f, 1305i, 1305j, 1305n, 1305r, 1305x, 1305ab, 1305ad, 1305aca), such as a speech input (e.g., natural-language speech input), text input (e.g., natural-language text input), or touch input (e.g., selection of an affordance) from a user that includes, or otherwise identifies, a first task.

While a digital assistant of the computer system is active (1405), in response to the request to perform the first task, the computer system performs (1415) the first task.

In some examples, in response to the request to perform the first task, the computer system performs the requested task. In some examples, performing the task in this manner includes displaying a performance indicator (e.g., 1312, 1346, 1362, 1364, 1380, 1386, 1326A) indicating that the computer system is currently performing the task and/or an indication as to the task identified by the request (e.g., a request for a weather forecast may cause the computer system to display a performance indicator labeled “weather”).

While a digital assistant of the computer system is active (1405), after performing the first task, the computer system displays (1420), via the display generation component, a user interface object (e.g., 1316, 1342, 1366, 1368, 1382, 1390, 1328A, 1332a) including a first result (e.g., 1318, 1320, 1322, 1324, 1344, 1348, 1350, 1392, 1312A, 1314A, 1316A, 1318A, 1328Aa) corresponding to the first task.

In some examples, once the computer system has completed the first task, the computer system displays a result (e.g., 1318, 1320, 1322, 1324, 1344, 1348, 1350, 1392, 1312A, 1314A, 1316A, 1318A, 1328Aa) corresponding to the first task. In some examples, displaying the result includes transitioning the performance indicator (e.g., 1312, 1346, 1362, 1364, 1380, 1386, 1326A) into the result, for instance, via an animation. In some examples, the result is displayed at a particular location (e.g., location 1314) on a display (e.g., 1301) of the computer system and/or includes an indication (e.g., 1312a, 1346a, 1362a, 1364a, 1380a) as to the nature of the task requested (e.g., “Here's information about this weekend's weather”). In some examples, the user interface object is overlaid on a user interface currently displayed by the computing device. In some examples, the user interface is displaced (e.g., translated across the display, for instance, in a downward direction) to provide room for display of the user face object. In some examples, once displayed, the user interface object is visually highlighted (e.g., with a glow effect) for a predetermined amount of time after which the visual highlighting is removed.

While a digital assistant of the computer system is active (1405) and while the user interface object is displayed (1425), the computer system receives (1430), via the one or more input devices, a request (e.g., 1305a, 1305d, 1305e, 1305f, 1305i, 1305j, 1305n, 1305r, 1305x, 1305ab, 1305ad) to perform a second task different than the first task.

In some examples, the computer system receives an input, such as a speech input (e.g., natural-language speech input), text input (e.g., natural-language text input), or touch input (e.g., selection of an affordance) from a user that includes, or otherwise identifies, a second task.

While a digital assistant of the computer system is active (1405) and while the user interface object is displayed (1425), in response to the request to perform the second task, the computer system performs (1435) the second task.

In some examples, in response to the request to perform the second task, the computer system performs the requested task. In some examples, performing the task in this manner includes displaying a performance indicator (e.g., 1312, 1346, 1362, 1364, 1380, 1386, 1326A) indicating that the computer system is currently performing the task and/or an indication as to the task identified by the request (e.g., a request for a set of directions may cause the computer system to display a performance indicator labeled “routing”).

While a digital assistant of the computer system is active (1405) and while the user interface object is displayed (1425), the computer system modifies (1440) display of the user interface object (e.g., 1318, 1320, 1322, 1324, 1344, 1348, 1350, 1392, 1312A, 1314A, 1316A, 1318A, 1328Aa) to include a second result corresponding to the second task.

In some examples, once the computer system has completed the second task, the computer system displays a result corresponding to the second task. In some examples, displaying the result includes maintaining display of the user interface object and updating contents of the user interface object to include the result for the second task. In some examples, the computer system replaces at least a portion of the first result with the second result. In some examples, the computer system appends the first result with the second result.

Displaying a user interface object including a first result and thereafter modifying display of the user interface object to include a second result provides improved visual feedback by displaying each of the results in turn without cluttering the user interface including the user interface object. As a result, a user can more readily identify and/or examine results, resulting in more efficient use of the computer system, which additionally reduces power usage and improves battery life of the device by enabling the user to use the device more quickly and efficiently.

In some examples, displaying the user interface object includes translating the user interface object (e.g., 1312, 1346, 1362, 1364, 1380, 1386, 1326A) from a first location (e.g., 1313) of a display of the computer system to a second location (e.g., 1314) of the display of the computer system, the second location different than the first location. In some examples, the user interface object is translated (e.g., vertically) across a display of (or in communication with) the computer system.

In some examples, modifying display of the user interface object includes adjusting a size of the user interface object, a shape of the user interface object, or a combination thereof. In some examples, the user interface object is modified in shape and/or size, for instance, based on the second result. In some examples, the user interface object is modified to fit a set of content of the second result.

In some examples, at least one of the size of the user interface object or the shape of the user interface object is based on the second result.

In some examples, the computer system detects a first input (e.g., 1305g) (e.g., a touch input) at a location corresponding to the second result. In some examples, in response to the first input, the computer system displays an application interface (e.g., 1330). In some examples, the user interface object and/or a result displayed in the user interface object are selectable. In some examples, selection of the user interface object and/or a result displayed in the user interface object causes the computing device to expand the user interface object into a full screen user interface. In some examples, the full screen user interface is an expanded form of the user interface object. In some examples, the full screen user interface is an application interface for an application corresponding to the result included in the user interface object.

Displaying an application interface in response to an input detected at a location corresponding to a result allows a user to access an application corresponding to a result with a single input, thereby reducing the number of inputs required to access an application.

In some examples, performing the first task includes prior to completing the first task, displaying a performance indicator (e.g., 1312, 1346, 1362, 1364, 1380, 1386, 1326A) corresponding to the request to perform the first task. In some examples, the performance indicator indicates an intent corresponding to the request to perform the first task. In some examples, when initiating a task, the computing device displays a performance indicator, which indicates that the computing device is initiating performance of a task and/or performing a task. In some examples, the computing device selectively displays the performance indicator based on a latency of a task. In some examples, if a latency of a task exceeds a threshold, the computing device displays a performance indicator for a task, and if the latency does not exceed a threshold, the computing device forgoes displaying the performance indicator. In some examples, a performance indicator is displayed until a task is completed and/or a result for the task is ready to be provided to a user. In some examples, the performance indicator includes an intent indicator which indicates an intent associated with the task.

Displaying a performance indicator provides improved visual feedback regarding the state (e.g., activation state) of a digital assistant and whether a user that the digital assistant (and/or the computing device generally) is initiating performance of a task.

In some examples, displaying a performance indicator includes translating the performance indicator from a third location (e.g., 1313) of a display of the computing device to a fourth location (e.g., 1314) of the display of the computing device. In some examples, a performance indicator is translated across a display of the computer system.

In some examples, while a digital assistant of the computer system is active and prior to receiving the request to perform a first task, in accordance with a determination that a set of result display criteria is met, the computer system displays a result corresponding to a third task. In some examples, while a digital assistant of the computer system is active and prior to receiving the request to perform a first task, in accordance with a determination that the result of result display criteria is not met, the computer system forgoes display of the result corresponding to the third task. In some examples, upon activation of a digital assistant, the computing device determines if a set of result display criteria is met. In some examples, the result display criteria include a requirement that the digital assistant was previously activated within a threshold amount of time; if the result display criteria is met, the computing device displays a result corresponding to the previous activation of the digital assistant.

Selectively displaying a result corresponding to a previous task allows a user to intuitively and efficiently view a result from the previous digital assistant session, in turn providing for faster and more reliable usage of the computing device.

In some examples, the first result includes a set of interactive content (e.g., interactive content of 1324, 1368) (e.g., contents of a photo, video, or selectable text). In some examples, results include one or more types of content (e.g., video, images, text). In some examples, content of a result is interactive such that a user may interact with the content. In some examples, the user can copy content into applications, such as applications on which the result is overlaid (e.g., using a drag-and-drop feature and/or a copy-paste function). In some examples, a user can initiate playback of content within the result. In some examples, results include an attribution to one or more sources of information which were used to provide the result. In some examples, attributions are links (e.g., hyperlinks) which may be selected to view the respective attributed source.

Providing interactive content in this manner allows the user to interact directly with content in results rather than having to access the content in applications of the computer system, which reduces the number of inputs required to operate the computing device.

In some examples, the first result further includes an attribution (e.g., “Nautical News Today” in 1344) for the interactive content.

Including an attribution in results allows for a user to reliably and efficiently identify a source of information and/or content provided in a result, which reduces the number of inputs needed to access one or more operations.

In some examples, the attribution is a hyperlink, which when selected, causes the computing device to display a source of the interactive content.

Including an attribution link in results allows for a user to reliably and efficiently access a source of information and/or content provided in a result, which reduces the number of inputs needed to access one or more operations.

In some examples, after modifying display of the user interface object to include a second result, the computer system detects a second input at a location corresponding to the second result.

In some examples, in response to the second input, the computer system displays an options menu (e.g., 1350) corresponding to the second result. In some examples, in response to an input (e.g., long press) detected at a location corresponding to the result, the computer system displays an options menu for the result including one or more options for the result. In some examples, the options menu includes a copy affordance which when selected causes at least a portion of content of the result to be copied to a clipboard of the computer system. In some examples, the options menu includes an affordance for reporting a concern, such as a concern that information of the result is inaccurate.

In some examples, the first result includes a set of user-specific information. In some examples, results include user-specific information; by way of example, a user may request that the digital assistant provide information regarding an upcoming dinner reservation, and in response the computing device displays a result including information regarding the dinner reservation.

In some examples, performing the first task includes displaying a disambiguation interface (e.g., 1382, 1312A, 1314A, 1316A, 1318A). In some examples, the disambiguation interface includes a task intent indicator corresponding to the first task. In some examples, when initiating performance of a task, the computing device may determine that a value for one or more parameters of the task cannot be resolved, for instance, with a predetermined level of confidence. In some examples, when a parameter value cannot be resolved in this manner, the computer system disambiguates values for the parameter by providing a query to a user for selection of a parameter value and/or information which would allow the computing device to select a parameter value. In some examples, disambiguation includes providing a confirmation prompt to a user (e.g., “Did you say ‘Mercury’?”). In some examples, disambiguation includes providing a selection prompt (e.g., “Which Mercury?”, “The god, planet, or element?”). In some examples, disambiguation includes a complex disambiguation in which a list of candidate parameters are displayed in combination with a text input bar (either of which may be used to indicate an intended parameter value). In some examples, the user interface object is a first user interface object. In some examples, after modifying display of the user interface object to include the second result, the computer system detects a third input corresponding to a request to display an application selection user interface (e.g., 1336a). In some examples, in response to the third input (e.g., 1305acb), the computer system displays the application selection user interface. In some examples, the application selection user interface includes, a second user interface object corresponding to a first application (e.g., 1338aa, 1338ab, 1338ac), a third user interface object corresponding to a second application different than the first application (e.g., 1338aa, 1338ab, 1338ac), and a fourth user interface object corresponding to the second result (e.g., 1338ad). In some examples, the computer system receives an input at a location corresponding to request to display an application selection user interface. In some examples, in response to the input, the computing device displays the application selection user interface. In some examples, the application selection user interface includes user interface objects corresponding to a respective set of applications. In some examples, the applications correspond to previously used applications of the computer system and are, optionally, arranged in a “stack” based on recency of usage. In some examples, the application selection user interface includes a user interface object corresponding to a result provided by the computer system. In some examples, the user interface object corresponding to the result is arranged with the user interface objects corresponding to applications (e.g., based on recency). In some examples, a result has an expiration, for instance, based on a threshold amount of time, and the user interface object corresponding to the result is included in the application selection user interface for as long as the result has not yet expired. In some examples, selection of the user interface object corresponding to the result causes the computer system to launch an application corresponding to the result.

In some examples, the application selection user interface further includes a fifth user interface object corresponding to the digital assistant of the computing device (e.g., 1340a), wherein selection of the fifth user interface object causes the computer system to display a digital assistant interface (e.g., 1344a).

In some examples, the application selection user interface includes a user interface object corresponding to a digital assistant of the electronic device. In some examples, selection of the user interface object corresponding to a digital assistant causes the computer system to activate the digital assistant in a particular mode (e.g., text input mode) and/or display a digital assistant user interface. In some examples, the user interface object corresponding to the digital assistant is selected using a particular type of input, such as a swipe input.

FIG. 15 is a flowchart of an exemplary method 1500 for managing a digital assistant, according to various examples. Process 1500 is performed, for example, using one or more computer systems (e.g., electronic devices, such as electronic device 1300) implementing a digital assistant. In some examples, process 1500 is performed using a client-server system (e.g., system 100), and the blocks of process 1500 are divided up in any manner between the server (e.g., DA server 106) and a client device. In other examples, the blocks of process 1500 are divided up between the server and multiple client devices (e.g., a mobile phone and a smart watch). Thus, while portions of process 1500 are described herein as being performed by particular devices of a client-server system, it will be appreciated that process 1500 is not so limited. In other examples, process 1500 is performed using only a client device (e.g., user device 104) or only multiple client devices. In process 1500, some blocks are, optionally, combined, the order of some blocks is, optionally, changed, and some blocks are, optionally, omitted. In some examples, additional steps may be performed in combination with the process 1500.

In some embodiments, the electronic device (e.g., 1300) is a computer system (e.g., a personal electronic device (e.g., a mobile device (e.g., iPhone), a headset (e.g., Vision Pro), a tablet computer (e.g., iPad), a smart watch (e.g., Apple Watch), a desktop (e.g., iMac), or a laptop (e.g., MacBook)) or a communal electronic device (e.g., a smart TV (e.g., AppleTV) or a smart speaker (e.g., HomePod))). The computer system is optionally in communication (e.g., wired communication, wireless communication) with a display generation component (e.g., an integrated display and/or a display controller) and with one or more input devices (e.g., a touch-sensitive surface (e.g., a touchscreen), a mouse, and/or a keyboard). The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

The computer system receives (1505), via the one or more input devices, an input (e.g., 1305a, 1305d, 1305e, 1305f, 1305i, 1305j, 1305n, 1305r, 1305x, 1305ab, 1305ad) including a request to perform a task.

In some examples, the computer system receives an input, such as a speech input (e.g., natural-language speech input), text input (e.g., natural-language text input), or touch input (e.g., selection of an affordance) from a user that includes, or otherwise identifies, a task.

In response to the request, the computer system initiates (1510) performance of the task.

In some examples, in response to the request to perform the first task, the computer system initiates performance of the requested task. In some examples, when initiating performance of the task and/or after initiating performance of the task, the computer system determines a latency of the task. In some examples, a latency of a task is an indication and/or measurement as to the amount of time required to perform the task; the latency of the request can be based on a computing latency (e.g., compute one or more aspects of the task), a network latency (e.g., how much time is required for one or more network-based aspects of the task (e.g., time to send or receive a particular set of data), a memory latency (e.g., how much time is required for one or more memory-based aspects of the task (e.g., time to read or write to memory), a storage latency (e.g., how much time is required for one or more storage aspects of the task (e.g., time to read or write data to storage), or any combination thereof. In some examples, latency is further based on scheduling performed by the computing device (e.g., a task may have a higher latency if other tasks are to be performed beforehand). In some examples, latency is determined prior to performing a task (e.g., the latency is predicted). In some examples, latency is measured while a task is performed (e.g., the latency is timed).

In accordance with a determination that the task satisfies a set of latency criteria (1525), the computer system displays (1530), via the display generation component, a performance indicator (e.g., 1312, 1346, 1362, 1364, 1380, 1386, 1326A) corresponding to the task.

In some examples, if the latency of a task satisfies a set of latency criteria, the computing device displays a performance indicator (e.g., 1312, 1346, 1362, 1364, 1380, 1386, 1326A) corresponding to the task. In some examples, the set of latency criteria specifies a threshold amount of time such that if the length of a task exceeds (or is predicted to exceed) the threshold amount of time, the latency criteria is satisfied.

In some examples, if the set of latency criteria is satisfied, the computing device displays a performance indicator corresponding to the task. In some examples, the performance indicator is a user interface object displayed while the computing device identifies and/or performs the task based on the request. In some examples, the performance indicator identifies one or more aspects of the task, such that a user can recognize that the performance indicator correctly corresponds to the request (e.g., a performance indicator can recite “weather” in response to a request for a weather forecast).

In some examples, displaying the performance indicator includes visually highlighting the performance indicator, for instance, by displaying an animation on the perimeter of the performance indicator. In some examples, displaying the performance indicator includes translating the performance indicator across a display of the computer system until the performance indicator reaches a predetermined location (e.g., 1314) on the display.

In accordance with a determination that the task satisfies a set of latency criteria (1525), after the task has been performed, the computer system displays (1535) a result (e.g., 1305a, 1305d, 1305e, 1305f, 1305i, 1305j, 1305n, 1305r, 1305x, 1305ab, 1305ad) corresponding to the request.

In some examples, once the computer system has completed the task, the computer system displays a result corresponding to the task. In some examples, displaying the result includes transitioning the performance indicator into the result, for instance, via an animation. In some examples, the result is displayed at a particular location on a display of the computer system and/or includes an indication as to the nature of the task requested (e.g., “Here's information about this weekend's weather”). In some examples, the user interface object is overlaid on a user interface currently displayed by the computing device. In some examples, the user interface is displaced (e.g., translated across the display, for instance, in a downward direction) to provide room for display of the user interface object.

In accordance with a determination that the task does not satisfy the set of latency criteria (1540), the computer system forgoes (1545) display of the performance indicator.

In accordance with a determination that the task does not satisfy the set of latency criteria (1540), after the task has been performed, the computer system displays (1550) the result corresponding to the request.

In some examples, if the latency of the task does not satisfy a set of latency criteria, the computer system forgoes displaying a performance indicator for the task; instead, the computer system displays the result for the task without displaying the performance indicator.

Selectively displaying a performance indicator provides improved visual feedback that the digital assistant (and/or the computing device generally) is initiating performance of a task. In this manner, a user can more readily recognize a current state of the digital assistant and/or computing device, which additionally reduces power usage and improves battery life of the device by enabling the user to use the device more quickly and efficiently.

In some examples, after initiating performance of the task, the computer system determines a latency of the task. In some examples, when initiating performance of a task (or during performance of the task), the computing device determines a latency of the task. In some examples, if a latency of a task exceeds a threshold, the computing device displays a performance indicator for a task, and if the latency does not exceed a threshold, the computing device forgoes displaying the performance indicator. In some examples, a performance indicator is displayed until a task is completed and/or a result for the task is ready to be provided to a user. In some examples, the performance indicator includes an intent indicator which indicates an intent associated with the task. In some examples, the intent indicator can, optionally, be modified (e.g., updated) during performance of the task. In some examples, if a task requires multiple subtasks, the intent summary may be updated for each subtask. In an example in which a user requests that the digital assistant send an email to a colleague with a particular set of photos, for instance, a performance indicator can first include an intent summary for retrieving the photos and subsequently be updated to include an intent summary for sending an email including the retrieved photos.

In some examples, a latency of a task is an indication and/or measurement as to the amount of time required to perform the task; the latency of the request can be based on a computing latency (e.g., compute one or more aspects of the task), a network latency (e.g., how much time is required for one or more network-based aspects of the task (e.g., time to send or receive a particular set of data), a memory latency (e.g., how much time is required for one or more memory-based aspects of the task (e.g., time to read or write to memory), a storage latency (e.g., how much time is required for one or more storage aspects of the task (e.g., time to read or write data to storage), or any combination thereof. In some examples, latency is further based on scheduling performed by the computing device (e.g., a task may have a higher latency if other tasks are to be performed beforehand). In some examples, latency is determined prior to performing a task (e.g., the latency is predicted). In some examples, latency is measured while a task is performed (e.g., the latency is timed).

In some examples, in accordance with a determination that the task satisfies a set of latency criteria, after displaying the performance indicator, the computer system displays an animation in which the performance indicator transitions into the result. In some examples, once the computer system has completed the first task, the computer system displays a result corresponding to the first task. In some examples, displaying the result includes transitioning the performance indicator into the result, for instance, via an animation. In some examples, the result is displayed at a particular location on a display of the computer system and/or includes an indication as to the nature of the task requested (e.g., “Here's information about this weekend's weather”).

In some examples, the result includes a task intent indicator (e.g., 1312a, 1346a, 1362a, 1364a, 1380a, 1386a, 1326Aa) corresponding to the task. In some examples, initiating performance of the task includes displaying a disambiguation interface (e.g., 1382, 1312A, 1314A, 1316A, 1318A) including a plurality of candidate parameters, while displaying the disambiguation interface, receiving a selection of a candidate parameter of the plurality of candidate parameters; and initiating performance of the task according to the selected candidate parameter. In some examples, when initiating performance of a task, the computing device may determine that a value for one or more parameters of the task cannot be resolved, for instance, with a predetermined level of confidence. In some examples, when a parameter value cannot be resolved in this manner, the computer system disambiguates values for the parameter by providing a query to a user for selection of a parameter value and/or information which would allow the computing device to select a parameter value. In some examples, disambiguation includes providing a selection prompt (e.g., “Which Mercury?”, “The god, planet, or element?”) including a plurality of candidate parameters. In some examples, in response to selection of a candidate parameter, the computing device initiates performance according to the selected candidate parameter.

In some examples, the performance indicator includes an intent indicator (e.g., an indication of an intent associated with the task) (e.g., 1312a, 1346a, 1362a, 1364a, 1380a, 1386a, 1326Aa) corresponding to the selected candidate parameter.

Including an intent indicator in a performance indicator provides improved visual feedback as to a task that has been initiated by the digital assistant and/or computing device.

In some examples, the task is a first task, the performance indicator is a first performance indicator, and the input includes a second request to perform a second task. In some examples, in accordance with a determination that the second task satisfies a set of latency criteria, the computer system displays, via the display generation component, a second performance indicator corresponding to the second task. In some examples, displaying the second performance indicator includes in accordance with a determination that the first performance indicator is currently displayed, concurrently displaying the first performance indicator and the second performance indicator. In some examples, an input includes a plurality of requests corresponding to a respective plurality of tasks. In some examples, the computer system identifies requests in the input and handles the requests at least partially in parallel. In some examples, for instance, the computing device initiates performance of a second task (and, optionally, one or more other tasks) prior to completion of a first task. In some examples, as a result of initiating tasks in this manner, multiple performance indicators may be simultaneously displayed as the computing device performs the respective tasks. As each task is completed, a corresponding performance indicator is transitioned to a result for the task (or a result is shown without displaying a performance indicator if the task has a latency below a threshold latency).

Concurrently displaying first and second performance indicators allows a user to simultaneous view a status of multiple tasks, thereby providing improved visual feedback.

In some examples, the result is a first result. In some examples, displaying the first result corresponding to the request includes in accordance with a determination that the second performance indicator is currently displayed, concurrently displaying the first result and the second performance indicator. In some examples, displaying the first result corresponding to the request includes in accordance with a determination that the second performance indicator is currently displayed, after performing the second task, displaying a second result corresponding to the second request.

Concurrently displaying a result and a performance indicator allows a user to simultaneous view a status of multiple tasks, thereby providing improved visual feedback.

In some examples, the input (e.g., 1305a, 1305d, 1305e, 1305f, 1305i, 1305j, 1305n, 1305r, 1305x, 1305ab, 1305ad) includes a request to activate a digital assistant of the computing device. In some examples, in response to the request to activate the digital assistant of the computing device, the computer system activates the digital assistant and displays an activation indicator indicating that the digital assistant has been activated. In some examples, upon activation of the digital assistant of the computer system, the computer system displays an activation indicator indicating that the digital assistant has been activated (i.e., is active). In some examples, displaying the activation indicator includes visually highlighting one or more aspects of a user interface.

Displaying an activation indicator provides improved visual feedback as to the activation state of a digital assistant (e.g., whether the digital assistant is activated). As a result, a user can readily observe the activation state of the digital assistant, allowing for more efficient and enhanced operation of the computing device.

In some examples, initiating performance of the task includes displaying a performance indicator corresponding to the task and translating the performance indicator from a first location of a display of the computing device to a second location of the display of the computing device, the second location different than the first location.

The operations described above with reference to FIG. 15 are optionally implemented by components depicted in FIGS. 1-4A, 6A-6B, 7A-7C, and FIGS. 13A-13AF. For example, the operations of process 1500 may be implemented by electronic device 1300 and, optionally, a digital assistant executing thereon. It would be clear to a person having ordinary skill in the art how other processes are implemented based on the components depicted in FIGS. 1-4A, 6A-6B, 7A-7C, and 13A-13AF.

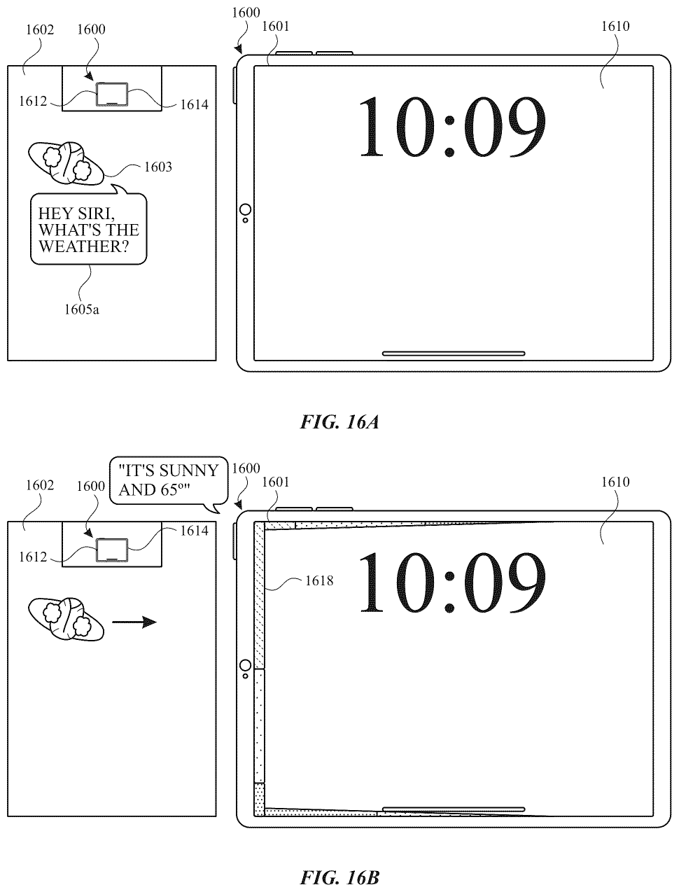

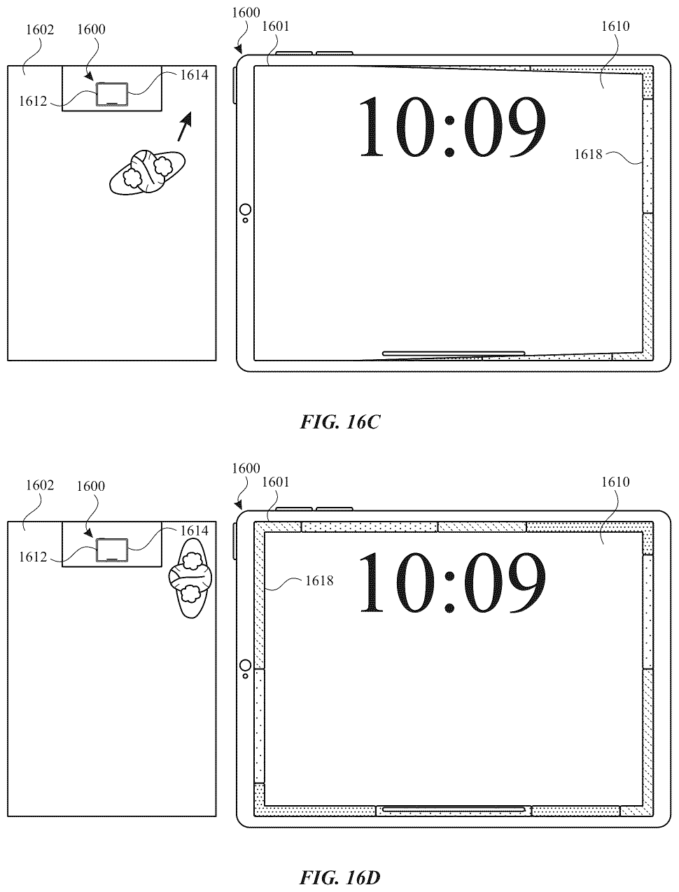

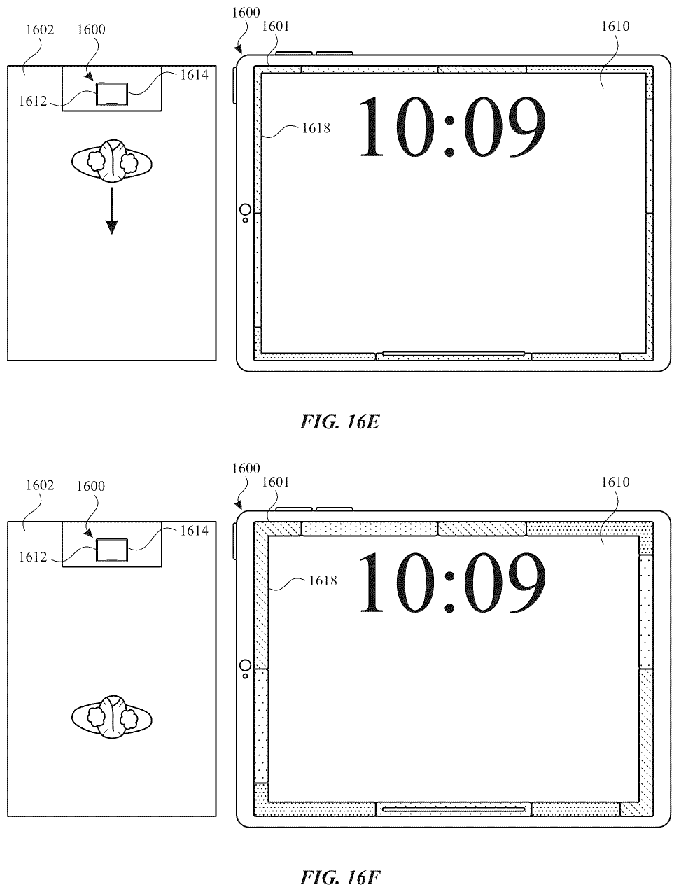

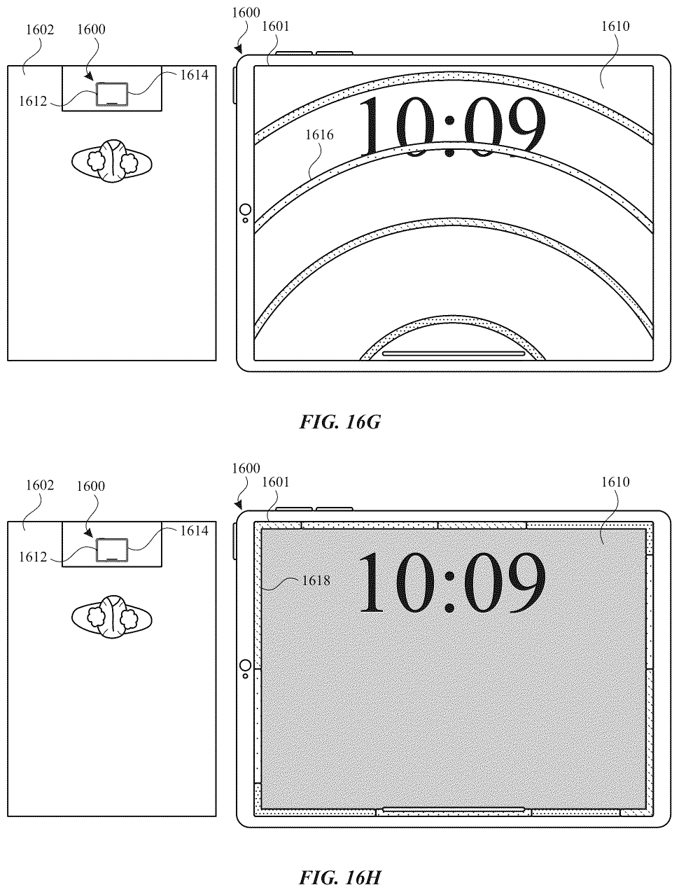

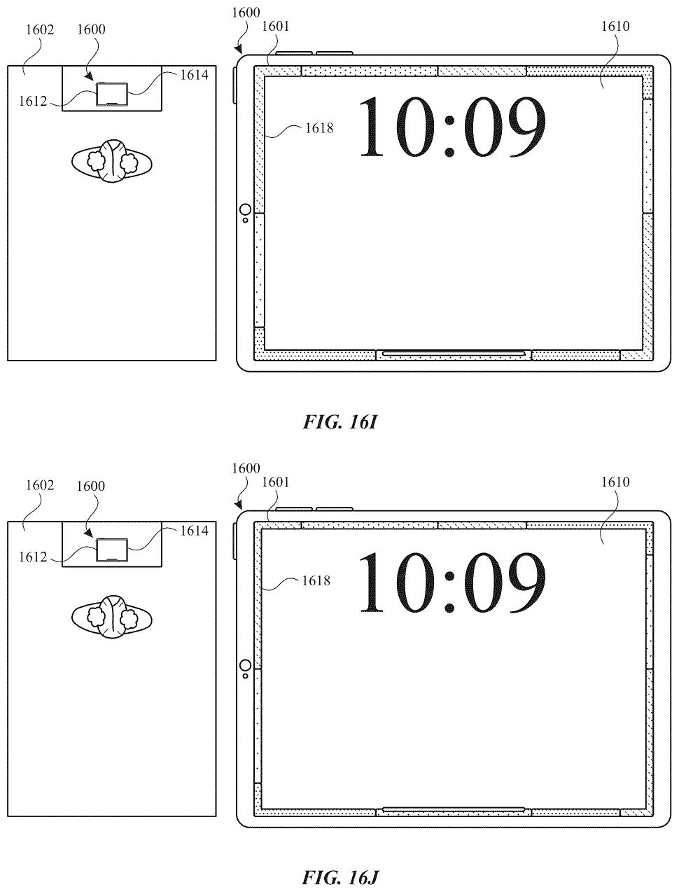

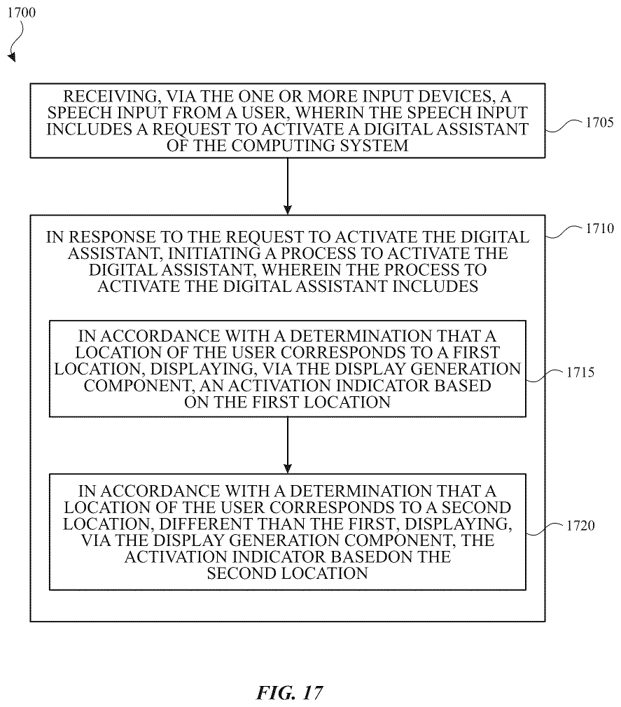

FIGS. 16A-16J illustrate exemplary user interfaces for managing a digital assistant, according to various examples. These figures are also used to illustrate processes described below, including process 1700 of FIG. 17.

FIG. 16A illustrates an electronic device 1600 (e.g., device 104, device 122, device 200, device 600, or device 700). In the non-limiting exemplary embodiment illustrated in FIGS. 16A-16J, electronic device 1600 is a smartphone. In other embodiments, electronic device 1600 can be a different type of electronic device, such as a wearable device (e.g., a smartwatch, headset), a laptop or desktop computer, a tablet, a smart speaker, and/or a set-top box. In some examples, electronic device 1600 has a display 1601, one or more input devices (e.g., a touchscreen of display 1601, a button, a microphone), and a wireless communication radio. In some examples, electronic device 1600 includes one or more forward facing and/or back facing cameras. In some examples, the electronic device includes one or more biometric sensors which, optionally, include a camera, such as an infrared camera, a thermographic camera, or a combination thereof.

FIG. 16A displays electronic device 1600 operating in environment 1602 including user 1603. In some examples, user 1603 is within a field-of-view of a camera of electronic device 1600 and as shown, is located near side 1612 of electronic device 1600.

In FIG. 16A, electronic device 1600 displays, on display 1601, user interface 1610 on display 1601 while a digital assistant of electronic device 1600 is deactivated (e.g., in an inactive state). In some examples, user interface 1610 is a home screen interface and/or a default interface displayed by device 1601 (e.g., an interface displayed while no application interfaces are actively displayed on electronic device 1600).

While displaying the user interface 1610 (and while the digital assistant of electronic device 1600 is deactivated), electronic device 1600 detects input 1605a. In some examples, input 1605a is a speech input (e.g., “Hey Siri, what's the weather?”), such as a natural-language speech input, including a digital assistant trigger (e.g., “Hey Siri”), and/or a requested task (e.g., retrieve the current weather forecast).

In some examples, the digital assistant of electronic device 1600 is activated in response to input 1605a (e.g., in response to the digital assistant trigger of input 1605a). With reference to FIG. 16B, for example, when activating the digital assistant, electronic device 1600 displays activation indicator 1618 indicating that the digital assistant of the electronic device 1600 has been activated (e.g., is in an active state). In some examples, displaying activation indicator 1618 includes highlighting (e.g., visually highlighting) at least a portion of user interface 1610. In some examples, highlighting a portion of user interface 1610 includes providing a glow effect on the portion of user interface 1610. In some examples, activation indicator 1618 is animated such that brightness and/or color of activation indicator 1618 fluctuates, flickers, and/or changes in size dynamically.

In some examples, electronic device 1600 displays activation indicator 1618 along at least a portion of the perimeter of display 1601. Because, in some examples, user interface 1610 is displayed on the entirety of display 1601, activation indicator 1618 can also be displayed along the perimeter of user interface 1610. In some examples, activation indicator 1618 is displayed along a portion of the perimeter of display 1601 and/or user interface 1610. In other examples, activation indicator 1618 is displayed along the entirety of the perimeter of display 1601 and/or application interface 1610.

In some examples, electronic device 1600 displays activation indicator 1618 based on a detected position of user 1603 in environment 1602. For example, as illustrated in FIG. 16B, electronic device 1600 may visually emphasize (e.g., enlarge, thicken, brighten, highlight, animate, change color) portions of activation indicator 1618 proximate user 1603 (e.g., portions proximate side 1612 of electronic device 1600) and, optionally, visually deemphasize (e.g., shrink, thin, dim, change color) portions of activation indicator 1618 further from user 1603 (e.g., portions proximate side 1614 of electronic device 1600).

In some examples, electronic device 1600 modifies display of activation indicator 1618 based on detected movement of user 1603. With reference to FIGS. 16B-16C, user 1603 may move from a position proximate a first side of electronic device 1600 (e.g., side 1612) to a position proximate a second side of electronic device 1600 (e.g., side 1614). In response, electronic device 1600 may adjust display of activation indicator 1618 to visually emphasize (e.g., enlarge, thicken, brighten, highlight, animate, change color) portions of activation indicator 1618 proximate side 1614 and visually deemphasize (e.g., shrink, thin, dim, change color) portions of activation indicator 1618 proximate side 1612. In some examples, electronic device 1600 detects movement of user 1603 within environment 1602 and modifies display of activation indicator 1618 in real-time. In other examples, electronic device 1600 modifies display of activation indicator 1618 each time user 1603 provides an input (e.g., speech input) to electronic device 1600.

In some examples, electronic device 1600 cannot detect a location of a user in environment 1602 and in response displays activation indicator 1618 in a default state. For example, with reference to FIG. 16D, user 1603 moves outside of the field-of-view of a camera of electronic device 1600 such that electronic device 1600 cannot determine a location of user 1603 in environment 1602. In response, electronic device 1600 displays activation indicator 1618 in a default state (e.g., according to a set of default criteria). In some examples, when displayed in a default state, activation indicator 1618 is uniformly displayed around the perimeter of display 1601 (e.g., displayed with a substantially consistent width).

In some examples, electronic device 1600 displays activation indicator 1618 based on a relative distance between electronic device 1600 and user 1603. As an example, electronic device 1600 can adjust brightness of display activation indicator 1618 based on a distance between electronic device 1600 and user 1603. Electronic device 1600 can, for instance, display activation indicator 1618 with a relatively high brightness when the distance between user 1603 and electronic device 1600 is determined to be relatively large and with a relatively low brightness when the distance between user 1603 and electronic device 1600 is determined to be relatively small. As another example, electronic device 1600 can adjust a size (e.g., width) of activation indicator 1618 based on based on a distance between electronic device 1600 and user 1603. As shown in FIG. 16E, for instance, user 1602 is a relatively small distance from electronic device 1600 and electronic device 1600 displays activation indicator 1618 at a relatively small size. In FIG. 16F, user 1602 has moved further away from electronic device 1600 and, in response to determining that user 1602 is a greater distance away, electronic device 1600 displays activation indicator 1618 at a relatively large size. In this manner, electronic device 1600 can ensure that activation indicator 1618 is visible by user 1603 at various distances.

In some examples, when activating the digital assistant of electronic device 1600 (prior to displaying activation indicator 1618), electronic device 1600 displays an input indicator 1616 indicating that electronic device 1600 is activating the digital assistant. As illustrated in FIG. 16G, for example, the input indicator 1616 is an animation, such as a “ripple” animation including a ripple effect, e.g., waves of light and/or distortion moving across the display (in this example from the bottom to top of the display). In some examples, input indicator 1616 is dynamically displayed. Each ripple of input indicator 1616 may for instance, shimmer (e.g., independently of other ripples) across a predefined spectrum of colors. In some examples, one or more ripples may be displayed such that the colors and/or brightness of one or more ripples is displayed according to a random noise function and, optionally, one or more smoothing filters and/or blur filters. While in FIG. 16G input indicator 1616 is shown as having three ripples, it will be appreciated that input indicator 1616 may include any number of ripples (e.g., one, five). In some examples, input indicator 1616 briefly modifies (e.g., distorts) display of one or more portions (e.g., objects) of user interface 1610 as input indicator 1616 traverses display 1601. As an example, one or more portions of user interface 1610 may be distorted (e.g., blurred, stretched in one or more directions, compressed in one or more directions) while input indicator 1616 is displayed. In some examples, this may include distorting portions of user interface 1610 that are proximate one or more ripples of input indicator 1616 as input indicator 1616 traverses across user interface 1610. In some examples, input indicator can originate from any portion of display 1601, and optionally, originate at a location based on a user position and/or user input (e.g., based on an angle of arrival determined using a voice input).

In some examples, activation indicator 1618 is overlaid on a portion of user interface 1610 and, optionally, is at least partially transparent such that the underlying portions of user interface 1610 remain visible to a user when activation indicator 1618 is displayed. In some examples, electronic device 1600 displays activation indicator 1618 without visually altering (e.g., changing and/or modifying) portions of the display of electronic device 1600 that are not included within the portion of the display that is highlighted as a result of displaying activation indicator 1618. In other examples, electronic device 1600 visual alters portions of the display of electronic device 1600 that are not included within the portion of the display that is highlighted as a result of displaying activation indicator 1618. As illustrated in FIG. 16H, in some examples, electronic device 1600 alters (e.g., reduces) the brightness of at least a portion of user interface 1610.

In some examples, electronic device 1600 maintains the digital assistant in an activated state after a requested task has been performed. In this manner, the digital assistant remains active such that subsequent requests can be performed more quickly. In some examples, while maintaining the digital assistant in the activated state, electronic device 1600 modifies display of activation indicator 1618 over a period of time. In some examples, electronic device 1600 gradually reduces a brightness of activation indicator 1618 over time. With reference to FIGS. 16I-J, in some examples, electronic device 1600 gradually reduces a size (e.g., thickness) of activation indicator 1618 over time. In some examples, electronic device 1600 modifies display of activation indicator 1618 until either a new request is provided to the digital assistant (at which time the initial size of activation indicator 1618 is optionally restored) or a threshold amount of time passes, and the digital assistant is deactivated.

While description has been made herein with respect to electronic device 1600 determining location of a user in environment 1602 using a camera of electronic device 1600, it will be appreciated that a location of a user may be determined in other ways. By way of example, user location may be determined using speech inputs (e.g., by determining angle of arrival of a speech input). In some examples, user location is determined using speech inputs alone. In other examples, user location is determined using speech inputs in combination with a camera and/or any other number of known spatial location techniques.

FIG. 17 is a flowchart of an exemplary method 1700 for managing a digital assistant, according to various examples. Process 1400 is performed, for example, using one or more computer systems (e.g., electronic devices, such as electronic device 1600) implementing a digital assistant. In some examples, process 1400 is performed using a client-server system (e.g., system 100), and the blocks of process 1400 are divided up in any manner between the server (e.g., DA server 106) and a client device. In other examples, the blocks of process 1400 are divided up between the server and multiple client devices (e.g., a mobile phone and a smart watch). Thus, while portions of process 1400 are described herein as being performed by particular devices of a client-server system, it will be appreciated that process 1400 is not so limited. In other examples, process 1400 is performed using only a client device (e.g., user device 104) or only multiple client devices. In process 1400, some blocks are, optionally, combined, the order of some blocks is, optionally, changed, and some blocks are, optionally, omitted. In some examples, additional steps may be performed in combination with the process 1400.

In some embodiments, the electronic device (e.g., 1600) is a computer system (e.g., a personal electronic device (e.g., a mobile device (e.g., iPhone), a headset (e.g., Vision Pro), a tablet computer (e.g., iPad), a smart watch (e.g., Apple Watch), a desktop (e.g., iMac), or a laptop (e.g., MacBook)) or a communal electronic device (e.g., a smart TV (e.g., AppleTV) or a smart speaker (e.g., HomePod))). The computer system is optionally in communication (e.g., wired communication, wireless communication) with a display generation component (e.g., an integrated display and/or a display controller) and with one or more input devices (e.g., a touch-sensitive surface (e.g., a touchscreen), a mouse, and/or a keyboard). The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

The operations described above with reference to FIG. 17 are optionally implemented by components depicted in FIGS. 1-4A, 6A-6B, 7A-7C, and FIGS. 16A-16J. For example, the operations of process 1700 may be implemented by electronic device 1600 and, optionally, a digital assistant executing thereon. It would be clear to a person having ordinary skill in the art how other processes are implemented based on the components depicted in FIGS. 1-4A, 6A-6B, 7A-7C, and 16A-16J.

The computer system (e.g., 1600) receives (1705), via the one or more input devices, a speech input (e.g., 1605a) (e.g., natural-language input) from a user (e.g., 1603). In some examples, the speech input includes a request to activate a digital assistant of the computing system. In some examples, the computing system receives an input from a user. In some examples, the input is a touch input, such as a single tap, a double tap, or a long press (e.g., a press exceeding a threshold amount of time). In some examples, the input is a natural-language input, such as a speech input. In some examples, the input includes a request to activate a digital assistant of the computing system.

In response to the request to activate the digital assistant, the computer system initiates (1710) a process to activate the digital assistant. In some examples, the process to activate the digital assistant includes, in accordance with a determination that a location of the user corresponds to a first location (e.g., a location near side 1612) (e.g., a location of input relative to the computing system), displaying (1715), via the display generation component, an activation indicator (e.g., 1618) (e.g., an edge light animation) based on the first location.

In some examples, the computing system determines a location of a user providing inputs to the computing system. In some examples, the location is determined using one or more input devices of the computing system, including but not limited to a set of cameras and/or a set of microphones.

In some examples, when activating the digital assistant of the computing system, the computing system displays an activation indicator indicating that the digital assistant has been activated (i.e., is active). In some examples, displaying the activation indicator includes visually highlighting one or more aspects of a user interface displayed by the computing system. In some examples, displaying the activation indicator includes displaying the activation indicator at one or more edges of a display of (or a display in communication with) the computing system. In some examples, the activation indicator is displayed at each edge of the display. In some examples, the activation indicator is displayed at a subset of the edges of the display. In some examples, one or more characteristics of the activation indicator is based on an environment of the computing device; by way of example, a brightness of the activation indicator can be based on an intensity of ambient light detected by the computing device.

In some examples, the computing system displays the activation indicator based on a determined location of a user; by way of example, the computing system can visually emphasize one or more portions of the activation indicator and, optionally, visually deemphasize one or more portions of the activation indicator. In some examples, visually emphasizing the activation indicator includes increasing brightness, saturation, an HDR value, and/or size (e.g., thickness) of one or more portions (or the entirety of) the activation indicator, and visually deemphasizing the activation indicator includes decreasing brightness, saturation, an HDR value, and/or size of one or more portions (or the entirety of) the activation indicator. In some examples, display of the activation indicator is adjusted based on a distance of a user to the computing system. In some examples, the activation indicator is displayed at a progressively greater scale and/or brightness as the determined distance of the user to the computing system increases. In some examples, the scale and/or brightness of the activation indicator changes dynamically as the user moves relative to the computing system. In some examples, the scale and/or brightness of the activation indicator is static. In this manner, the computing system can signal to a user that the computing system has recognized the location of the user and that the digital assistant of the computing system has been successfully activated. In some examples, once the digital assistant has been activated, the digital assistant remains active for the entirety of a digital assistant session with a user; the session may span, for instance, any number of conjunctive and/or successive interactions (e.g., requests, responses) between a user of the computing system and the digital assistant. In some examples, the activation indicator is displayed for the entirety of the session.

In some examples, the process to activate the digital assistant includes, in accordance with a determination that a location of the user corresponds to a second location (e.g., a location near side 1614) different than the first, displaying (1720), via the display generation component, the activation indicator (e.g., an edge light animation) based on the second location.

In some examples, the computing system displays the activation indicator based on a determined location of a user; by way of example, the computing system can visually emphasize one or more portions of the activation indicator and, optionally, visually deemphasize one or more portions of the activation indicator. In some examples, visually emphasizing the activation indicator includes increasing brightness, saturation, an HDR value, and/or size (e.g., thickness) of one or more portions (or the entirety of) the activation indicator, and visually deemphasizing the activation indicator includes decreasing brightness, saturation, an HDR value, and/or size of one or more portions (or the entirety of) the activation indicator. In some examples, display of the activation indicator is adjusted based on a distance of a user to the computing system. In some examples, the activation indicator is displayed at a progressively greater scale and/or brightness as the determined distance of the user to the computing system increases. In some examples, the scale and/or brightness of the activation indicator changes dynamically as the user moves relative to the computing system. In some examples, the scale and/or brightness of the activation indicator is static.

Displaying an activation indicator based, at least in part, on the location of a user provides improved visual feedback as to both the activation state of a digital assistant (e.g., whether the digital assistant is activated) and that the location of a user is properly recognized. As a result, a user can readily observe the activation state of the digital assistant, allowing for more efficient and enhanced operation of the computing device. In this manner, operation is faster and more reliable, which additionally reduces power usage and improves battery life of the device by enabling the user to use the device more quickly and efficiently.

In some examples, the process to activate the digital assistant includes determining, via the one or more input devices, the location of the user. In some examples, the computing system determines a location of a user providing inputs to the computing system. In some examples, the location is determined using one or more input devices of the computing system, including but not limited to a set of cameras and/or a set of microphones.

In some examples, determining the location of the user includes determining the location of the user based on the speech input. In some examples, the user provides a speech input, such as a natural-language speech input. In some examples, when receiving the speech input, the computing system determines a location of the user. In some examples, the location is a location of the user relative to the computing system (e.g., distance and/or direction of the user relative to the computing system). In some examples, the voice input includes a trigger word or trigger phrase that constitutes a request to activate the digital assistant such that, when detected by the comping system, causes the computing system to activate the digital assistant of the computing system.

In some examples, the one or more input devices includes a camera and determining the location of the user includes detecting, via the camera, a position (e.g., location) of the user in a field of view of the camera; and determining the location of the user based on the position of the user in the field of view of the camera. In some examples, one or more input devices of the computing system is a camera having a field of view. In some examples, the computing system detects users in the field of view of the camera and identifies respective locations of the detected users.

In some examples, the computing system determines a location of a user based on each of (1) a speech input provided by the user and (2) a location of the user in the field of view of a camera of the computing system. In some examples, locations indicated by each of these signals may conflict; that is, the location determined based on the speech input may be a first location and the location determined using the field of view of the camera may be a second location different than the first location. In some examples, if the locations are different, the computing system may bias toward one signal. In some examples, the location determined based on the speech input supersedes. In some examples, the location determined based on the field of view of the camera supersedes. In some examples, which signal supersedes is determined based on a context of the computing system; by way of example, locations determined based on the field of view of the camera may supersede so long as lighting conditions of the computing system's environment satisfy a set of criteria.

In some examples, detecting a position of the user in a field of view of the camera includes determining a position of a head of the user (e.g., 1603) in the field of view of the camera. In some examples, the computing system detects the location of a user's head using the camera of the computing system. In some examples, detecting the location of the user's head includes detecting a face of the user and/or one or more other identifiable characteristics of the user's head. In some examples, detecting the location of a user's head includes detecting a face of the user and that a user is looking in the direction of the computing system (e.g., as indicated by a direction of the user's gaze); additionally or alternatively, In some examples, the computing system detects a torso of the user in the field of view of the camera.

In some examples, displaying the activation indicator (e.g., 1618) based on the first location includes displaying the activation indicator based on a distance between the first location (e.g., a location of user 1603) and the computing system (e.g., 1600). In some examples, when determining a location of the user, the computing system determines a distance between the location of the user and the computing system. In some examples, the computing system displays the activation indicator based on the determined distance. In some examples, the further the user is from the computing device, the greater the size at which the activation indicator is displayed. In some examples, the further the user is from the computing device, the brighter at which the activation indicator is displayed.

Displaying an activation indicator based, at least in part, on a distance between an electronic device and a user provides improved visual feedback in that the user can recognize the activation state of a digital assistant at various distances. As a result, a user can readily observe the activation state of the digital assistant, allowing for more efficient and enhanced operation of the computing device. In this manner, operation is faster and more reliable, which additionally reduces power usage and improves battery life of the device by enabling the user to use the device more quickly and efficiently.

In some examples, displaying the activation indicator based on a distance between the first location and the computing system includes in accordance with a determination that the distance between the first location and the computing system is a distance having a first magnitude, displaying the activation indicator at a first size and, in accordance with a determination that the distance between the first location and the computing system is a distance having a second magnitude larger than the first magnitude, displaying the activation indicator at a second size larger than the first size. In some examples, the computing system displays the activation indicator based on the determined distance. In some examples, the further the user is from the computing device, the greater the size at which the activation indicator is displayed.

In some examples, the process to activate the digital assistant includes in accordance with a determination that a location of the user does not correspond to the first location or the second location (e.g., the device cannot determine a location of the user), displaying, via the display generation component, the activation indicator (e.g., an edge light animation) according to a set of default criteria.

Displaying an activation indicator according to a set of default criteria when no user is recognized allows for a user to readily observe the activation state of the digital assistant even when a location of the user is not determined by a device. This in turn allows for more efficient and enhanced operation of the computing device. In this manner, operation is faster and more reliable, which additionally reduces power usage and improves battery life of the device by enabling the user to use the device more quickly and efficiently.

In some examples, the computing system is unable to determine a location of a user providing an input (e.g., the user is not identified in the field of view of a camera of the computing system and/or the angle of arrival of the input cannot be determined by the computing system). In some examples, when the computing system is unable to determine a location of the user, the computing system displays the activation indicator in a default state (i.e., according to a set of default criteria). In some examples, displaying the activation indicator in a default state includes displaying the activation indicator at a predetermined size, brightness, HDR value, and/or saturation. In some examples, displaying the activation indicator in a default state includes displaying the activation indicator such that no portions of the activation indicator are visually emphasized (e.g., each side of the activation indicator has a same width).

In some examples, the process to activate the digital assistant includes, prior to displaying the activation indicator, displaying an input indicator based on the location of the user. In some examples, displaying, via the display generation component, the input indicator includes initially displaying the input indicator at a third location (e.g., a location near side 1612). In some examples, displaying, via the display generation component, the activation indicator includes initially displaying the activation indicator at the third location. In some examples, activating the digital assistant includes displaying an input indicator indicating that an input for activating the digital assistant has been received (e.g., detected) by the computing system. In some examples, the computing system displays the input indicator in a manner based on a type and/or location of an input for activating the digital assistant. In some examples, the input for activating the digital assistant is detected at a location corresponding to a display of the computing system, and the input indicator is displayed based on the detected location. In some examples, the input for activating the digital assistant is a voice input (e.g., speech input), and the input indicator is displayed based on the voice input (e.g., auditory characteristics of the voice input).

In some examples, the input indicator has a directionality; by way of example, display of the input indicator may include displaying, via the display generation component, a ripple animation that is translated across a display of (or a display in communication with) the computing system. In some examples, the ripple moves away from an input (and, optionally radially expands by virtue of being a ripple); for example, if the input is a touch input, the ripple moves in a direction away from a location of the touch input (e.g., if a touch input is detected near a bottom of a display, the ripple animation moves toward a top of the display); as another example, if the input is a press of a button, the ripple moves in a direction away from a location of the button, as yet another example, if the input is a voice input, the ripple moves away from a particular edge of the computing system (e.g., an edge at which a microphone is located) and/or moves away from a perceived direction from which the voice input was received. In some examples, the computing system initiates display of the input indicator at a particular location and after initiating (or completing) display of the input indicator, the computing system initiates display of the activation indicator at substantially the same location.

In some examples, displaying the activation indicator includes visually emphasizing (e.g., brightening, enlarging) a first portion of the activation indicator, wherein the first portion of the activation indicator is a first distance from the user. In some examples, displaying the activation indicator includes visually deemphasizing (e.g., dimming, shrinking) a second portion of the activation indicator different than the first portion, wherein the second portion of the activation indicator is a second distance from the user, the second distance greater than the first distance.

In some examples, the computing system modifies display of the activation indicator based on the location of the user relative to the computing system; as an example, the computing system can visually emphasize one or more portions of the activation indicator and, optionally, visually deemphasize one or more portions of the activation indicator. In some examples, visually emphasizing the activation indicator includes increasing brightness, saturation, an HDR value, and/or size (e.g., thickness) of the activation indicator, and visually deemphasizing the activation indicator includes decreasing brightness, saturation, an HDR value, and/or size of the activation indicator. In this manner, the computing system “weights” the activation indicator toward the user to indicate that the digital assistant is activated and ready to receive user inputs.

In some examples, the computing system visually emphasizes one or more portions of the activation indicator relatively close to a user and, optionally, visually deemphasizes one or more portions of the activation indicator relatively far from the user.

In some examples, displaying the activation indicator includes displaying (e.g., overlaying) the activation indicator over a first portion of a user interface and dimming a second portion of the user interface different than the first portion.

Dimming a portion of a user interface while displaying an activation indicator allows for a user to readily observe the activation state of the digital assistant allowing for more efficient and enhanced operation of the computing device. In this manner, operation is faster and more reliable, which additionally reduces power usage and improves battery life of the device by enabling the user to use the device more quickly and efficiently.

In some examples, after performing the process to activate the digital assistant, the computing system receives, from the user, a request to perform a task. In some examples, the computing system initiates performance of the task. In some examples, after the task has been performed, the computing system maintains the digital assistant in an activated state. In some examples, the digital assistant of the computing system is activated, and thereafter the computing system receives a request from the user to perform a task. In some examples, after performing the task, the computing system maintains the digital assistant in the activated state such that the digital assistant can receive further inputs and/or requests from the user without the need to reactivate the digital assistant.

In some examples, maintaining the digital assistant in an activated state includes, prior to receiving a second speech input, adjusting display (e.g., dimming) of the activation indicator according to a predetermined function. In some examples, while the computing system maintains the digital assistant in the activated state, the computing system determines the amount of time in which the digital assistant has been activated. In some examples, if a threshold amount of time has been reached, the computing system can transition the digital assistant to a deactivated state and/or terminate an ongoing digital assistant session. In some examples, while the digital assistant is activated (and while the digital assistant is waiting for user input), the computing system adjusted display of the activation indicator. In some examples, the computing system gradually dims the activation indicator according to a function, such as a decay function. In some examples, additionally or alternatively, the computing system adjusts (e.g., reduces) the size of the activation indicator according to the function.

In some examples, the one or more input devices includes a second camera. In some examples, the computing system determines, via the second camera, whether one or more users are gazing at the computing system. In some examples, in accordance with a determination that one or more users are gazing at the computing system, the computing system displays a gaze indicator. In some examples, the computing system determines whether one or more users in a field of view of a camera are gazing toward the computing system (e.g., whether a gaze of one or more users is determined to be directionally oriented toward the computing system). In some examples, when determining that one or more users are gazing at the computing system, the computing system displays a gaze indicator indicating that the computing system has recognized at least one user as currently gazing at the computing system.

The operations described above with reference to FIG. 17 are optionally implemented by components depicted in FIGS. 1-4A, 6A-6B, 7A-7C, and FIGS. 16A-16J. For example, the operations of process 1700 may be implemented by electronic device 1600 and, optionally, a digital assistant executing thereon. It would be clear to a person having ordinary skill in the art how other processes are implemented based on the components depicted in FIGS. 1-4A, 6A-6B, 7A-7C, and 16A-16J.

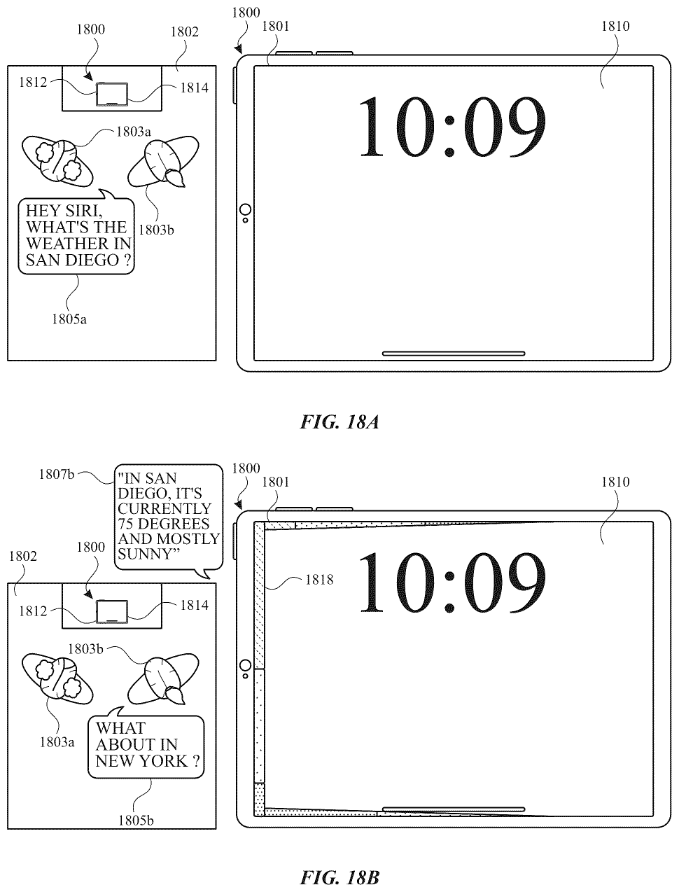

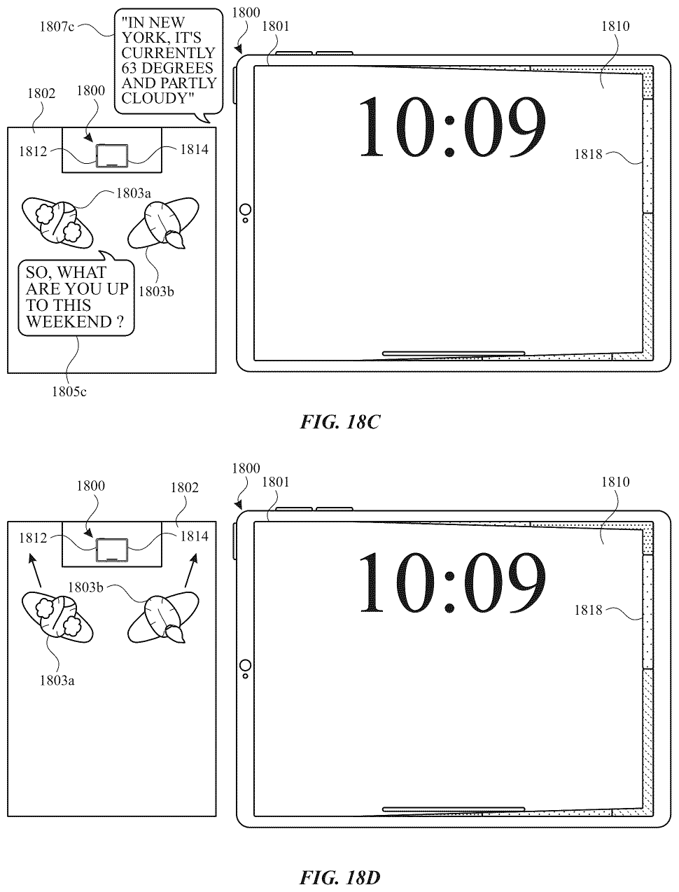

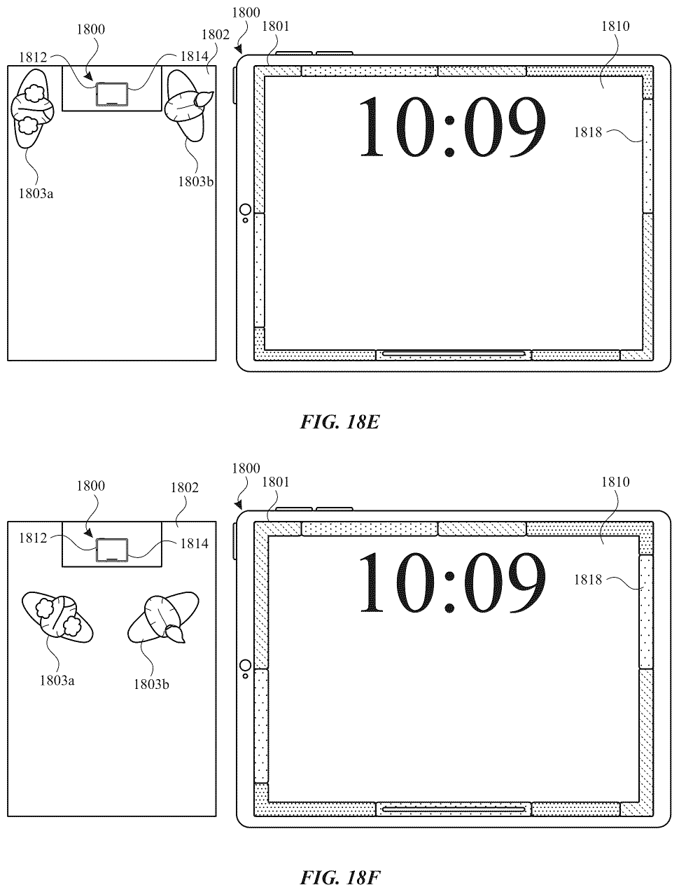

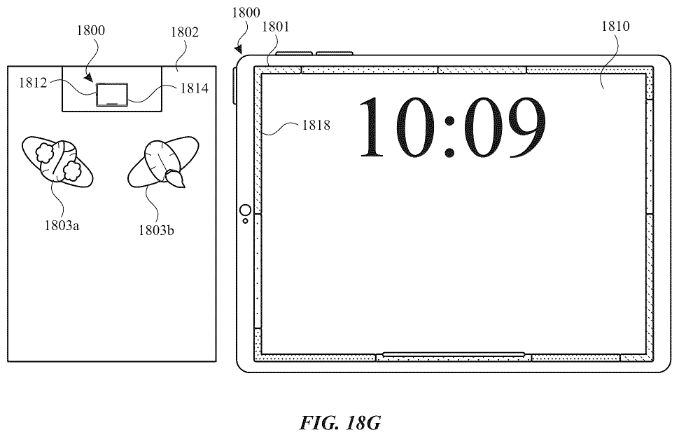

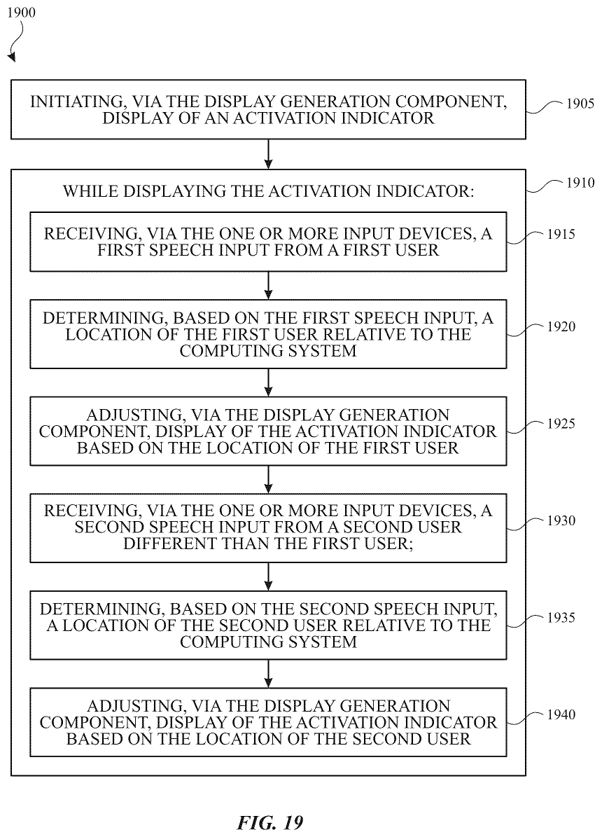

FIGS. 18A-18G illustrate exemplary user interfaces for managing a digital assistant, according to various examples. These figures are also used to illustrate processes described below, including process 1900 of FIG. 19.

FIG. 18A illustrates an electronic device 1800 (e.g., device 104, device 122, device 200, device 600, or device 700). In the non-limiting exemplary embodiment illustrated in FIGS. 18A-18G, electronic device 1800 is a smartphone. In other embodiments, electronic device 1800 can be a different type of electronic device, such as a wearable device (e.g., a smartwatch, headset), a laptop or desktop computer, a tablet, a smart speaker, and/or a set-top box. In some examples, electronic device 1600 has a display 1801, one or more input devices (e.g., a touchscreen of display 1801, a button, a microphone), and a wireless communication radio. In some examples, electronic device 1800 includes one or more forward facing and/or back facing cameras. In some examples, the electronic device includes one or more biometric sensors which, optionally, include a camera, such as an infrared camera, a thermographic camera, or a combination thereof.

FIG. 18A displays electronic device 1800 operating in environment 1802 including user 1803a and user 1803b. In some examples, users 1803a, 1803b are visible within a field-of-view of a camera of electronic device 1800. As shown, user 1803a may be located near side 1812 of the electronic device 1800 and user 1803b may be located near side 1814 of electronic device 1800.

In some examples, during operation, electronic device 1800 determines a location of users 1803a, 1803b. Locations of users can, for instance, be determined using any number of input devices, including but not limited to one or more cameras or microphones of electronic device 1800. For example, electronic device 1800 can determine locations of users positioned within the field-of-view of a camera of electronic device 1800 and/or natural-language speech (e.g., conversational speech, speech directed to electronic device 1800) provided by users 1803.

In FIG. 18A, electronic device 1800 displays, on display 1801, user interface 1810 on display 1801 while a digital assistant of electronic device 1600 is deactivated (e.g., in an inactive state). In some examples, user interface 1810 is a home screen interface and/or a default interface displayed by device 1801 (e.g., an interface displayed while no applications are actively displayed on electronic device 1800).

While displaying user interface 1810 (and while the digital assistant of electronic device 1800 is deactivated), electronic device 1800 detects input 1805a provided by user 1803a. In some examples, input 1805a is a speech input (e.g., “Hey Siri, what's the weather in San Diego?”), such as a natural-language speech including a digital assistant trigger (e.g., “Hey Siri”), and/or a requested task (e.g., retrieve the current weather forecast for San Diego, CA).

In some examples, electronic device 1800 activates he digital assistant of electronic device 1800 in response to input 1805a (e.g., in response to the digital assistant trigger of input 1805a). With reference to FIG. 18B, for example, when activating the digital assistant, electronic device 1800 displays activation indicator 1818 indicating that the digital assistant of the electronic device 1800 has been activated (e.g., is in an active state). In some examples, displaying activation indicator 1818 includes highlighting (e.g., visually highlighting) at least a portion of user interface 1810. In some examples, highlighting a portion of user interface 1810 includes providing a glow effect on the portion of user interface 1810. In some examples, activation indicator 1818 is animated such that brightness and/or color of activation indicator 1818 fluctuates, flickers, and/or changes in size dynamically.

In some examples, electronic device 1800 displays activation indicator 1618 along at least a portion of the perimeter of display 1801. Because, in some examples, user interface 1810 is displayed on the entirety of display 1801, activation indicator 1618 can also be displayed along the perimeter of user interface 1810. In some examples, activation indicator 1818 is displayed along a portion of the perimeter of display 1801 and/or user interface 1810. In other examples, activation indicator 1818 is displayed along the entirety of the perimeter of display 1801 and/or application interface 1810.

In some examples, electronic device 1800 displays activation indicator 1818 based on a detected position of one or more users 1803 in environment 1802. For example, as illustrated in FIG. 18B, electronic device 1800 may determine that input 1805a is provided by user 1803a (or that the input came from a direction corresponding to the location of user 1803a) and visually emphasize (e.g., enlarge, thicken, brighten, highlight, animate, change color) portions of activation indicator 1818 proximate user 1803a (e.g., portions proximate side 1812 of electronic device 1800). In some examples, electronic device 1800 can optionally, visually deemphasize (e.g., shrink, thin, dim, change color) portions of activation indicator 1818 further from user 1803a (e.g., portions proximate side 1814 of electronic device 1800).

In some examples, electronic device 1800 can modify display of activation indicator 1818 as additional inputs are received from users of environment 1802. In FIG. 18B, electronic device 1800 responds to input 1805a via output 1807b (“In San Diego, it's currently 75 degrees and mostly sunny.”) and thereafter receives input 1805b (“What about in New York?”) from user 1803b. As shown in FIG. 18C, electronic device 1800 may determine that input 1805b is provided by user 1803b (or that the input came from a direction corresponding to the location of user 1803b) and visually emphasize (e.g., enlarge, thicken, brighten, highlight, animate, change color) portions of activation indicator 1818 proximate user 1803b (e.g., portions proximate side 1814 of electronic device 1800). In some examples, electronic device 1800 can optionally, visually deemphasize (e.g., shrink, thin, dim, change color) portions of activation indicator 1818 further from user 1803b (e.g., portions proximate side 1812 of electronic device 1800).

In some examples, electronic device 1800 determines whether natural-language speech of users in environment 1802 is intended as input for electronic device 1800. If natural-language speech is intended as input for electronic device 1800 (e.g., the natural-language speech is determined to include a request for the digital assistant of electronic device 1800), electronic device 1800 can adjust display of activation indicator 1818, as described. If the speech input is not intended as input for electronic device 1800 (e.g., the speech input is determined to be conversational speech between multiple users), electronic device 1800 can forgo adjusting display of activation indicator 1818. For example, as shown in FIG. 18C, user 1803a provides natural-language speech 1805c (“So, what are you up to this weekend?”). Thereafter, electronic device 1800 determines natural-language speech 1805c is not intended as input for electronic device 1818 and forgoes adjusting display of activation indicator 1818 (e.g., forgoes visually emphasizing portions of activation indicator 1818 proximate user 1803a), as shown in FIG. 18D.

In some examples, electronic device 1800 maintains the digital assistant in an activated state after a requested task has been performed. In this manner, the digital assistant remains active such that subsequent requests can be performed more quickly. In some examples, while maintaining the digital assistant in the activated state, electronic device 1800 modifies display of activation indicator 1818 over a period of time. With reference to FIGS. 18F-18G, in some examples, electronic device 1800 gradually reduces a size (e.g., thickness) of activation indicator 1818 over time. In some examples, electronic device 1600 reduces the size of activation indicator 1818 until either a new request is provided to the digital assistant (at which time the initial size of activation indicator 1818 is optionally restored) or a threshold amount of time passes and the digital assistant is deactivated.

FIG. 19 is a flowchart of an exemplary method 1900 for managing a digital assistant, according to various examples. Process 1900 is performed, for example, using one or more computer systems (e.g., electronic devices, such as electronic device 1800) implementing a digital assistant. In some examples, process 1900 is performed using a client-server system (e.g., system 100), and the blocks of process 1900 are divided up in any manner between the server (e.g., DA server 106) and a client device. In other examples, the blocks of process 1900 are divided up between the server and multiple client devices (e.g., a mobile phone and a smart watch). Thus, while portions of process 1900 are described herein as being performed by particular devices of a client-server system, it will be appreciated that process 1900 is not so limited. In other examples, process 1900 is performed using only a client device (e.g., user device 104) or only multiple client devices. In process 1900, some blocks are, optionally, combined, the order of some blocks is, optionally, changed, and some blocks are, optionally, omitted. In some examples, additional steps may be performed in combination with the process 1900.

In some embodiments, the electronic device (e.g., 1800) is a computer system (e.g., a personal electronic device (e.g., a mobile device (e.g., iPhone), a headset (e.g., Vision Pro), a tablet computer (e.g., iPad), a smart watch (e.g., Apple Watch), a desktop (e.g., iMac), or a laptop (e.g., MacBook)) or a communal electronic device (e.g., a smart TV (e.g., AppleTV) or a smart speaker (e.g., HomePod))). The computer system is optionally in communication (e.g., wired communication, wireless communication) with a display generation component (e.g., an integrated display and/or a display controller) and with one or more input devices (e.g., a touch-sensitive surface (e.g., a touchscreen), a mouse, and/or a keyboard). The display generation component is configured to provide visual output, such as display via a CRT display, display via an LED display, or display via image projection. In some embodiments, the display generation component is integrated with the computer system. In some embodiments, the display generation component is separate from the computer system. The one or more input devices are configured to receive input, such as a touch-sensitive surface receiving user input. In some embodiments, the one or more input devices are integrated with the computer system. In some embodiments, the one or more input devices are separate from the computer system. Thus, the computer system can transmit, via a wired or wireless connection, data (e.g., image data or video data) to an integrated or external display generation component to visually produce the content (e.g., using a display device) and can receive, a wired or wireless connection, input from the one or more input devices.

The computing system (e.g., 1600) initiates (1905), via the display generation component, display of an activation indicator (e.g., 1818). In some examples, the computing system displays an activation indicator, for instance, indicating that the digital assistant has been activated (i.e., is active). In some examples, displaying the activation indicator includes visually highlighting one or more aspects of a user interface displayed by the computing system. In some examples, displaying the activation indicator includes displaying the activation indicator at one or more edges of a display of (or a display in communication with) the computing system. In some examples, the activation indicator is displayed at each edge of the display. In some examples, the activation indicator is displayed at a subset of the edges of the display. In some examples, one or more characteristics of the activation indicator is based on an environment of the computing device; by way of example, a brightness of the activation indicator can be based on an intensity of ambient light detected by the computing device.

While displaying (1910) the activation indicator, the computing system receives (1915), via the one or more input devices, a first speech input (e.g., 1805a) from a first user (e.g., 1803a).

While displaying (1910) the activation indicator, the computing system determines (1920), based on the first speech input, a location of the first user relative to the computing system (e.g., a location near side 1812). In some examples, the computing system determines a location of a user providing inputs to the computing system. In some examples, the location is determined using one or more input devices of the computing system, including but not limited to a set of cameras and/or a set of microphones.

While displaying (1910) the activation indicator, the computing system adjusts (1925), via the display generation component, display of the activation indicator based on the location of the first user. In some examples, the computing system displays (or adjusts display of) the activation indicator based on a determined location of a user; by way of example, the computing system can visually emphasize one or more portions of the activation indicator and, optionally, visually deemphasize one or more portions of the activation indicator. In some examples, visually emphasizing the activation indicator includes increasing brightness, saturation, an HDR value, and/or size (e.g., thickness) of one or more portions (or the entirety of) the activation indicator, and visually deemphasizing the activation indicator includes decreasing brightness, saturation, an HDR value, and/or size of one or more portions (or the entirety of) the activation indicator. In some examples, display of the activation indicator is adjusted based on a distance of a user to the computing system. In some examples, the activation indicator is displayed at a progressively greater scale and/or brightness as the determined distance of the user to the computing system increases. In some examples, the scale and/or brightness of the activation indicator changes dynamically as the user moves relative to the computing system. In some examples, the scale and/or brightness of the activation indicator is static.

In some examples, once the digital assistant has been activated, the digital assistant remains active for the entirety of a digital assistant session with a user; the session may span, for instance, any number of conjunctive and/or successive interactions (e.g., requests, responses) between a user, or multiple users, of the computing system and the digital assistant. In some examples, the activation indicator is displayed for the entirety of the session.

While displaying (1910) the activation indicator, the computing system receives (1930), via the one or more input devices, a second speech input (e.g., 1805b) from a second user (e.g., 1803b) different than the first user. In some examples, the computing system receives inputs (e.g., speech inputs) while operating in a multi-user environment (e.g., a room with multiple users). In some examples, the computing system is configured to recognize and/or operate according to any number of users based on received inputs.

While displaying (1910) the activation indicator, the computing system determines (1935), based on the second speech input, a location of the second user relative to the computing system (e.g., a location near side 1814). In some examples, the computing system determines a location of a user providing inputs to the computing system. In some examples, the location is determined using one or more input devices of the computing system, including but not limited to a set of cameras and/or a set of microphones.

While displaying (1910) the activation indicator, the computing system adjusts (1940), via the display generation component, display of the activation indicator based on the location of the second user. In some examples, the computing system displays (or adjusts display of) the activation indicator based on a determined location of a user; by way of example, the computing system can visually emphasize one or more portions of the activation indicator and, optionally, visually deemphasize one or more portions of the activation indicator. In some examples, after displaying (or adjusting display of) the activation indicator in response to an input from a first user, the computing system can adjust display of the activation indicator in response to a subsequent input received from a second user. In some examples, adjusting display in this manner includes visually emphasizing one or more portions of the activation indicator and, optionally, visually deemphasizing one or more portions of the activation indicator. In some examples, visually emphasizing the activation indicator includes increasing brightness, saturation, an HDR value, and/or size (e.g., thickness) of one or more portions (or the entirety of) the activation indicator, and visually deemphasizing the activation indicator includes decreasing brightness, saturation, an HDR value, and/or size of one or more portions (or the entirety of) the activation indicator. In some examples, display of the activation indicator is adjusted based on a distance of a user to the computing system.

Displaying an activation indicator based, at least in part, on the location of a plurality of users provides improved visual feedback as to both the activation state of a digital assistant (e.g., whether the digital assistant is activated) and that the location of a currently speaking user is properly recognized. As a result, users can readily observe the activation state of the digital assistant, allowing for more efficient and enhanced operation of the computing device. In this manner, operation is faster and more reliable, which additionally reduces power usage and improves battery life of the device by enabling the user to use the device more quickly and efficiently.

In some examples, adjusting display of the activation indicator based on the location of the first user includes visually emphasizing a first portion of the activation indicator and visually deemphasizing a second portion of the activation indicator different than the first portion. In some examples, the computing system displays (or adjusts display of) the activation indicator based on a determined location of a user; by way of example, the computing system can visually emphasize one or more portions of the activation indicator and, optionally, visually deemphasize one or more portions of the activation indicator. In some examples, after displaying (or adjusting display of) the activation indicator (e.g., in response to an input from a first user), the computing system can adjust display of the activation indicator in response to a subsequent input received from a different user.

In some examples, the computing device receives, via the one or more input devices, a third speech input from a third user (e.g., 1803a). In some examples, in accordance with a determination that a location of the third user is determined based on the third speech input, the computing system adjust, via the display generation component, display of the activation indicator based on the location of the third user. In some examples, in accordance with a determination that the location of the third user is not determined based on the third speech input, the computing system adjusts, via the display generation component, display of the activation indicator according to a set of default criteria. In some examples, the computing system is unable to determine a location of a user providing an input (e.g., the user is not identified in the field of view of a camera of the computing system and/or the angle of arrival of a speech input cannot be determined by the computing system). In some examples, when the computing system is unable to determine a location of the user, the computing system displays the activation indicator in a default state (i.e., according to a set of default criteria). In some examples, displaying the activation indicator in a default state includes displaying the activation indicator at a predetermined size, brightness, HDR value, and/or saturation. In some examples, displaying the activation indicator in a default state includes displaying the activation indicator such that no portions of the activation indicator are visually emphasized (e.g., each side of the activation indicator has a same width).

Selectively adjusting display of an activation indicator provides improved visual feedback as to the activation state of a digital assistant (e.g., activated in a voice mode) and further indicates that the device recognizes whether speech input is intended for a digital assistant of the device.

In some examples, adjusting display of the activation indicator based on the location of the first user includes adjusting display of the activation indicator based on a distance between the user and the computing system. In some examples, display of the activation indicator is adjusted based on a distance of a user to the computing system. In some examples, the activation indicator is displayed at a progressively greater scale and/or brightness as the determined distance of the user to the computing system increases. In some examples, the scale and/or brightness of the activation indicator changes dynamically as the user moves relative to the computing system. In some examples, the scale and/or brightness of the activation indicator is static.

In some examples, the computing system receives a fourth speech input (e.g., 1805c). In some examples, the computing system determines whether the fourth speech input includes a request for a digital assistant of the computing system. In some examples, in accordance with a determination that the fourth speech input does not include a request directed to (e.g., intended for) a digital assistant of the computing system, the computing system forgoes adjusting display of the activation indicator. In some examples, while a digital assistant of the computing system receives is activated, the computing system receives inputs that are directed to the digital assistant. In some examples, such inputs include requests for the digital assistant to perform a task. In some examples, the computing system receives inputs that are not directed to the digital assistant (e.g., the computing system detects audio of a conversation, of a television program, etc.). In some examples, upon receiving an input, the computing system determines whether an input is intended for the digital assistant of the computing system; if so, the computing system adjusts the activation indicator based on the input and performs a task if specified by the input. In some examples, if not, the computing system forgoes adjusting the activation indicator based on the input.

In some examples, in accordance with a determination that the fourth speech input includes a request directed to a digital assistant of the computing system, the computing system adjusts display of (e.g., initiating display of) the activation indicator based on the fourth speech input. In some examples, in accordance with a determination that the fourth speech input includes a request directed to a digital assistant of the computing system, the computing system performs a task corresponding to the request.

In some examples, the second speech input includes a task request. In some examples, the computing system initiates performance of a task corresponding to the task request. In some examples, after the task has been performed, the computing system maintains the digital assistant in an activated state. In some examples, the digital assistant of the computing system is activated, and thereafter the computing system receives a request from the user to perform a task. In some examples, after performing the task, the computing system maintains the digital assistant in the activated state such that the digital assistant can receive further inputs and/or requests from the user without the need to reactivate the digital assistant.

In some examples, while maintaining the digital assistant in an activated state and prior to receiving a fifth speech input, the computing system adjusts display (e.g., dimming) of the activation indicator according to a predetermined function. In some examples, while the computing system maintains the digital assistant in the activated state, the computing system determines the amount of time in which the digital assistant has been activated. In some examples, if a threshold amount of time has been reached, the computing system can transition the digital assistant to a deactivated state and/or terminate an ongoing digital assistant session. In some examples, while the digital assistant is activated (and while the digital assistant is waiting for user input), the computing system adjusted display of the activation indicator. In some examples, the computing system gradually dims the activation indicator according to a function, such as a decay function. In some examples, additionally or alternatively, the computing system adjusts (e.g., reduces) the size of the activation indicator according to the function.

In some examples, the one or more input devices includes a camera. In some examples, the computing system determines, via the camera, whether one or more users are gazing at the computing system. In some examples, in accordance with a determination that one or more users are gazing at the computing system, the computing system displays a gaze indicator.

In some examples, the computing system determines whether one or more users in a field of view of a camera are gazing toward the computing system (e.g., whether a gaze of one or more users is determined to be directionally oriented toward the computing system). In some examples, when determining that one or more users are gazing at the computing system, the computing system displays a gaze indicator indicating that the computing system has recognized at least one user as currently gazing at the computing system.

Displaying a gaze indicator provides improved visual feedback as to the activation state of a digital assistant (e.g., activated in a voice mode).

The operations described above with reference to FIG. 19 are optionally implemented by components depicted in FIGS. 1-4A, 6A-6B, 7A-7C, and FIGS. 18A-18G. For example, the operations of process 1900 may be implemented by electronic device 1800 and, optionally, a digital assistant executing thereon. It would be clear to a person having ordinary skill in the art how other processes are implemented based on the components depicted in FIGS. 1-4A, 6A-6B, 7A-7C, and 18A-18G.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to operate a computer system (and a digital assistant executing thereon) across various modes. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to perform various tasks (e.g., sending a message) requiring user-specific data. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, for the activation and/or operation of a digital assistant cross various modes, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, parameters for various tasks can be determined based on non-personal information data or a bare minimum amount of personal information, such as the content being requested by the device associated with a user, other non-personal information available, or publicly available information.

1. A computer system configured to communicate with a display generation component and one or more input devices, comprising:
one or more processors; and
memory storing one or more programs configured to be executed by the one or more processors, the one or more programs including instructions for:
while displaying a user interface, via the display generation component, receiving, via the set of one or more input devices, a set of inputs including a request to activate a digital assistant of the computer system, wherein the user interface includes a plurality of user interface objects;
in response to the set of inputs:
activating the digital assistant;
modifying, based on a type of an input of the set of inputs, a visual characteristic of an entire perimeter of the user interface indicating that the digital assistant is active.

2. The computer system of claim 1, wherein modifying the visual characteristic of the entire perimeter of the user interface includes modifying a visual characteristic of an edge of the user interface.

3. The computer system of claim 1, wherein:
activating the digital assistant includes displaying a digital assistant keyboard, and
modifying the visual characteristic of the entire perimeter of the user interface includes modifying a visual characteristic of the digital assistant keyboard.

4. The computer system of claim 1, wherein the one or more programs further include instructions for:
in response to the set of inputs, modifying a visual characteristic of an interior portion of the digital assistant keyboard.

5. The computer system of claim 1, wherein:
the set of inputs include a task request, and
modifying the visual characteristic of the entire perimeter of the user interface includes modifying a perimeter of a performance indicator corresponding to the task request.

6. The computer system of claim 5, wherein modifying a perimeter of a performance indicator corresponding to the task request includes translating the performance indicator across a display of the computer system.

7. The computer system of claim 1, wherein:
activating the digital assistant includes displaying a text input field, and
modifying the visual characteristic of the entire perimeter of the user interface includes modifying a visual characteristic of a perimeter of the text input field.

8. The computer system of claim 1, wherein the set of inputs includes a second task request, and wherein the one or more programs further include instructions for:
while modifying the visual characteristic of the entire perimeter of the user interface, performing a task associated with second task request.

9. The computer system of claim 1, wherein activating the digital assistant includes initiating a digital assistant session, and wherein the one or more programs further include instructions for:
in accordance with a determination that the digital assistant session has not ended, maintaining modification of the visual characteristic of the entire perimeter of the user interface; and
in accordance with a determination that the digital assistant session has ended:
deactivating the digital assistant; and
ceasing to modify the visual characteristic of the entire perimeter of the user interface.

10. The computer system of claim 1, wherein modifying the visual characteristic of the entire perimeter of the user interface includes displaying a shimmer animation at a location corresponding to the entire perimeter of the user interface.

11. The computer system of claim 1, wherein modifying the visual characteristic of the entire perimeter includes:
in accordance with a determination that the computer system has been moved in a first direction:
visually emphasizing a first portion of the perimeter; and
visually deemphasizing a second portion of the perimeter different than the first portion; and
in accordance with a determination that the computer system has been moved in a second direction opposite the first direction:
visually emphasizing the second portion of the perimeter; and
visually deemphasizing the first portion of the perimeter.

12. The computer system of claim 1, wherein modifying the visual characteristic of the entire perimeter includes:
in accordance with a determination that the computer system has a first position relative to a user:
visually emphasizing a third portion of the perimeter; and
visually deemphasizing a fourth portion of the perimeter different than the third portion; and
in accordance with a determination that the computer system has a second position relative to the user different than the first position:
visually emphasizing the fourth portion of the perimeter; and
visually deemphasizing the third portion of the perimeter.

13. The computer system of claim 1, wherein activating the digital assistant includes activating the digital assistant in a first mode, and wherein the one or more programs further include instructions for:
while the digital assistant is activated in a first mode:
in accordance with a determination that an input of a predetermined type has not been received for a threshold amount of time, providing a prompt to activate the digital assistant in a second mode different than the first mode.

14. A non-transitory computer-readable storage medium storing one or more programs configured to be executed by one or more processors of a computer system that is in communication with a display generation component and one or more input devices, the one or more programs including instructions for:
while displaying a user interface, via the display generation component, receiving, via the set of one or more input devices, a set of inputs including a request to activate a digital assistant of the computer system, wherein the user interface includes a plurality of user interface objects;
in response to the set of inputs:
activating the digital assistant;
modifying, based on a type of an input of the set of inputs, a visual characteristic of an entire perimeter of the user interface indicating that the digital assistant is active.

15. A method, comprising:
at a computer system that is in communication with a display generation component and one or more input devices:
while displaying a user interface, via the display generation component, receiving, via the set of one or more input devices, a set of inputs including a request to activate a digital assistant of the computer system, wherein the user interface includes a plurality of user interface objects;
in response to the set of inputs:
activating the digital assistant;
modifying, based on a type of an input of the set of inputs, a visual characteristic of an entire perimeter of the user interface indicating that the digital assistant is activated.
